(19) United States
(12) Patent Application Publication
(10) Pub. No.: US 2020/0345049 A1
(43) Pub. Date: Nov. 5, 2020

(54) COMPOSITIONS

(71) Applicant: Givaudan, S.A., Vernier (CH)

(72) Inventors: Moises GALANO, Sao Paolo (BR); Feng Shi, Mason, OH (US)

(21) Appl. No.: 16/853,562

(22) Filed: Apr. 20, 2020

Related U.S. Application Data
(63) Continuation-in-part of application No. 16/617,687.
(60) Provisional application No. 62/549,242, filed on Aug. 23, 2017.
(60) Provisional application No. 62/514,482, filed on Jun. 2, 2017.

(51) Int. Cl. A23L 27/30; A23L 2/60; A23L 2/54; A23C 9/156; A23C 9/13

(52) U.S. Cl. CPC A23L 27/36; A23L 27/34; A23L 2/60; A23V 2002/00; A23C 9/156; A23C 9/1307; A23L 2/54

(57) ABSTRACT

A composition includes (i) rebaudioside M, (ii) a glucosylated steviol glycoside and (iii) an effective amount of a taste modifier. A sweetened composition includes the composition and at least one other sweetener, and a sweetened consumable containing the composition or the sweetened composition. Methods of making the composition, sweetened compositions and sweetened consumables are also provided. Methods of using the compositions to reduce the amount of sugar present in a sweetened consumable, to enhance the sweetness of sweetened compositions and sweetened consumables, and/or to modify a characteristic of a sweetened consumable is further provided.

### CROSS REFERENCE TO RELATED APPLICATIONS

This application is a continuation-in-part of U.S. Ser. No. 16/617,687, filed Nov. 27, 2019, which is a national stage application of International Application No. PCT/EP2018/064324, filed May 31, 2018, which claims priority from U.S. Provisional Application For Patent Ser. Nos. 62/514,482, filed Jun. 2, 2017, and 62/549,242, filed Aug. 23, 2017, all of which applications are incorporated herein by reference in their entireties.

### TECHNICAL FIELD

The present invention relates generally to the use of one or more low-potency sweetener(s) to improve one or more sweetness characteristics of one or more high-intensity sweetener(s). The present invention thus also relates to compositions comprising a mixture of at least one high-intensity sweetener and at least one low-potency sweetener. The present invention further relates to the use of a combination of at least one high-intensity sweetener and at least one low-potency sweetener as a sweetness modifier wh+en used in combination with at least one other sweetener and/or as a sweetener. The present invention further relates to the use of one or more mogroside(s) as a sweetness enhancer in sweetened compositions and said sweetened compositions. The present invention further relates to methods of making the sweeteners and compositions disclosed herein.

### BACKGROUND

Sweetness in comestible products, that is products intended to be taken by mouth either for permanent ingestion or temporarily for expectoration, is often a desirable characteristic. Traditionally, sweetness has been provided by the addition of one or more sweeteners, particularly low-potency, nutritive sweeteners such as sucrose (table sugar), fructose, glucose, xylose, arabinose, rhamnose, sugar alcohols such as erythritol, xylitol, mannitol, sorbitol and inositol as well as sugar syrups such as high fructose corn syrup and starch syrup. These deliver considerable sweetness without any undesirable aftertaste. However, it is desirable to use a reduced amounts of these sweeteners to reduce the caloric value of the comestible product. It is therefore desirable to provide alternative sweeteners that can reduce the caloric value of the comestible product whilst maintaining the same or a similar sweetness taste.

High-intensity sweeteners (HIS) have been used for this purpose. High-intensity sweeteners may be natural or artificial and have a sweetness that can be several hundred times that of sucrose and thus can theoretically replace a much larger quantity of sugar in a composition. Examples of high-intensity sweeteners include sucralose, saccharin, aspartame, acesulfame potassium (AceK), neotame, advantame, sterviol glycosides, including stevioside, rebaudioside A, rebaudioside D or steviol glycoside mixture preparations with rebaudioside A and/or stevioside as predominant components. However, these substances generally have the drawback that they may impart undesirable off-tastes to comestible products, typically bitter, metallic or liquorice tastes, or an undesirable lingering sweetness.

Sucrose imparts an intense upfront sweetness that is short in time and decreases without any significant off-notes or aftertaste. Rebaudioside M (Reb M or reb M) has been used as an alternative sweetener to sucrose to reduce the caloric value of a comestible product. Reb M has a delayed and slight upfront sweetness as compared to sucrose, which transitions to an intense sweet impact followed by a quick decrease in sweetness and undesired lingering off-notes or aftertaste, typically bitter, metallic or liquorice off-notes. Reb M also imparts lingering dryness and/or astringent mouthfeel sensory perceptions.

Furthermore, while Reb M is able to impart an intense sweetness to a comestible product at low concentrations as compared to sucrose, it also exhibits a lower solubility in water as compared to other natural and artificial sweeteners typically used in the food and beverage industry. This lower water solubility of Reb M is a negative characteristic that limits its technical feasibility and use at an industrial scale.

It is therefore desirable to provide alternative and/or improved sweetness modifying composition and sweetened compositions to address one or more of these issues.

### SUMMARY

In accordance with a first aspect of the present invention there is provided a sweetness modifying composition comprising:
one or more high-intensity sweetener(s) selected from the group consisting of steviol glycosides and/or mogrosides; and
one or more low-intensity sweetener(s) selected from the group consisting of cellobiose, psicose, cyclamate and/or 11-O-mogroside V;
wherein the sweetness modifying composition increases the sweetness of a sweetened composition by more than the sweetness of the sweetness modifying composition alone; and/or
wherein the ratio of the one or more high-intensity sweetener(s) to the one or more low-potency sweetener(s) ranges from about 2:1 to about 12:1.

In accordance with a second aspect of the present invention there is provided a sweetened composition comprising:
at least one sweetener present in an amount having a sweetness equal to or greater than about 1.5% (w/v) sucrose equivalence; and
a sweetness modifying composition according to any aspect or embodiment of the present invention.

In accordance with a third aspect of the present invention there is provided a use of one or more low-potency sweetener(s) selected from the group consisting of cellobiose, psicose, cyclamate and/or 11-O-mogroside V to improve one or more sweetness characteristic(s) of a sweetened composition comprising one or more high-intensity sweetener(s) selected from the group consisting of steviol glycosides and/or mogrosides, wherein the total concentration of the one or more low-potency sweetener(s) and the one or more high-potency sweetener(s) that is used has a sweetness of less than 1.5% (w/v) sucrose equivalence.

In accordance with a fourth aspect of the present invention there is provided a method of enhancing the sweetness of a sweetened composition, the method comprising providing a base composition comprising at least one sweetener present in an amount at or above its sweetness recognition threshold and/or having a sweetness equal to or greater than about 1.5% (w/v) sucrose equivalence, and adding one or more high-intensity sweetener(s) selected from the group consisting of steviol glycosides and/or mogrosides and one or more low-potency sweetener(s) selected from the group consisting of cellobiose, psicose, cyclamate and/or 11-O-mogroside V, wherein the ratio of the one or more high-intensity sweetener(s) to the one or more low-potency sweetener(s) is from about 2:1 to about 12:1; and/or wherein the one or more high-intensity sweetener(s) are added in a total amount equal to or greater than about 15 ppm and optionally equal to or less than about 50 ppm, and the one or more low-potency sweetener(s) are added in a total amount equal to or greater than about 2 ppm and optionally equal to or less than about 12 ppm; and/or wherein the total concentration of the one or more high-intensity sweetener(s) and the one or more low-potency sweetener(s) that is added has a sweetness less than 1.5% (w/v) sucrose equivalence.

In accordance with a fifth aspect of the present invention there is provided a method of making a sweetness modifying composition according to any aspect or embodiment of the present invention, the method comprising combining one or more high-intensity sweetener(s) and one or more low-potency sweetener(s).

In accordance with a sixth aspect of the present invention there is provided a method of making a sweetened composition according to any aspect or embodiment of the present invention, the method comprising combining the base composition, one or more high-intensity sweetener(s), one or more low-intensity sweetener(s) and at least one other sweetener.

In accordance with a seventh aspect of the present invention there is provided a sweetened composition comprising at least one sweetener present in an amount having a sweetness equal to or greater than 1.5% (w/v) sucrose equivalence; and one or more sweetness enhancer(s) selected from mogroside IV, siamenoside and neomogroside.

In accordance with an eighth aspect of the present invention there is provided a use of one or more of mogroside IV, siamenoside and neomogroside to enhance the sweetness of a sweetened composition. Thus, in a further aspect there is provided a method for enhancing the sweetness of a sweetened composition, the method comprising providing a base composition and adding at least one sweetener and one or more sweetness enhancer(s) selected from mogroside IV, siamenoside and neomogroside.

In accordance with a ninth aspect of the present invention there is provided a method of making a sweetened composition according to any aspect or embodiment of the present invention, the method comprising combining the base composition, one or more sweetness enhancer(s) selected from mogroside IV, siamenoside and neomogroside and at least one other sweetener.

In accordance with a tenth aspect of the present invention there is provided a sweetened composition comprising one or more mogroside(s). The one or more mogroside(s) may, for example, be present as a sweetness enhancer and thus be present in an amount having a sweetness of less than 1.5% (w/v) sucrose equivalence. The sweetened composition will then further comprise at least one sweetener present in an amount having a sweetness equal to or greater than 1.5% (w/v) sucrose equivalence.

In accordance with an eleventh aspect of the present invention there is provided a use of one or more mogroside(s) to enhance the sweetness of a sweetened composition. Thus, there is provided a method for enhancing the sweetness of a sweetened composition, the method comprising providing a base composition and adding at least one sweetener and one or more mogroside(s).

In accordance with a twelfth aspect of the present invention there is provided a method of making a sweetened composition according to any aspect or embodiment of the present invention, the method comprising combining the base composition, one or more mogroside(s) and at least one other sweetener.

In certain embodiments of any aspect of the present invention the one or more high-intensity sweetener may include or be mogroside V and/or the one or more low-potency sweetener may include or be 11-O-mogroside V.

In certain embodiments of any aspect of the present invention the ratio of the one or more high-intensity sweetener(s) to the one or more low-potency sweetener(s) is from about 2:1 to about 12:1. In certain embodiments of any aspect of the present invention the ratio of the one or more high-intensity sweetener(s) to the one or more low-potency sweetener(s) is from about 5:1 to about 12:1. In certain embodiments of any aspect of the present invention the ratio of the one or more high-intensity sweetener(s) to the one or more low-potency sweetener(s) may be from about 6:1 to about 10:1.

In certain embodiments of any aspect of the present invention the one or more high-intensity sweetener(s) may be present in a total amount ranging from about 15 ppm to about 30 ppm and/or the one or more low-potency sweetener(s) may be present in a total amount ranging from about 2 ppm to about 10 ppm. In certain embodiments of any aspect of the present invention the one or more high-intensity sweetener(s) may be present in a total amount ranging from about 22 ppm to about 28 ppm and/or the one or more low-potency sweetener(s) may be present in a total amount ranging from about 2 ppm to about 5 ppm.

In certain embodiments of the seventh to twelfth aspect of the present invention, the one or more mogroside(s) or one or more sweetness enhancer(s) may be present in an amount ranging from about 15 ppm to about 50 ppm. In certain embodiments, the one or more mogroside(s) or one or more sweetness enhancer(s) may be present in an amount ranging from about 15 ppm to about 35 ppm.

In certain embodiments of any aspect of the present invention the combination of the one or more high-intensity sweetener(s) and the one or more low-potency sweetener(s) alone may have a sweetness less than about 1.5% (w/v) sucrose equivalence. In particular, the concentration of the one or more high-intensity sweetener(s) and the one or more low-intensity sweetener(s) in a sweetened composition may have a sweetness less than about 1.5% (w/v) sucrose equivalence.

In certain embodiments of the seventh to twelfth aspect of the present invention, the one or more mogroside(s) or one or more sweetness enhancer(s) may have a total sweetness less than about 1.5% (w/v) sucrose equivalence. In certain embodiments, the one or more sweetness enhancer(s) increase the sweetness of a sweetened composition by more than the total sweetness of the one or more sweetness enhancer(s) alone.

In certain embodiments of any aspect of the present invention the combination of the one or more high-intensity sweetener(s) and the one or more low-potency sweetener(s) may increase the sweetness of a sweetened composition by more than the sweetness of the combination alone. In certain embodiments of any aspect of the present invention the combination of the one or more high-intensity sweetener(s) and the one or more low-potency sweetener(s) may increase the sweetness of a composition by equal to or greater than about 1.25% (w/v) sucrose equivalence.

In certain embodiments of any aspect of the present invention the one or more low-potency sweetener(s) weaken the lingering sweet taste of a sweetened composition comprising the one or more high-intensity sweetener(s) compared to the lingering sweet taste of the sweetened composition in the complete absence of the one or more low-potency sweetener(s).

In certain embodiments of any aspect of the present invention the one or more low-potency sweetener(s) weakens the bitter and/or astringent taste of a sweetened composition comprising the one or more high-intensity sweetener(s) compared to the bitter and/or astringent taste of the sweetened composition in the complete absence of the one or more low-potency sweetener(s).

One or more (e.g. all) of the sweeteners used may be natural or synthetic (artificial). One or more of the sweeteners may, for example, be made by a biological process or by an enzymatic process or by a synthetic process.

According to another illustrative aspect of the present invention, provided is a composition comprising (i) rebaudioside M, (ii) a glucosylated steviol glycoside, and (iii) an effective amount of a taste modifier. The composition may comprise a sweetness composition or a sweetness modifying composition. According to certain embodiments, the amount of said glucosylated steviol glycoside present in the composition is greater than the amount of rebaudioside M present in the composition.

According to another illustrative aspect of the present invention, provided is a composition comprising (i) rebaudioside M, (ii) a glucosylated steviol glycoside, and (iii) an effective amount of a taste modifier, wherein the ratio of said rebaudioside M to said glucosylated steviol glycoside in said composition is from 1:1.1 to 1:1.5.

According to another illustrative aspect of the present invention, provided is a sweetened composition comprising at least one sweetener and a composition comprising (i) rebaudioside M, (ii) a glucosylated steviol glycoside, and (iii) an effective amount of a taste modifier. According to certain embodiments, the amount of said glucosylated steviol glycoside present in the composition is greater than the amount of rebaudioside M present in the composition.

According to another illustrative aspect of the present invention, provided is a sweetened composition comprising at least one sweetener and a composition comprising (i) rebaudioside M, (ii) a glucosylated steviol glycoside and (iii) an effective amount of taste modifier, wherein the ratio of said rebaudioside M to said glucosylated steviol glycoside in said composition is from 1:1.1 to 1:1.5.

According to another illustrative aspect of the present invention, provided is the use of a composition to improve one or more characteristic(s) of a sweetened composition, the composition comprising (i) rebaudioside M, (ii) a glucosylated steviol glycoside, and (iii) an effective amount of a taste modifier. According to certain embodiments, the amount of said glucosylated steviol glycoside present in the composition is greater than the amount of rebaudioside M present in the composition. According to certain embodiments, the use of the composition comprising (i) rebaudioside M, (ii) a glucosylated steviol glycoside, and (iii) an effective amount of a taste modifier is to improve a sweetness characteristic(s) of a sweetened composition.

According to another illustrative aspect of the present invention, provided is the use of a composition to improve one or more characteristic(s) of a sweetened composition, the composition comprising (i) rebaudioside M, (ii) a glucosylated steviol glycoside, and (iii) an effective amount of a taste modifier, wherein the ratio of said rebaudioside M to said glucosylated steviol glycoside in the sweetness modifying composition is from 1:1.1 to 1:1.5. According to certain embodiments, the use of the composition comprising (i) rebaudioside M, (ii) a glucosylated steviol glycoside, and (iii) an effective amount of a taste modifier is to improve a sweetness characteristic(s) of a sweetened composition.

According to another illustrative aspect of the present invention, provided is a method of enhancing the sweetness of a sweetened composition, the method comprising providing a base composition comprising at least one sweetener present in an amount at or above its sweetness recognition threshold and/or having a sweetness equal to or greater than about 1.5% (w/v) sucrose equivalence, and a composition comprising (i) rebaudioside M, (ii) a glucosylated steviol glycoside, and (iii) an effective amount of a taste modifier. According to certain embodiments, the amount of said glucosylated steviol glycoside present in the composition is greater than the amount of rebaudioside M present in the composition.

According to another illustrative aspect of the present invention, provided is a method of enhancing the sweetness of a sweetened composition, the method comprising providing a base composition comprising at least one sweetener present in an amount at or above its sweetness recognition threshold and/or having a sweetness equal to or greater than about 1.5% (w/v) sucrose equivalence, and a composition comprising (i) rebaudioside M, (ii) a glucosylated steviol glycoside, and (iii) an effective amount of a taste modifier, wherein the ratio of said rebaudioside M to said glucosylated steviol glycoside in the composition is from 1:1.1 to 1:1.5.

According to another illustrative aspect of the present invention, provided is a sweetened consumable comprising a food or beverage base composition comprising at least one sweetener present in an amount at or above its sweetness recognition threshold and/or having a sweetness equal to or greater than about 1.5% (w/v) sucrose equivalence, and a composition comprising (i) rebaudioside M, (ii) a glucosylated steviol glycoside, and (iii) an effective amount of a taste modifier. According to certain embodiments, the amount of said glucosylated steviol glycoside present in the composition is greater than the amount of rebaudioside M present in the composition.

According to another illustrative aspect of the present invention, provided is a sweetened consumable comprising a food or beverage base composition comprising at least one sweetener present in an amount at or above its sweetness recognition threshold and/or having a sweetness equal to or greater than about 1.5% (w/v) sucrose equivalence, and a composition comprising (i) rebaudioside M, (ii) a glucosylated steviol glycoside, and (iii) an effective amount of a taste modifier, wherein the ratio of said rebaudioside M to said glucosylated steviol glycoside in the sweetness modifying composition is from 1:1.1 to 1:1.5.

According to another illustrative aspect of the present invention, provided is a method of reducing the amount of sugar in a sweetened composition, the method comprising providing a base composition comprising at least one sweetener present in an amount at or above its sweetness recognition threshold and/or having a sweetness equal to or greater than about 1.5% (w/v) sucrose equivalence, and adding a composition to said base composition, the composition comprising (i) rebaudioside M, (ii) a glucosylated steviol glycoside, and (iii) an effective amount of a taste modifier. According to certain embodiments, the amount of said glucosylated steviol glycoside present in the composition is greater than the amount of rebaudioside M present in the composition.

According to another illustrative aspect of the present invention, provided is a method of reducing the amount of sugar in a sweetened composition, the method comprising providing a base composition comprising at least one sweetener present in an amount at or above its sweetness recognition threshold and/or having a sweetness equal to or greater than about 1.5% (w/v) sucrose equivalence, and adding a composition to said base composition, the composition comprising (i) rebaudioside M, (ii) a glucosylated steviol glycoside, and (iii) an effective amount of a taste modifier, wherein the ratio of said rebaudioside M to said glucosylated steviol glycoside in the composition is from 1:1.1 to 1:1.5.

According to another illustrative aspect of the present invention, provided is a composition comprising (i) rebaudioside M and (ii) an effective amount of a taste modifier.

According to another illustrative aspect of the present invention, provided is a sweetened composition comprising at least one sweetener and a composition comprising (i) rebaudioside M and (ii) an effective amount of a taste modifier.

According to another illustrative aspect of the present invention, provided is a sweetened consumable comprising a food or beverage base composition comprising at least one sweetener present in an amount at or above its sweetness recognition threshold and/or having a sweetness equal to or greater than about 1.5% (w/v) sucrose equivalence, and a composition comprising (i) rebaudioside M and (ii) an effective amount of a taste modifier.

According to another illustrative aspect of the present invention, provided is the use of a composition to improve one or more characteristic(s) of a sweetened composition, the composition comprising (i) rebaudioside M and (ii) an effective amount of a taste modifier. The use of the composition is to improve a sweetness characteristic(s) of a sweetened composition.

According to another illustrative aspect of the present invention, provided is a method of enhancing the sweetness of a sweetened composition, the method comprising providing a base composition comprising at least one sweetener present in an amount at or above its sweetness recognition threshold and/or having a sweetness equal to or greater than about 1.5% (w/v) sucrose equivalence, and a composition comprising (i) rebaudioside M and (ii) an effective amount of a taste modifier.

According to another illustrative aspect of the present invention, provided is a method of reducing the amount of sugar in a sweetened composition, the method comprising providing a base composition comprising at least one sweetener present in an amount at or above its sweetness recognition threshold and/or having a sweetness equal to or greater than about 1.5% (w/v) sucrose equivalence, and adding a composition to said base composition, the composition comprising (i) rebaudioside M and (ii) an effective amount of a taste modifier.

According to another illustrative aspect of the present invention, provided is a composition comprising (i) a glucosylated steviol glycoside and (ii) an effective amount of a taste modifier.

According to another illustrative aspect of the present invention, provided is a sweetened composition comprising at least one sweetener and a composition comprising (i) a glucosylated steviol glycoside and (ii) an effective amount of a taste modifier.

According to another illustrative aspect of the present invention, provided is a sweetened consumable comprising a food or beverage base composition comprising at least one sweetener present in an amount at or above its sweetness recognition threshold and/or having a sweetness equal to or greater than about 1.5% (w/v) sucrose equivalence, and a composition comprising (i) a glucosylated steviol glycoside and (ii) an effective amount of a taste modifier.

According to another illustrative aspect of the present invention, provided is the use of a composition to improve one or more characteristic(s) of a sweetened composition, the composition comprising (i) a glucosylated steviol glycoside and (ii) an effective amount of a taste modifier. The use of the composition is to improve a sweetness characteristic(s) of a sweetened composition.

According to another illustrative aspect of the present invention, provided is a method of enhancing the sweetness of a sweetened composition, the method comprising providing a base composition comprising at least one sweetener present in an amount at or above its sweetness recognition threshold and/or having a sweetness equal to or greater than about 1.5% (w/v) sucrose equivalence, and a composition comprising (i) a glucosylated steviol glycoside and (ii) an effective amount of a taste modifier.

According to another illustrative aspect of the present invention, provided is a method of reducing the amount of sugar in a sweetened composition, the method comprising providing a base composition comprising at least one sweetener present in an amount at or above its sweetness recognition threshold and/or having a sweetness equal to or greater than about 1.5% (w/v) sucrose equivalence, and adding a composition to said base composition, the composition comprising (i) a glucosylated steviol glycoside and (ii) an effective amount of a taste modifier.

Certain embodiments of any aspect of the present invention may provide one or more of the following advantages:
increased sweetness in a composition;
enhanced sweetness in a composition including at least one sweetener;
decrease in the amount of caloric sweetener required to obtain desired sweetness;
improvement of one or more sweetness characteristics to make sweet taste more similar to sugar (sucrose);
weakening of lingering sweetness (e.g. decreasing the length of time the sweet taste remains and/or decreasing the intensity of the sweet taste more rapidly);
weakening of bitter taste and/or liquorice taste and/or metallic taste;
weakening of the sensory perceptions of dryness and/or astringent mouthfeel;
improvement in sweetness impact (e.g. increasing the maximum intensity of the sweet taste and/or decreases the length of time for the sweet taste to be detected) (e.g. decreasing the lingering sweetness).

The details, examples and preferences provided in relation to any particulate one or more of the stated aspects of the present invention will be further described herein and apply equally to all aspects of the present invention. Any combination of the embodiments, examples and preferences described herein in all possible variations thereof is encompassed by the present invention unless otherwise indicated herein, or otherwise clearly contradicted by context.

### BRIEF DESCRIPTION OF THE DRAWINGS

FIG. 1 shows a chromatogram of a Luo Han Guo extract (extract 2 of Table 1 below).

FIG. 2 shows the chemical structures of mogrosides 1-6;

FIGS. 3A and 3B show the LC-MS analysis of commercial Luo Han Guo extracts;

FIGS. 4A-4D show the Heteronuclear Single Quantum Coherence-Total Correlation Spectroscopy (HSQC-TOCSY) (hsqcgpmlph) of iso-mogroside VI with different mixing time (d9). FIG. 4A: 10 ms mixing time. FIG. 4B: 30 ms mixing time. FIG. 4C: 60 ms mixing time. FIG. 4D: 100 ms mixing time. Because of the overlap of H-1 of Glc II and H-6a of Glc III, HSQC-COSY correlation intensity of Glc II was not analyzed here;

FIGS. 5A-5D show HSQC-TOCSY (hsqcgpmlph) peak intensity quantification of iso-mogroside VI glucopyranosyls with different mixing time. (*C-3 and C-5 signals on HSQC-TOCSY appeared overlap for 100 ms mixing time. The total integration of C-3 and C-5 was therefore used in the bar chart);

FIG. 6 shows the strategy to elucidate mogroside sugar chain (*Numbers of C-2 to C-6 appeared under certain mixing time might slightly change if adjusting peak intensity of HSQC-TOCSY. By observing the increasing intensity of C-2 to C-6 in different mixing time experiments connection sequence can be still determined. **There is no natural glycosylation on C-3 of mogroside glucopyranosyl so far. C-3 glycosylation on glucopyranosyl would cause the downshift from δ76 to δ81 and can be easily determined by HSQC-TOCSY experiments). The sequence of steps in FIG. 6 can be outlined as follows:

In Step 1, Heteronuclear multiple bond correlation spectroscopy (HMBC) was used to determine anormeric C-1 and H-1 of the sugar. Start from the sugar link to aglycone. In Step 2, HSQC-TOCSY was used with 100 ms mixing time to determine the whole group of C-2 to C-6. HSQC-COSY or HSQC-TOCSY (d9=10 ms) to assign C-2. HSQC-TOCSY (d9=30 ms) to assign C-3. HSQC-TOCSY (d9=60 ms) to assign C-4. HSQC-TOCSY (d9=100 ms) to assign C-5 and C-6. In Step 3, if a C-2 downshift from ˜δ75 to ˜δ81, C-4 downshift from ˜δ71 to ˜δ81 or C-6 downshift from ˜δ62 to ˜69 is observed, check HMBC for glycosylation at these positions.**

If a C-2 downshift from ˜δ75 to ˜δ81, C-4 downshift from ˜δ71 to ˜δ81 or C-6 downshift from ˜δ62 to ˜δ9, check HMBC for glycosylation at these positions.**

FIG. 7 shows the chemical structure for iso-mogroside VI which has the chemical formula C₆₆H₁₁₂O₃₄ and an Exact Mass of 1448.70. This chemical structure is designated Formula I; and

FIG. 8 shows the chemical structure for 11-epi-mogrosideV which has the chemical formula C₆₀H₁₀₂O₂₉ and an Exact Mass of 1286.65. This chemical structure is designated Formula II.

### DETAILED DESCRIPTION

The present invention is based on the surprising finding that a combination of one or more high-intensity sweetener(s) (e.g. mogroside V) and one or more low-potency sweetener(s) (e.g. 11-O-mogroside V) can act synergistically with at least one other sweetener (e.g. sucrose) to obtain a composition having a sweetness that is greater than the sum of the sweetness of the individual sweeteners. The present invention is further based on the surprising finding that one or more low-potency sweetener(s) may offset one or more negative sweetness characteristics of one or more high-potency sweetener(s). For example, the combination of one or more high-intensity sweetener(s) (e.g. mogroside V) and one or more low-potency sweetener(s) (e.g. 11-O-mogroside V) may provide improved sweetness characteristics in a sweetened composition (i.e. a composition comprising at least one other sweetener such as sucrose in an amount above its sweetness recognition threshold and/or an amount equal to or greater than about 1.5% (w/v) sucrose equivalence) compared to using the one or more high-intensity sweetener(s) alone. The sweetness characteristics may thus, for example, be closer to the sweetness characteristics of sucrose.

Thus, there is provided herein various compositions comprising one or more high-intensity sweetener(s) and one or more low-potency sweetener(s) as disclosed herein, particularly sweetened compositions comprising at least one sweetener in an amount above its sweetness recognition threshold and/or an amount equal to or greater than about 1.5% (w/v) sucrose equivalence and one or more high-intensity sweetener and one or more low-potency sweetener(s). The sweetened compositions may also be referred to as comestible compositions. There is also provided herein various uses of one or more high-intensity sweetener(s) and one or more low-potency sweetener(s) as disclosed herein and methods of making the various compositions disclosed herein.

The present invention is further based on the surprising finding that mogrosides such as mogroside IV, siamenoside and neomogroside can act as sweetness enhancers (i.e. can increase the sweetness of a sweetened composition by more than the sweetness of the sweetness enhancer alone).

Thus, there is provided herein various compositions, in particular sweetened compositions, comprising one or more of mogroside IV, siamenoside and neomogroside.

### Compositions

There is provided herein various compositions comprising at least one high-intensity sweetener and at least one low-potency sweetener. There is also provided herein compositions comprising one or more mogroside(s), for example one or more of mogroside IV, siamenoside and neomogroside. In certain embodiments, the compositions are comestible compositions.

In certain embodiments, there is provided a sweetness modifying composition comprising, consisting essentially of or consisting of at least one high-intensity sweetener selected from the group consisting of steviol glycosides and/or mogrosides and at least one low-potency sweetener selected from the group consisting of cellobiose, psicose, cyclamate and/or 11-O-mogroside V. In certain embodiments, the sweetness modifying composition comprises, consists essentially of or consists of one high-intensity sweetener and one low-potency sweetener. The sweetness modifying composition may, for example, be a concentrate which may, for example, be diluted in a sweetened (e.g. comestible) composition to give the comestible composition a desired sweetness. The term “sweetened composition” refers to a composition comprising at least one sweetener present in an amount above its sweetness recognition threshold and/or in an amount having a sweetness equal to or greater than about 1.5% (w/v) sucrose equivalence.

In certain embodiments, there is provided a sweetened composition (e.g. comestible composition) comprising one or more mogroside(s), for example one or more of mogroside IV, siamenoside and neomogroside. In certain embodiments, there is provided a sweetened composition (e.g. comestible composition) comprising at least one high-intensity sweetener and at least one low-potency sweetener. The combination of the high-intensity sweetener(s) and low-potency sweetener(s) may be referred to as a sweetness modifying composition. The one or more mogroside(s), for example the one or more of mogroside IV, siamenoside and neomogroside may also be referred to herein as a sweetness modifying composition. Thus, in certain embodiments, there is provided a sweetened composition comprising at least one sweetener present in an amount above its sweetness recognition threshold and/or in an amount having a sweetness equal to or greater than about 1.5% (w/v) sucrose equivalence and a sweetness modifying composition comprising, consisting essentially of or consisting of at least one high-intensity sweetener and at least one low-potency sweetener. The sweetened composition may, for example, be a comestible composition.

The term “enhancing” when used in relation to a particular sweetness modifying composition refers to a synergistic sweetening effect when the sweetness modifying composition is used in combination with at least one other sweetener. The sweetness modifying composition increases the sweetness of a sweetened composition by more than the sweetness of the sweetness modifying composition alone. In other words, the sweetness of a composition comprising at least one sweetener and at least one sweetness modifying composition is greater than the sum of the sweetness of all the sweeteners in the composition. The sweetness modifying compositions described herein are used in sweetened (e.g. comestible) compositions in amounts that have no detectable sweetness or no taste recognised as sweet (below its sweetness recognition threshold). Typically, a sweetness modifying composition with a sweetness below 1.5% (w/v) sucrose equivalence is accepted as being “not intrinsically sweet” by FEMA (Flavor & Extract Manufacturers Association). Sweetness modifiers may also be referred to as sweetness enhancers.

The sweetened composition comprising the sweetness modifying composition as disclosed herein and at least one sweetener in an amount above its sweetness recognition threshold and/or in an amount having a sweetness equal to or greater than about 1.5% (w/v) sucrose equivalence may have a sweetness that is equal to or more than about 1.0% (w/v) sucrose equivalence greater than the sweetness of the sweetened composition in the absence of the sweetness modifying composition. For example, the sweetened composition may have a sweetness that is equal to or more than about 1.1% (w/v) or equal to or more than about 1.15% (w/v) or equal to or more than about 1.2% (w/v) or equal to or more than about 1.25% (w/v) sucrose equivalence greater than the sweetness of the sweetened composition in the absence of the sweetness modifying composition. In other words, the sweetness modifying composition may increase the sweetness of a sweetened composition by equal to or more than about 1% (w/v) or equal to or more than about 1.1% (w/v) or equal to or more than about 1.15% (w/v) or equal to or more than about 1.2% (w/v) or equal to or more than about 1.25% (w/v) sucrose equivalence. The comparative composition is identical to the said composition except that it does not include the said sweetness modifying composition.

The term “sucrose equivalence” refers to the equivalence in sweetness of a composition containing at least one non-sucrose sweetener to a reference sucrose solution. Typically, taste panellists are trained to detect sweetness of reference sucrose solutions containing between 1% and 15% sucrose (w/v). Other non-sucrose sweeteners may then be tasted at a series of dilutions to determine the concentration of the non-sucrose sweetener that is as sweet (i.e. isosweet) to a given sucrose reference. The term “isosweet” refers to compositions that have equivalent sweetness. Typically, the sweetness of a given composition is measured with reference to a solution of sucrose. See “A Systematic Study of Concentration-Response Relationships of Sweeteners,” G. E. DuBois, D. E. Walters, S. S. Schiffman, Z. S. Warwick, B. J. Booth, S. D. Pecore, K. Gibes, B. T. Carr, and L. M. Brands, in Sweeteners: Discovery, Molecular Design and Chemoreception, D. E. Walters, F. T. Orthoefer, and G. E. DuBois, Eds., American Chemical Society, Washington, D.C. (1991), pp 261-276.

The combination of the one or more high-intensity sweetener(s) and the one or more low-potency sweetener(s) (e.g. the sweetness modifying composition) may, for example, have a sweetness less than about 1.5% (w/v) sucrose equivalence. For example, the combination of the high-intensity sweetener(s) and the low-potency sweetener(s) (e.g. sweetness modifying composition) may have a sweetness equal to or less than about 1.45% (w/v) sucrose equivalence or equal to or less than about 1.4% (w/v) sucrose equivalence or equal to or less than about 1.35% (w/v) sucrose equivalence or equal to or less than about 1.3% (w/v) sucrose equivalence. For example, the combination of the high-intensity sweetener(s) and the low-potency sweetener(s) (e.g. sweetness modifying composition) may have a sweetness equal to or greater than about 1% (w/v) sucrose equivalence or equal to or greater than about 1.1% (w/v) sucrose equivalence or equal to or greater than about 1.15% (w/v) sucrose equivalence or equal to or greater than about 1.2% (w/v) sucrose equivalence or equal to or greater than about 1.25% (w/v) sucrose equivalence or equal to or greater than about 1.3% (w/v) sucrose equivalence.

The one or more mogroside(s), for example one or more sweetness enhancer(s) selected from mogroside IV, siamenoside and neomogroside may, for example, have a sweetness less than about 1.5% (w/v) sucrose equivalence. For example, the one or more mogroside(s), for example one or more sweetness enhancer(s) selected from mogroside IV, siamenoside and neomogroside may have a sweetness equal to or less than about 1.45% (w/v) sucrose equivalence or equal to or less than about 1.4% (w/v) sucrose equivalence or equal to or less than about 1.35% (w/v) sucrose equivalence or equal to or less than about 1.3% (w/v) sucrose equivalence. For example, the one or more mogroside(s), for example one or more sweetness enhancer(s) selected from mogroside IV, siamenoside and neomogroside may have a sweetness equal to or greater than about 1% (w/v) sucrose equivalence or equal to or greater than about 1.1% (w/v) sucrose equivalence or equal to or greater than about 1.15% (w/v) sucrose equivalence or equal to or greater than about 1.2% (w/v) sucrose equivalence or equal to or greater than about 1.25% (w/v) sucrose equivalence or equal to or greater than about 1.3% (w/v) sucrose equivalence.

Each of the sweeteners and sweetness enhancers used in the compositions disclosed herein may be a natural or synthetic (artificial) sweetener. Examples of non-naturally occurring (i.e. synthetic) mogrosides are disclosed in WO 2017/075257, the contents of which are incorporated herein by reference. The term “natural sweetener” refers to sweeteners that are obtained from nature, including mixtures that may have been enzymatically treated (e.g. glycosylated) to form compounds not found in nature (this does not include purified compounds that have been enzymatically treated). For example, a modified extract having a mogrol glycoside distribution that is different (e.g. enhanced) from the naturally occurring mogrol glycoside distribution may be classed as natural. For example, a mixture of glucosylated steviol glycosides and/or glucosylated mogrosides may be classed as natural. Each of the sweeteners used in the compositions disclosed herein may be food-derived. A “food-derived” product refers to a product which is prepared under typical cooking conditions such as, for example, using temperatures similar to those used in cooking methods. In certain embodiments, the high-intensity sweetener and the low-potency sweetener used in the compositions disclosed herein (e.g. in the sweetness modifying composition disclosed herein) are both natural sweeteners. In certain embodiments, all of the sweeteners used in the compositions disclosed herein are natural.

The sweeteners disclosed herein may be used in pure or purified form and may be chemically synthesised, produced by biotechnological processes (e.g. fermentation) or isolated from a natural source (e.g. a botanical source including, without limitation, fruits, sugar cane, sugar beet).

The one or more mogroside(s), for example the one or more of mogroside IV, siamenoside and neomogroside may, for example, be at least 80 wt % pure. For example, the one or more mogroside(s), for example one or more of mogroside IV, siamenoside and neomogroside may be at least about 85 wt % or at least about 90 wt % or at least about 95 wt % or at least about 98 wt % or at least about 99 wt % pure. For example, the one or more mogroside(s), for example one or more of mogroside IV, siamenoside and neomogroside may be up to 100 wt % or up to 99 wt % pure.

The term “high-intensity sweetener” refers to compounds having a sweetness that is at least 100 times the sweetness of sucrose. In certain embodiments, the high-intensity sweetener has a sweetness that is at least about 120 or at least about 140 or at least about 150 or at least about 160 or at least about 180 or at least about 200 or at least about 220 or at least about 240 or at least about 250 or at least about 260 or at least about 280 or at least about 300 or at least about 320 or at least about 340 or at least about 350 or at least about 360 or at least about 380 or at least about 400 or at least about 420 or at least about 440 or at least about 450 times the sweetness of sucrose. The high-intensity sweetener may, for example, have a sweetness that is up to 1000 times the sweetness of sucrose. Although the high-intensity sweetener has a sweetness that is at least 100 times the sweetness of sucrose, in the context of its use in a sweetness modifying composition as described herein, they will be used in a sweetened composition in an amount that does not have any detectable sweetness or be recognised as sweet (amounts providing a sweetness less than 1.5% (w/v) sucrose equivalence, which is accepted as being “not intrinsically sweet” by FEMA.

The one or more high-intensity sweetener(s) may, for example, be one or more steviol glycosides and/or one or more mogrosides. For example, the one or more high-intensity sweetener may be a mixture of steviol glycosides and mogrosides. For example, the one or more high-intensity sweeteners may be one or more steviol glycosides. For example, the one or more high-intensity sweetener(s) may be one or more mogrosides. In certain embodiments, mogrosides may perform better than steviol glycosides in terms of sweetness enhancement and off-note reduction (e.g. weakening of lingering sweet after taste).

The high-intensity sweetener may, for example, be one or more steviol glycoside(s). Examples of steviol glycosides include, for example, stevioside (CAS: 57817-89-7), rebaudioside A (CAS: 58543-16-1), rebaudioside B (CAS: 58543-17-2), rebaudioside C (CAS: 63550-99-2), rebaudioside D (CAS: 63279-13-0), rebaudioside E (CAS: 63279-14-1), rebaudioside F (CAS: 438045-89-7), rebaudioside G (CAS: 127345-21-5), rebaudioside H, rebaudioside I (CAS: 1220616-34-1), rebaudioside J, rebaudioside K, rebaudioside L, rebaudioside M (CAS: 1220616-44-3), rebaudioside N (CAS: 1220616-46-5), rebaudioside O (CAS: 1220616-48-7), dulcoside A (CAS: 64432-06-0), dulcoside B (CAS: 63550-99-2), rubusoside (CAS: 64849-39-4) and Naringin Dihydrochalcone (CAS: 18916-17-1).

The high-intensity sweetener may, for example, be one or more mogroside(s). In certain embodiments, the high-intensity sweetener may be one or more of the mogrosides listed herein. In certain embodiments, the high-intensity sweetener may be one or more of mogroside IV, siamenoside, neomogroside and mogroside V (including all isomers thereof). For example, the high-intensity sweetener may be a mixture of mogroside IV, siamenoside and mogroside V (including all isomers thereof). The one or more mogroside(s) may, for example, be obtained or obtainable from Luo Han Guo fruit extracts.

The term “low-potency sweetener” refers to compounds having a sweetness that is less than 100 times the sweetness of sucrose. In certain embodiments, the low-potency sweetener has a sweetness that is up to about 95 times or up to about 90 times or up to about 85 times the sweetness of sucrose.

The one or more low-potency sweetener(s) are selected from one or more of cellobiose, psicose, cyclamate and/or 11-O-mogroside V (CAS: 126105-11-1). For example, the one or more low-intensity sweetener(s) may be one or more of cellobiose, psicose and 11-O-mogroside V.

In certain embodiments, the one or more high-intensity sweetener(s) includes or is a high-intensity mogroside. In certain embodiments, the one or more low-potency sweetener(s) includes or is a low-potency mogroside. In certain embodiments, the one or more high-intensity sweetener includes or is a high-intensity mogroside and the one or more low-potency sweetener(s) includes or is a low-potency mogroside.

In certain embodiments, the one or more high-intensity sweetener includes or is mogroside V. In certain embodiments, the one or more low-potency sweetener includes or is 11-O-mogroside V. In certain embodiments, the one or more high-intensity sweetener includes or is mogroside V and the one or more low-potency sweetener includes or is 11-O-mogroside V.

Mogrosides are a group of triterpene glycosides and may be obtained from the fruit Luo Han Guo (Siraitia grosvenorii), also known as arhat fruit or longevity fruit or swingle fruit. Mogrosides make up approximately 1% of the flesh of the fresh fruit. Through extraction, an extract in the form of a powder containing up to 80% mogrosides can be obtained. Mogroside extract contains grosvenorine II, grosvenorine I, 11-O-mogroside II (I), 11-O-mogroside II (II), 11-O-mogroside II (III), mogroside II (I), mogroside II (II), mogroside II (III), 11-dehydroxy-mogroside III, 11-O-mogroside III, mogroside III (I), mogroside III (II), mogroside IV (I) (siamenoside), mogroside IV (II), mogroside IV (III), mogroside IV (IV), deoxymogroside V (I), deoxymogroside V (II), 11-O-mogroside V (I), mogroside V isomer, mogroside V, iso-mogroside V, 7-O-mogroside V, 11-O-mogroside VI, mogroside VI (I), mogroside VI (II), mogroside VI (III) (neomogroside) and mogroside VI (IV). The precise amount of mogroside V may vary depending on the ripeness of the fruit and/or extraction process used.

Mogroside(s) include both mogroside(s) that occur in nature and mogrosides that do not occur in nature. Examples of mogrosides include, for example, grosvenorine II, grosvenorine I, 11-O-mogroside II (I), 11-O-mogroside II (II), 11-O-mogroside II (III), mogroside II (I), mogroside II (II), mogroside II (III), 11-dehydroxy-mogroside III, 11-O-mogroside III, mogroside III (I), mogroside III (II), mogroside IIIe, mogroside IIIx, mogroside IV (I) (siamenoside), mogroside IV (II), mogroside IV (III), mogroside IV (IV), deoxymogroside V (I), deoxymogroside V (II), 11-O-mogroside V (I), mogroside V isomer, mogroside V, iso-mogroside V, 7-O-mogroside V, 11-O-mogroside VI, mogroside VI (I), mogroside VI (II), mogroside VI (III) (neomogroside) and mogroside VI (IV). The mogroside(s) may, for example, be obtained or obtainable from Luo Han Guo extracts.

Mogroside V (CAS: 88901-36-4) is a glycoside of a cucurbitane derivative and has the chemical formula C₆₀H₁₀₂O₂₉ and the chemical structure shown below. Mogroside V can be found in certain plant extracts such as extracts from the fruit Luo Han Guo (Siraitia grosvenorii). Pure mogroside V has been found to have a sweetness of at least 400 times the sweetness of sucrose.

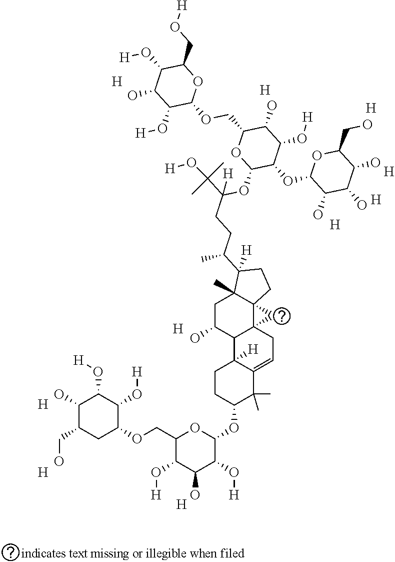

Siamenoside (CAS: 126105-12-2) is a cucurbitane found in the fruit of Siraitia grosvenorii and has the following chemical structure.

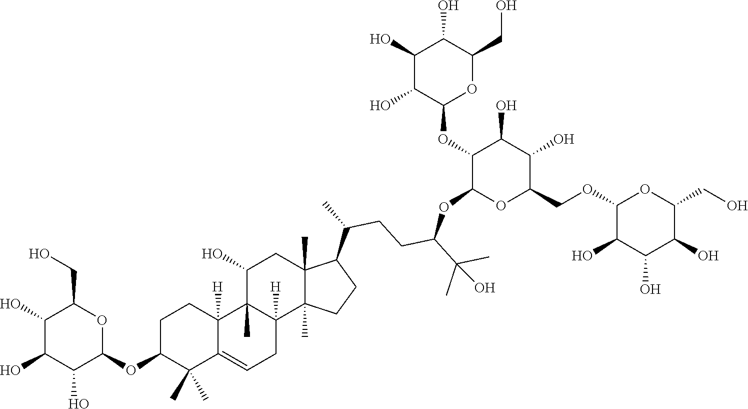

Mogroside IV (CAS: 89590-95-4) is a triterpenic heteroside found in the fruit of Siraitia grosvenorii and has the following chemical structure.

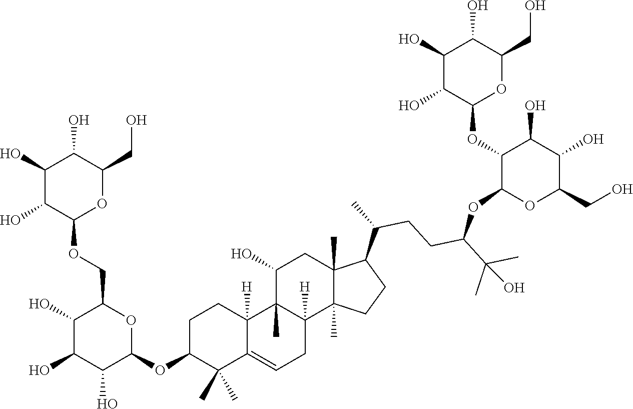

Neomogroside (CAS: 189307-15-1) is a cucurbitane glycoside also found in the fruit of Siraitia grosvenorii and has the following chemical structure.

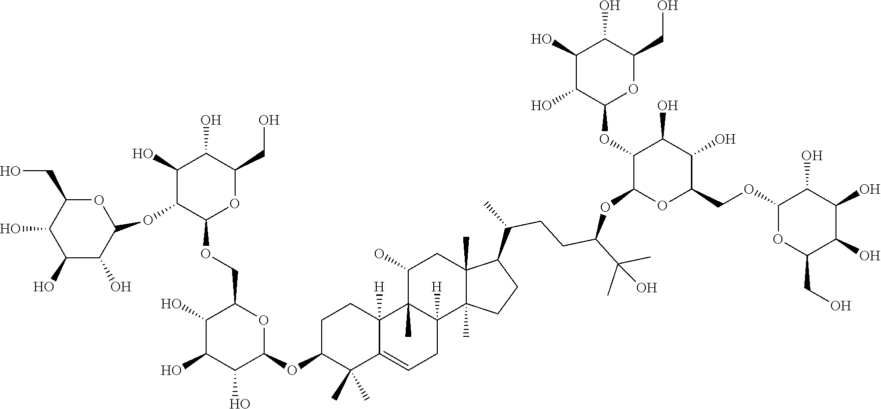

11-O-Mogroside V (CAS: 126105-11-1) is derived from mogroside V and has the following chemical structure. It is also found in plant extracts such as extracts from the fruit Luo Han Guo (Siraitia grosvenorii). 11-O-mogroside V has been found to have a sweetness that is about 84 times the sweetness of sucrose.

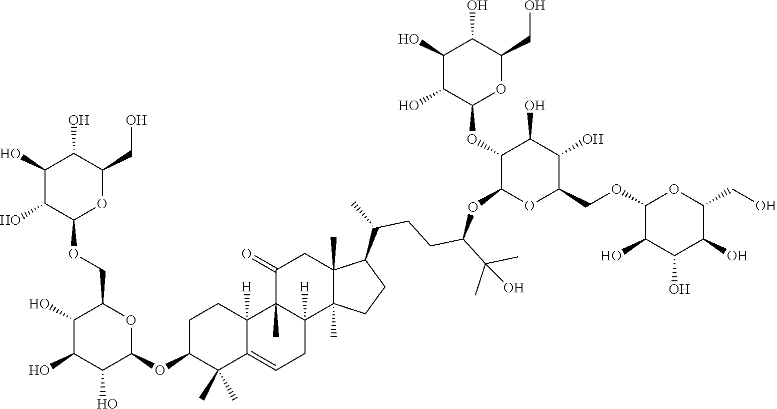

The ratio of the one or more high-intensity sweetener(s) to the one or more low-potency sweetener(s) is equal to or greater than about 2:1. For example, the ratio of the one or more high-intensity sweetener(s) to the one or more low-potency sweetener(s) may be equal to or greater than about 2.5:1 or equal to or greater than about 3:1 or equal to or greater than about 3.5:1 or equal to or greater than about 4:1 or equal to or greater than about 4.5:1 or equal to or greater than about 5:1 or equal to or greater than about 5.5:1 or equal to or greater than about 6:1 or equal to or greater than about 6.5:1 or equal to or greater than about 7:1 or equal to or greater than about 7.5:1 or equal to or greater than about 8:1. The ratio of the high-intensity sweetener to the low-potency sweetener is equal to or less than about 12:1. For example, the ratio of the one or more high-intensity sweetener(s) to the one or more low-potency sweetener(s) may be equal to or less than about 11.5:1 or equal to or less than about 11:1 or equal to or less than about 10.5:1 or equal to or less than about 10:1 or equal to or less than about 9.5:1 or equal to or less than about 9:1 or equal to or less than about 8.5:1. For example, the ratio of the one or more high-intensity sweetener(s) to the one or more low-potency sweetener(s) may range from about 5:1 to about 11:1 or from about 6:1 to about 10:1 or from about 6.5:1 to about 9.5:1 or from about 7:1 to about 9:1 or from about 7.5:1 to about 8.5:1.

In certain embodiments, the ratio of the one or more high-intensity sweetener(s) to the one or more low-potency sweetener(s) is from about 2:1 to about 12:1 or from about 4:1 to about 12:1 or from about 5:1 to about 12:1 or from about 6:1 to about 10:1 or from about 7:1 to about 9:1. The ratio may be weight or volume ratio. The ratio only applies to the high-intensity sweetener(s) and low-potency sweeteners in the sweetness modifying composition (high-intensity and low-potency sweeteners that are used in a sweetened composition in an amount below the sweetness recognition threshold or having less than 1.5% (w/v) sucrose equivalence).

The one or more high-intensity sweetener(s) may be present in a composition in a total amount equal to or greater than about 15 ppm. For example, the one or more high-intensity sweetener(s) may be present in a composition in a total amount equal to or greater than about 16 ppm or equal to or greater than about 17 ppm or equal to or greater than about 18 ppm or equal to or greater than about 19 ppm or equal to or greater than about 20 ppm or equal to or greater than about 21 ppm or equal to or greater than about 22 ppm or equal to or greater than about 23 ppm or equal to or greater than about 24 ppm or equal to or greater than about 25 ppm. For example, the one or more high-intensity sweetener(s) may be present in a composition in a total amount equal to or less than about 50 ppm or equal to or less than about 48 ppm or equal to or less than about 46 ppm or equal to or less than about 45 ppm or equal to or less than about 44 ppm or equal to or less than about 42 ppm or equal to or less than about 40 ppm or equal to or less than about 38 ppm or equal to or less than about 36 ppm or equal to or less than about 35 ppm or equal to or less than about 34 ppm or equal to or less than about 32 ppm or equal to or less than about 30 ppm. For example, the one or more high-intensity sweetener(s) may be present in a composition in a total amount ranging from about 15 ppm to about 50 ppm or from about 15 ppm to about 45 ppm or from about 15 ppm to about 40 ppm or from about 15 ppm to about 35 ppm or from about 15 ppm to about 30 ppm. For example, the one or more high-intensity sweetener(s) may be present in a composition in a total amount ranging from about 15 ppm to about 30 ppm or from about 20 ppm to about 30 ppm or from about 22 ppm to about 28 ppm or from about 23 ppm to about 27 ppm or from about 24 ppm to about 26 ppm. For example, the one or more high-intensity sweetener(s) may be present in a composition in a total amount of about 20 ppm or about 25 ppm. The composition may, for example, be a sweetened composition comprising at least one sweetener in an amount having a sweetness above its sweetness recognition threshold and/or equal to or greater than about 1.5% (w/v) sucrose equivalence.

The one or more low-potency sweetener(s) may be present in a composition in a total amount equal to or greater than about 2 ppm. For example, the one or more low-potency sweetener(s) may be present in a composition in a total amount equal to or greater than about 3 ppm. For example, the one or more low-potency sweetener(s) may be present in a composition in a total amount equal to or less than about 12 ppm or equal to or less than about 11 ppm or equal to or less than about 10 ppm or equal to or less than about 9 ppm or equal to or less than about 8 ppm or equal to or less than about 7 ppm or equal to or less than about 6 ppm or equal to or less than about 5 ppm. For example, the one or more low-potency sweetener(s) may be present in a composition in a total amount ranging from about 2 ppm to about 12 ppm or from about 2 ppm to about 10 ppm or from about 2 ppm to about 5 ppm, for example in a total amount of about 3 ppm. The composition may, for example, comprise at least one sweetener other than the combination of the high-intensity sweetener and the low-potency sweetener (e.g. sweetness modifying composition) as disclosed herein. The concentration ranges may, for example, be particularly suitable for liquid compositions such as beverages or compositions that do not comprise any proteins or fats. In compositions having a base such as milk and yogurt or other compositions that do comprise proteins and fats, higher concentrations of the one or more high-intensity sweetener(s) and one or more low-potency sweetener(s) may be used. For example, concentrations that are about 1.5 times higher than the concentrations used for liquid compositions or compositions that do not comprise any proteins or fats may be used. For example, concentrations that are from about 1.5 times to about 3 times higher than the concentrations used for liquid compositions or compositions that do not comprise any proteins or fats may be used.

Therefore, for example, the one or more high-intensity sweetener(s) may be present in a composition (e.g. a composition having a base such as milk and yoghurt or other compositions that comprise proteins and/or fats) in a total amount ranging from about 20 ppm to about 75 ppm, for example from about 22 ppm to about 74 ppm or from about 24 ppm to about 72 ppm or from about 25 ppm to about 70 ppm or from about 26 ppm to about 68 ppm or from about 28 ppm to about 66 ppm or from about 30 ppm to about 65 ppm or from about 30 ppm to about 60 ppm or from about 30 ppm to about 55 ppm or from about 30 ppm to about 50 ppm or from about 30 ppm to about 45 ppm.

Therefore, for example, the one or more low-potency sweetener(s) may be present in a composition (e.g. a composition having a base such as milk and yoghurt or other compositions that comprise proteins and/or fats) in a total amount ranging from about 3 ppm to about 20 ppm or from about 4 ppm to about 18 ppm or from about 4 ppm to about 16 ppm or from about 5 ppm to about 15 ppm or from about 6 ppm to about 15 ppm.

In certain embodiments, a sweetened composition comprises at least one sweetener in an amount having a sweetness above its sweetness recognition threshold and/or equal to or greater than about 1.5% (w/v) sucrose equivalence and a sweetness modifying composition consisting of 15 ppm to about 50 ppm of one or more high-intensity sweetener(s) as described herein and 2 ppm to 12 ppm of one or more low-potency sweetener(s) as described herein. In certain embodiments, a comestible composition comprises at least one sweetener and a sweetness modifying composition consisting of 15 ppm to about 30 ppm of one or more high-intensity sweetener(s) as described herein and 2 ppm to 10 ppm of one or more low-potency sweetener(s) as described herein. In certain embodiments, a comestible composition comprises at least one sweetener and a sweetness modifying composition consisting of 20 ppm to about 30 ppm of one or more high-intensity sweetener(s) as described herein and 2 ppm to 10 ppm of one or more low-potency sweetener(s) as described herein. In certain embodiments, a comestible composition comprises at least one sweetener and a sweetness modifying composition consisting of 22 ppm to about 28 ppm of one or more high-intensity sweetener(s) as described herein and 2 ppm to 5 ppm of one or more low-potency sweetener(s) as described herein. In certain embodiments, the high-intensity sweetener is mogroside V. In certain embodiments, the low-potency sweetener is 11-O-mogroside V.

The one or more mogroside(s), for example the one or more of mogroside IV, siamenoside and neomogroside may, for example, be present in a sweetened composition in a total amount equal to or greater than about 15 ppm. For example, the one or more mogroside(s), for example the one or more of mogroside IV, siameonside and neomogroside may, for example, be present in a sweetened composition in a total amount equal to or greater than about 16 ppm or equal to or greater than about 17 ppm or equal to or greater than about 18 ppm or equal to or greater than about 19 ppm or equal to or greater than about 20 ppm or equal to or greater than about 21 ppm or equal to or greater than about 22 ppm or equal to or greater than about 23 ppm or equal to or greater than about 24 ppm or equal to or greater than about 25 ppm. For example, the one or more mogroside(s), for example the one or more of mogroside IV, siamenoside and neomogroside may, for example, be present in a sweetened composition in a total amount equal to or less than about 50 ppm, for example equal to or less than about 45 ppm, for example equal to or less than about 40 ppm, for example equal to or less than about 35 ppm. For example, the one or more mogroside(s), for example the one or more of mogroside IV, siamenoside and neomogroside may be present in a sweetened composition in a total amount ranging from about 15 ppm to about 50 ppm or from about 15 ppm to about 45 ppm or from about 15 ppm to about 40 ppm or from about 15 ppm to about 35 ppm or from about 20 ppm to about 35 ppm or from about 20 ppm to about 30 ppm.

The term “ppm” refers to part(s) per million by weight, for example the weight of a compound, such as Mogroside V (in milligrams) per kilogram of the product containing such compound (i.e. mg/Kg) or the weight of a compound (e.g. orally consumable/comestible product of the present disclosure), such as Mogroside V (in milligrams) per litre of the product containing such compound (i.e. mg/L) or by volume, for example, the volume of a compound, such as Mogroside V (in millilitres) per litre of the product containing such compound (i.e. ml/L).

The sweetness modifying compositions described herein may, for example, comprise higher concentrations of the high-intensity and low-intensity sweeteners and are then diluted in a sweetened composition to obtain the concentrations recited herein.

A sweetened composition comprises at least one sweetener in an amount equal to or greater than its sweetness recognition threshold and/or an amount having a sweetness equal to or greater than about 1.5% (w/v) sucrose equivalence. The term “sweetness recognition threshold” refers to the lowest known concentration of a compound that is perceivable as sweet by the human sense of taste. A sweetness equal to or greater than about 1.5% (w/v) sucrose equivalence is accepted as being “intrinsically sweet” by FEMA.

The at least one sweetener may be nutritive or non-nutritive. Nutritive sweeteners add caloric value to the foods that contain them while non-nutritive sweeteners are very low in calories or contain no calories at all. Aspartame, the only approved nutritive high-intensity sweetener contains more than 2% of the calories in an equivalent amount of sugar as opposed to non-nutritive sweeteners that contain less than 2% of the calories in an equivalent amount of sugar.

The at least one sweetener may, for example, be selected from one or more of sucrose, fructose, glucose, xylose, arabinose, rhamnose, tagatose, allulose, trehalose, isomaltulose, acesulfame potassium (AceK), aspartame, steviol glycoside(s), sucralose, high-fructose corn syrup, starch syrup, saccharin, sucralose, neotame, advantame, Luo Han Guo extract, neohespiridin, dihydrochalcone, naringin dihydrochalcone, neohesperidin dihydrochalcone, rubusoside, rebaudioside A, stevioside, stevia, trilobtain and sugar alcohols such as erythritol, xylitol, mannitol, sorbitol and inositol. Examples of sweeteners that may be used in the sweetened compositions are disclosed, for example, in WO 2016/038617, the contents of which are incorporated herein by reference.

The at least one sweetener may, for example, be selected from one or more of sucrose, high-fructose corn syrup, acesulfame potassium (AceK), aspartame, steviol glycoside(s) and/or sucralose.

How to sweeten consumables using sweeteners in a sufficient amount is well-known in the art. Depending on the consumable, the amount of sweetener can be reduced by addition of a sweetness modifying composition as disclosed herein. For example, a reduction of about 1° to about 4° Brix or more may be achieved.

The at least one other sweetener present in an amount equal to or greater than its sweetness recognition threshold and/or an amount having a sweetness equal to or greater than about 1.5% (w/v) sucrose equivalence may, for example, be used in a sweetened composition in an amount equal to or greater than about 0.01% (w/v). For example, the at least one other sweetener may be used in a sweetened composition in an amount equal to or greater than about 0.1% (w/v) or equal to or greater than about 0.5% (w/v) or equal to or greater than about 1% (w/v) or equal to or greater than about 2% (w/v). For example, the at least one other sweetener may be used in a comestible composition in an amount equal to or less than about 20% (w/v) or equal to or less than about 15% (w/v) or equal to or less than about 10% (w/v) or equal to or less than about 8% (w/v) or equal to or less than about 6% (w/v) or equal to or less than about 5% (w/v).

The at least one other sweetener present in an amount equal to or greater than its sweetness recognition threshold and/or an amount having a sweetness equal to or greater than about 1.5% (w/v) sucrose equivalence may be used in the sweetened compositions disclosed herein (e.g. comestible composition) in amounts isosweet to about 2% (w/v) to about 15% (w/v) sucrose.

In certain embodiments, there is provided herein a sweetness modifying composition consisting of mogroside V and 11-O-mogroside V in a ratio ranging from about 2:1 to about 12:1, for example from about 6:1 to about 10:1. This sweetness modifying composition may, for example, be used as sweetness enhancer or modifier in a comestible composition. The comestible composition may, for example, comprise at least one other sweetener such as sucrose. The mogroside V may, for example, be used in the comestible composition in an amount ranging from about 15 ppm to about 30 ppm or from about 20 ppm to about 30 ppm (e.g. about 20 ppm or about 25 ppm). The 11-O-mogroside V may be used in the comestible composition in an amount ranging from about 2 ppm to about 12 ppm or from about 2 ppm to about 10 ppm (e.g. about 8.5 ppm or about 3 ppm). The at least one other sweetener may, for example, be present in the comestible composition in an amount isosweet to about 2% (w/v) to about 15% (w/v) sucrose.

According to certain illustrative embodiments, the composition comprises (i) rebaudioside M, (ii) a glucosylated steviol glycoside, and (iii) an effective amount of a taste modifier. For the purposes of this specification, the term “taste modifier” refers to one or more components that improves the sweet taste profile of a reduced sugar sweetened composition or sweetened consumable to which it is added. According to certain illustrative embodiments, without limitation, the taste modifier (iii) of the composition may include one or more components in effective amount(s) to mask off-notes associated to the rebaudioside M in the composition and to improve mouthfeel.

The amount of the glucosylated steviol glycoside that is present in the composition may be greater than the amount of rebaudioside M that is present in the composition. By way of example, and not in limitation, the ratio of the rebaudioside M to the glucosylated steviol glycoside that is present in the composition may be in the range of about 1:1 to about 1:1.5. The ratio of the rebaudioside M to the glucosylated steviol glycoside in the composition may be selected from the any one of the ratios 1:1.1, or 1:1.2, or 1:1.3, or 1:1.4, or 1:1.5 By way of illustration, and not in limitation, the ratio of rebaudioside M to glucosylated steviol glycoside in the composition is 1:1.2.

A sweetened composition includes at least one sweetener and the composition comprising (i) rebaudioside M, (ii) a glucosylated steviol glycoside, and (iii) an effective amount of a taste modifier. The amount of glucosylated steviol glycoside present in the composition may be greater than the amount of rebaudioside M present in composition. According to certain illustrative embodiments, without limitation, the taste modifier (iii) of the composition may include one or more components in effective amount(s) to mask off-notes associated to the rebaudioside M in the composition and to improve mouthfeel.

A sweetened consumable may be prepared with the composition containing the (i) rebaudioside M, (ii) a glucosylated steviol glycoside, and (iii) a taste modifier, or with a sweetened composition containing the composition comprising (i) rebaudioside M, (ii) a glucosylated steviol glycoside, and (iii) a taste modifier. According to certain embodiments, the sweetened consumable includes a food or beverage base composition comprising at least one sweetener that is present in an amount at or above its sweetness recognition threshold and/or having a sweetness equal to or greater than about 1.5% (w/v) sucrose equivalence, and the composition comprising (i) rebaudioside M, (ii) a glucosylated steviol glycoside, and (iii) an effective amount of a taste modifier, wherein the amount of the glucosylated steviol glycoside present in the composition is greater than the amount of rebaudioside M present in the composition. According to certain illustrative embodiments, without limitation, the taste modifier (iii) of the composition may include one or more components in effective amount(s) to mask off-notes associated to the rebaudioside M in the composition and to improve mouthfeel.

The glucosylated steviol glycoside included in the composition, sweetened composition and sweetened consumable may be selected from any one or more steviol glycosides capable of having one or more glucose units added to the molecule by a glucosylation reaction. By way of example, but not in limitation, the glucosylated steviol glycoside included in the sweetness modifying composition maybe selected from glucosylated stevioside, glucosylated rebaudioside A, glucosylated rebaudioside B, glucosylated rebaudioside C, glucosylated rebaudioside D, glucosylated rebaudioside E, glucosylated rebaudioside F, glucosylated rebaudioside G, glucosylated rebaudioside H, glucosylated rebaudioside I, glucosylated rebaudioside J, glucosylated rebaudioside K, glucosylated rebaudioside L, glucosylated rebaudioside M, glucosylated rebaudioside N, glucosylated rebaudioside O, glucosylated dulcoside A, glucosylated dulcoside B, glucosylated rubusoside, any other glucosylated steviol glycosides derived from an extract of Stevia rebaudiana, and mixtures thereof.

The glucosylated steviol glycosides may have different degrees of glucosylation. The glucosylated steviol glycoside (ii) of the composition may therefore comprise of blend of the same type of glucosylated steviol glycoside and having different or varying degrees of glucosylation. The glucosylated steviol glycoside (ii) of the composition may also comprise of blend of one or more different types of glucosylated steviol glycoside having the same degree of glucosylation. The glucosylated steviol glycoside (ii) of the composition may further comprise of blend of one or more of different types of glucosylated steviol glycoside with each type having different or varying degrees of glucosylation.

The glucosylated steviol glycosides may comprise a blend of at least one glucosylated steviol glycoside and at least one residual steviol glycoside. A residual steviol glycoside refers to an unreacted steviol glycoside that has not been glucosylated. The residual steviol glycoside may include residual stevioside, residual rebaudioside A, residual rebaudioside B, residual rebaudioside C, residual rebaudioside D, residual rebaudioside E, residual rebaudioside F, residual rebaudioside G, residual rebaudioside H, residual rebaudioside I, residual rebaudioside J, residual rebaudioside K, residual rebaudioside L, residual rebaudioside M, residual rebaudioside N, residual rebaudioside O, residual dulcoside A, residual dulcoside B, residual rubusoside, any other residual steviol glycosides derived from an extract of Stevia rebaudiana, and mixtures thereof. The blend of the at least one glucosylated steviol glycoside and the at least one residual steviol glycoside may comprise about 1 percent and 15 percent of the at least one residual steviol glycoside. According to certain embodiments, the blend of the at least one glucosylated steviol glycoside and the at least one residual steviol glycoside may comprise between about 1 percent and 10 percent, or about 1 percent to about 8 percent, or about 1 percent to about 6 percent, or about 1 percent to about 4 percent, or about 1 percent to about 2 percent, of the at least one residual steviol glycoside.

The glucosylated steviol glycosides may be prepared by preparing a reaction mixture of one or more steviol glycosides, a source of glucose units to be added to the steviol glycoside molecules, an enzyme to catalyze the glucosylation reaction, and a suitable solvent. According to certain embodiments, the glucosylated steviol glycosides are prepared by preparing a reaction mixture of one or more steviol glycosides, a starch as the source of glucose units to be added to the steviol glycoside molecules, CGTase (cyclodextrin glucano-transferase) to catalyze the glucosylation reaction, and water as the solvent. The glycosylation reaction is carried out on the reaction mixture, and the resulting product is purified and dried. By way of example, the glucosylated steviol glycosides may be prepared in accordance with the disclosure of JP2001-120218, which is incorporated by reference. The alpha-glycosyl steviol gluycosides (alpha-GS) are prepared by the alpha-addition of glucose by means of cyclodextrin glucosyl-transferase to a stevia extract that contains at least 1.5 times as much RebA as stevioside.

The taste modifier may comprise one or more of a wide variety compounds. According to certain illustrative embodiments, the taste modifier (iii) of the composition comprises a betaine. A betaine is a zwitterionic quaternary ammonium compound of the following general formula and derivatives thereof:

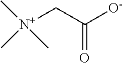

According to other illustrative embodiments, the taste modifier (iii) of the composition comprises a substance of the following formula and derivatives thereof:

CH₂OH—(CHOH)₄—CO—NH—CH₂—CH₂—O—X

wherein X in the formula —OH, —O(CO)R, —OPO₃H₂, —PO₃H₂, —OSO₃H, —SO₃H, and R is a C₂-C₁₀ group containing at least one carboxylic acid group, and derivatives thereof. This substance is more fully described in WO2006/009428, which is incorporated herein by reference.

According to other illustrative embodiments, the taste modifier (iii) of the composition comprises one or more carboxylic acid-amino acid conjugates of the following formula and derivatives thereof:

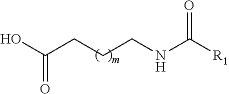

and edible derivatives thereof, wherein R₁ is an alkyl residue having from 6 to 30 carbon atoms, or an alkene residue containing from 9 to 25 carbon atoms with 1 to 6 double bonds together, R₁ with the carbonyl group to which it is attached is a residue of a carboxylic acid, m is 0 or 1. The edible derivatives may comprise an edible salt, including those typically used in the food and beverage industry, including, without limitation, chlorides, sulphates, phosphates, gluconates, sodium salts, citrates, carbonates, acetates and lactates. These carboxylic acid-amino acid conjugates are more fully described in WO2013/148991, which is incorporated herein by reference.

According to other illustrative embodiments, the taste modifier (iii) of the composition comprises one or more carboxylic acid-amino acid conjugates of the following formula and derivatives thereof:

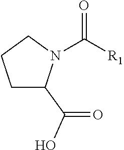

and edible derivatives thereof, wherein R₁ is an alkyl residue having from 6 to 30 carbon atoms, or an alkene residue containing from 9 to 25 carbon atoms with 1 to 6 double bonds together, R¹ with the carbonyl group to which it is attached is a residue of a carboxylic acid, m is 0 or 1. The edible derivatives may comprise an edible salt, including those typically used in the food and beverage industry, including, without limitation, chlorides, sulphates, phosphates, gluconates, sodium salts, citrates, carbonates, acetates and lactates. These carboxylic acid-amino acid conjugates are more fully described in WO2013/149022, which is incorporated herein by reference.

According to other illustrative embodiments, the taste modifier (iii) of the composition comprises one or more carboxylic acid-amino acid conjugates of the following formula and derivatives thereof:

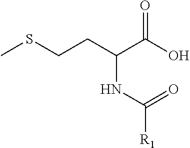

and edible derivatives thereof, wherein R₁ is an alkyl residue having from 6 to 30 carbon atoms, or an alkene residue containing from 9 to 25 carbon atoms with 1 to 6 double bonds together, R¹ with the carbonyl group to which it is attached is a residue of a carboxylic acid, m is 0 or 1. The edible derivatives may comprise an edible salt, including those typically used in the food and beverage industry, including, without limitation, chlorides, sulphates, phosphates, gluconates, sodium salts, citrates, carbonates, acetates and lactates. These carboxylic acid-amino acid conjugates are more fully described in WO2013/149019, which is incorporated herein by reference.

According to other illustrative embodiments, the taste modifier (iii) of the composition comprises one or more of the compounds of the following formulas and derivatives thereof:

### 4-(2,2,3-trimethylcyclopent-3-enyl)but-2-enoic acid (including (E)-4-(2,2,3-trimethylcyclopent-3-enyl)but-2-enoic acid), and (Z)-4-(2,2,3-trimethylcyclopent-3-enyl)but-2-enoic acid)

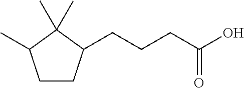

### 4-(2,2,3-trimethylcyclopentyl)butanoic acid

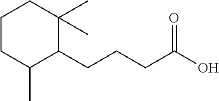

### 4-(2,2,6-trimethylcyclohexyl)butanoic acid

### 3-(2,2,6-trimethylcyclohexyl)propanoic acid

### 2-(3,4-dimethylcyclohexyl)acetic acid

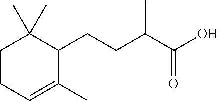 [SMILES: CC1=CCCC(C)(C)C1CCC(C)C(=O)O]

### 2-methyl-4-(2,6,6-trimethylcyclohex-2-enyl)butanoic acid

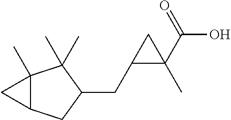 [SMILES: CC1(C(=O)O)CC1CC1CC2CC2(C)C1(C)C]

### 1-methyl-2-((1,2,2-trimethylbicyclo[3.1.0]hexan-3-yl)methyl)cyclopropanecarboxylic acid

### (E)-4-(2,2,3-trimethylcyclopentyl)but-3-enoic acid

### (E)-4-(2,2,3-trimethylcyclopentyl)but-2-enoic acid

### (E)-4-(2,2,3-trimethylcyclohex-3-enyl)but-2-enoic acid

### 2,2-dimethyl-4-(2,2,3-trimethylcyclopentyl)butanoic acid

### 3,3-dimethyl-4-(2,2,3-trimethylcyclopentyl)butanoic acid

### 4-(1-methylbicyclo[3.1.0]hexan-2-yl)butanoic acid

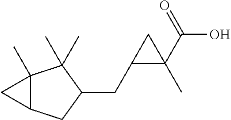 [SMILES: CC1(C(=O)O)CC1CC1CC2CC2(C)C1(C)C]

### 1-methyl-2-((1,2,2-trimethylbicyclo[3.1.0]hexan-3-yl)methyl)cyclopropanecarboxylic acid

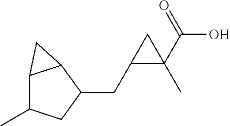

### 2-((1,4-dimethyl-bicyclo[3.1.0]hexan-3-yl)methyl)cyclopropanecarboxylic acid

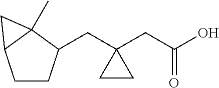

### 2-(1-((1-methyl-bicyclo[3.1.0]hexan-2-yl)methyl)cyclopropyl)acetic acid

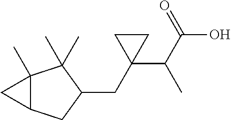 [SMILES: CC(C(=O)O)C1(CC2CC3CC3(C)C2(C)C)CC1]

### 2-(1-((1,2,2-trimethyl-bicyclo[3.1.0]hexan-3-yl)methyl)cyclopropyl)propanoic acid

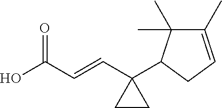 [SMILES: CC1=CCC(C2(/C=C/C(=O)O)CC2)C1(C)C]

### (E)-3-(1-(2,2,3-trimethyl-cyclopent-3-enyl)cyclopropyl)acrylic acid

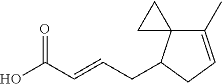

### (E)-4-(7-methylspiro[2.4]hept-6-en-4-yl)but-2-enoic acid

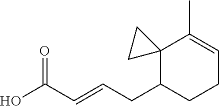

### (E)-4-(8-methylspiro[2.5]oct-7-en-4-yl)but-2-enoic acid

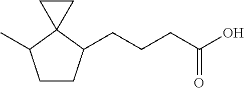

### 4-(7-methylspiro[2.4]heptan-4-yl)butanoic acid

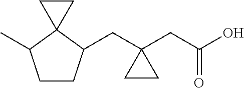 [SMILES: CC1CCC(CC2(CC(=O)O)CC2)C12CC2]

### 2-(1-((7-methyl-spiro[2.4]heptan-4-yl)methyl)cyclopropyl)acetic acid

### 2-(1-((1-methylbicyclo[3.1.0]hexan-2-yl)methyl)cyclopropyl)acetic acid

### 2-((6,7-dimethylspiro[2.4]heptan-4-yl)methyl)-1-methylcyclopropanecarboxylic acid

### 1-(2-(7-methylspiro[2.4]heptan-4-yl)ethyl)cyclopropanecarboxylic acid

### (E)-1-(2-(7-methylspiro[2.4]heptan-4-yl)vinyl)cyclopropanecarboxylic acid

### 2-(1-((1,4-dimethylbicyclo[3.1.0]hexan-2-yl)methyl)cyclopropyl)propanoic acid

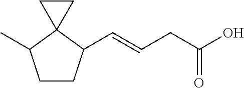

### (E)-4-(7-methylspiro[2.4]heptan-4-yl)but-3-enoic acid

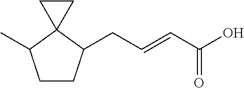

### (E)-4-(7-methylspiro[2.4]heptan-4-yl)but-2-enoic acid

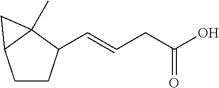

### (E)-4-(1-methyl-bicyclo[3.1.0]hexan-2-yl)but-3-enoic acid

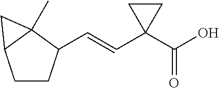

### (E)-1-(2-(1-methylbicyclo[3.1.0]hexan-2-yl)vinyl)cyclopropanecarboxylic acid

The above compounds are more fully described in WO2008/119197 and WO2008/119196, which are fully incorporated herein by reference.

According to other illustrative embodiments, the taste modifier (iii) of the composition comprises one or more of a chlorogenic acid. The term chlorogenic acid refers to quinic acid conjugates comprising one or more compounds of a family of esters that form between cis and trans cinnamic acids (for example, caffeic acid, ferulic acid, p-coumaric acid, sinapic acid) and quinic acid. The quinic acid conjugates are represent by the following formula:

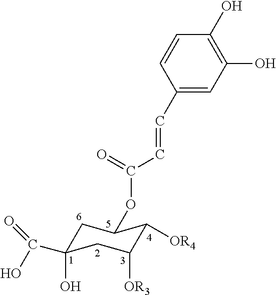

wherein certain illustrative quinic acid conjugates are defined by the R group substitutions shown in the following table:

| Identity of R3 | Identity of R4 | Identity of R5 |
|---|---|---|
| caffeic acid | H | H |
| H | caffeic acid | H |
| H | H | caffeic acid |
| ferulic acid | H | H |
| H | ferulic acid | H |
| H | H | ferulic acid |
| p-coumaric acid | H | H |
| H | p-coumaric acid | H |
| H | H | p-coumaric acid |
| caffeic acid | caffeic acid | H |
| caffeic acid | H | caffeic acid |
| H | caffeic acid | caffeic acid |
| caffeic acid | ferulic acid | H |
| ferulic acid | caffeic acid | H |
| caffeic acid | H | ferulic acid |
| ferulic acid | H | caffeic acid |
| H | caffeic acid | ferulic acid |
| H | ferulic acid | caffeic acid |

The use of chlorogenic acids as a taste modifier is more fully described in WO2002/100192, which is fully incorporated herein by reference.

According to other illustrative embodiments, the taste modifier (iii) of the composition comprises one or more of a phenyl pyridyl ketone of the following formulas:

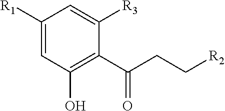

wherein R₁ may be H, OH, O(CH₂)₂OH, OCH₂OCH₃ or

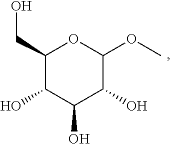

R₂ may be selected from a range of 5- and 6-membered heterocyclic rings, and wherein R₃ may be H or OH.

The structure and use of phenyl pyridyl ketones as a taste modifier is more fully described in WO2012/123475 and WO 2009/105906, which are fully incorporated herein by reference.

According to other illustrative embodiments, the taste modifier (iii) of the composition may comprise rebaudioside A as described in WO2007/121605, WO2008/049256 and WO2009/023975, and blends of rebaudioside A and stevioside as described in WO2013/060746, all of which are incorporated by reference.

According to other illustrative embodiments, the taste modifier (iii) of the composition may comprise one or more compounds defined by the following formula and derivatives thereof (such as salts thereof): [symbol]
in which
R¹ is H, methyl or ethyl;
R² is H, OH, fluorine, C₁-C₄ linear or branched alkyl, C₁-C₆ alkoxy wherein the alkyl group is linear or branched, or a C₃-C₅ cycloalkyl moiety;
R³ is H, methoxy, methyl or ethyl;
or R² and R³ together form a bridging moiety —O—CH₂—O— between the phenyl carbon atoms to which they are connected;
R⁴ is OH or methoxy; and
R⁵ and R⁶ are independently H or methyl;
R¹, R², R³, R⁴, R⁵ and R⁶ are such that,
   (i) when R² and R³ together form a bridging moiety —O—CH₂—O— between the phenyl carbon atoms to which they are connected, R¹, R⁵, R⁶ are H, and R⁴ is OH; and
   (ii) when R⁴ is OH and R¹-R³ are H, at least one of R⁵, R⁶ is methyl.

These compounds are more fully described in WO2011/004016, which is fully incorporated herein by reference.

According to other illustrative embodiments, the taste modifier (iii) of the composition may comprise one or more compounds defined by the following formula and derivatives thereof (such as salts thereof):

R¹—CR⁷(OR⁴)—CO—NR²—CR⁸R³—X—OR⁵ (I)

R⁶—CR⁷(OR⁴)—CO-Az (II)
wherein:
X represents a covalent bond; C₁-C₅ alkyl or C₂-C₅ alkenyl, each optionally substituted with 1-4 substituents selected from hydroxyl, C₁-C₃ alkyl and C₁-C₃ alkenyl;
R¹ and R⁷ independently represent hydrogen; or C₁-C₈ alkyl, C₂-C₈ alkenyl or C₃-C₈ cycloalkyl, each optionally substituted with 1-8 substituents selected from hydroxyl, oxo, C₁-C₃ alkyl; C₂-C₃ alkenyl and C₁-C₃ carboxyl;
R² represents hydrogen; or C₁-C₆ alkyl, C₂-C₆ alkenyl, C₃-C₆ cycloalkyl C₃-C₆ cycloalkenyl or C₁-C₆ acyl, each optionally substituted with 1-6 substituents selected from hydroxyl, C₁-C₃ alkyl and C₂-C₃ alkenyl;
R³ and R⁸ independently represent hydrogen; hydroxyl; or C₁-C₈ alkyl, C₂-C₈ alkenyl, or C₃-C₈ cycloalkyl, each optionally substituted with 1-8 substituents selected from hydroxyl, C₁-C₃ alkyl and C₂-C₃ alkenyl;
R⁴ represents hydrogen, C₁-C₃ acyl or C₁-C₃ alkyl;
R⁵ represents hydrogen, C₁-C₃ acyl, C₁-C₃ alkyl, a phosphate group selected from mono-, di- and triphosphate or a C₂-C₅ carboxyacyl, optionally further substituted with 1-3 substituents selected from hydroxyl, oxo, C₁-C₃ carboxyl;
R⁶ represents C₂-C₆ alkyl or C₄-C₆ cycloalkyl each optionally substituted with 1-6 hydroxyl groups and each optionally substituted with 1-4 substituents selected from C₁-C₃ alkyl and C₁-C₃ carboxyl; and
Az represents an amino acid residue, and the CO-Az bond represents an amide bond;
provided that R¹—CR⁷(OR⁴)—CO— does not represent a hexose or heptose sugar acid residue comprising more than 4 hydroxyl groups.

These compounds are more fully described in WO2005/102071 and WO/2006/009425, which are fully incorporated herein by reference.

According to other illustrative embodiments, the taste modifier (iii) of the composition may comprise choline chloride in amounts ranging from 500 ppb to 500 ppm, particularly from about 10 ppm to about 50 ppm, as described in WO2011/073187, which is incorporated by reference.

According to other illustrative embodiments, the taste modifier (iii) of the composition may comprise gamma amino butyric acid as described in WO2011/039340, which is incorporated by reference.

According to other illustrative embodiments, the taste modifier (iii) of the composition may comprise a mega fatty complex as described in WO2016/062743, which is incorporated by reference. Mega fatty complex refers to a composition prepared from arachidonic acid-enriched single cell oils. Single cell oils are edible oils that are extracted from single cell microorganisms, such as algae, bacteria and yeast. Methods for the preparation of mega fatty complex is also described in U.S. Pat. No. 5,178,892 and US 2007/009642.

Each of the rebaudioside M and the glucosylated steviol glucoside independently may be present in the composition an in amount greater than, less than, or equal to their respective sweetness recognition threshold.

According to certain illustrative embodiments, rebaudioside M and the glucosylated steviol glucoside are both present in the composition in amounts that are less than their respective sweetness recognition thresholds.

According to certain illustrative embodiments, rebaudioside M and the glucosylated steviol glucoside are both present in the composition in amounts that are greater than their respective sweetness recognition thresholds.

According to certain illustrative embodiments, rebaudioside M is present in the composition in an amount that is greater than its sweetness recognition threshold and the glucosylated steviol glucoside is present in an amount that is less than its sweetness recognition threshold.

According to certain illustrative embodiments, rebaudioside M is present in the composition in an amount that is less than its sweetness recognition threshold and the glucosylated steviol glucoside is present in an amount that is greater than its sweetness recognition threshold.

According to certain illustrative embodiments, rebaudioside M is present in the composition in an amount of about 50 to about 360 ppm and the glucosylated steviol glycoside is present in the composition in an amount of about 60 to about 430 ppm.

According to certain illustrative embodiments, rebaudioside M is present in the composition in an amount of greater than 0 to about 25 ppm and the glucosylated steviol glycoside is present in the composition in an amount of greater than 0 to about 100 ppm.

According to certain illustrative embodiments, rebaudioside M is present in the composition in an amount of about 50 to about 360 ppm and the glucosylated steviol glycoside is present in the composition in an amount of greater than 0 to about 100 ppm.

According to certain illustrative embodiments, rebaudioside M is present in the composition in an amount of greater than 0 to about 25 ppm and the glucosylated steviol glycoside is present in the composition in an amount of about 60 to about 430 ppm.

According to certain embodiments, the amount of (i) rebaudioside M present in the composition is from about 50 ppm to about 360 ppm and all ranges within this range, including but not limited to, from about 50 to about 300 ppm, from about 50 ppm to about 250 ppm, from about 50 ppm to about 200 ppm, from about 50 ppm to about 150 ppm, from about 50 ppm to about 100 ppm, from about 100 ppm to about 360 ppm, from about 100 ppm to about 300 ppm, from about 100 ppm to about 250 ppm, from about 100 ppm to about 200 ppm, from about 100 ppm to about 150 ppm, from about 150 ppm to about 360 ppm, from about 150 ppm to about 300 ppm, from about 150 ppm to about 250 ppm, from about 150 ppm to about 200 ppm, from about 200 ppm to about 360 ppm, from about 200 ppm to about 300 ppm, from about 200 ppm to about 250 ppm, from 250 ppm to about 360 ppm, and from about 250 ppm to about 300 ppm.

According to certain embodiments, the amount of (i) rebaudioside M present in the composition is from greater than 0 ppm to about 25 ppm and all ranges within this range, including but not limited to, from greater than 0 ppm to about 24 ppm, from greater than 0 ppm to about 23 ppm, from greater than 0 ppm to about 22 ppm, from greater than 0 ppm to about 21 ppm, from greater than 0 ppm to about 20 ppm, from greater than 0 ppm to about 19 ppm, from greater than 0 ppm to about 18 ppm, from greater than 0 ppm to about 17 ppm, from greater than 0 ppm to about 16 ppm, from greater than 0 ppm to about 15 ppm, from greater than 0 ppm to about 14 ppm, from greater than 0 ppm to about 13 ppm, from greater than 0 ppm to about 12 ppm, from greater than 0 ppm to about 11 ppm, from greater than 0 ppm to about 10 ppm, from greater than 0 ppm to about 9 ppm, from greater than 0 ppm to about 8 ppm, from greater than 0 ppm to about 7 ppm, from greater than 0 ppm to about 6 ppm, from greater than 0 ppm to about 5 ppm, from greater than 0 ppm to about 4 ppm, from greater than 0 ppm to about 3 ppm, from greater than 0 ppm to about 2 ppm, from greater than 0 ppm to about 1 ppm, from about 5 ppm to about 25 ppm, about 5 ppm to about 20 ppm, from about 5 ppm to about 15 ppm, from about 5 ppm to about 10 ppm, from about 10 ppm to about 25 ppm, from about 10 ppm to about 20 ppm, from about 10 ppm to about 15 ppm, from about 15 ppm to about 25 ppm, from about 15 ppm to about 20 ppm, from about 20 ppm to about 25 ppm.

According to certain embodiments, the amount of (ii) glucosylated steviol glycoside present in the composition is from about 60 ppm to about 430 ppm and all ranges within this range, including but not limited to, from about 60 to about 400 ppm, from about 60 ppm to about 350 ppm, from about 60 ppm to about 300 ppm, from about 60 ppm to about 250 ppm, from about 60 ppm to about 200 ppm, from about 60 ppm to about 150 ppm, from about 60 ppm to about 100 ppm, from about 60 ppm to about 75 ppm, from about 100 ppm to about 430 ppm, from about 100 ppm to about 400 ppm, from about 100 ppm to about 350 ppm, from about 100 ppm to about 300 ppm, from about 100 ppm to about 250 ppm, from about 100 ppm to about 200 ppm, from about 100 ppm to about 150 ppm, from about 150 ppm to about 430 ppm, from about 150 ppm to about 400 ppm, from 150 ppm to about 350 ppm, from about 150 ppm to about 300 ppm, from about 150 ppm to about 250 ppm, from about 150 ppm to about 200 ppm, from about 200 ppm to about 430 ppm, from about 200 ppm to about 350 ppm, from about 200 ppm to about 300 ppm, from about 200 ppm to about 250 ppm, from about 250 ppm to about 430 ppm, from about 250 ppm, to about 400 ppm, from about 250 ppm to about 350 ppm, from about 250 ppm to about 300 ppm, from about 300 ppm to about 430 ppm, from about 300 ppm to about 400 ppm, from about 300 ppm to about 350 ppm, from about 350 ppm to about 430 ppm and from about 350 ppm to about 400 ppm.

According to certain embodiments, the amount of (ii) glucosylated steviol glycoside present in the composition is from greater than 0 ppm to about 28 ppm and all ranges within this range, including but not limited to, from greater than 0 ppm to about 27 ppm, from greater than 0 ppm to about 26 ppm, from greater than 0 ppm to about 25 ppm, from greater than 0 to about 24 ppm, from greater than 0 ppm to about 23 ppm, from greater than 0 ppm to about 22 ppm, from greater than 0 ppm to about 21 ppm, from greater than 0 ppm to about 20 ppm, from greater than 0 ppm to about 19 ppm, from greater than 0 ppm to about 18 ppm, from greater than 0 ppm to about 17 ppm, from greater than 0 ppm to about 16 ppm, from greater than 0 ppm to about 15 ppm, from greater than 0 ppm to about 14 ppm, from greater than 0 ppm to about 13 ppm, from greater than 0 ppm to about 12 ppm, from greater than 0 ppm to about 11 ppm, from greater than 0 ppm to about 10 ppm, from greater than 0 ppm to about 9 ppm, from greater than 0 ppm to about 8 ppm, from greater than 0 ppm to about 7 ppm, from greater than 0 ppm to about 6 ppm, from greater than 0 ppm to about 5 ppm, from greater than 0 ppm to about 4 ppm, from greater than 0 ppm to about 3 ppm, from greater than 0 ppm to about 2 ppm, from greater than 0 ppm to about 1 ppm, from about 5 ppm to about 25 ppm, about 5 ppm to about 20 ppm, from about 5 ppm to about 15 ppm, from about 5 ppm to about 10 ppm, from about 10 ppm to about 25 ppm, from about 10 ppm to about 20 ppm, from about 10 ppm to about 15 ppm, from about 15 ppm to about 25 ppm, from about 15 ppm to about 20 ppm, from about 20 ppm to about 25 ppm.

According to certain illustrative embodiments, rebaudioside M is present in the composition in an amount from about 80 to about 100 ppm and the glucosylated steviol glycoside is present in the composition in an amount from 100 ppm to about 120 ppm.

According to other illustrative embodiments, rebaudioside M is present in the composition in an amount from about 90 to about 100 ppm and the glucosylated steviol glycoside is present in the composition in an amount from 110 ppm to about 120 ppm.

According to certain embodiments, the amount of (iii) taste modifier present in the composition is from about 500 ppm to about 4000 ppm, or from about 500 ppm to about 3500 ppm, or from about 500 ppm to about 3000 ppm, or from about 500 ppm to about 2500 ppm, or from about 500 ppm to about 2000 ppm, or from about 500 ppm to about 1500 ppm, or from about 500 ppm to about 1000 ppm, or from about 1000 ppm to about 4000 ppm, or from about 1000 ppm to about 3000 ppm, or from about 1000 ppm to about 2000 ppm, or from about 2000 ppm to about 4000 ppm, or from about 2000 ppm to about 3000 ppm.

The composition may be used to replace 5 percent or more, or 10 percent or more, or 20 percent or more, or 30 percent or more, or 40 percent or more, or 50 percent or more, or 60 percent or more, or 70 percent or more, or 80 percent or more, or 90 percent or more, of the sugar in a sweetened consumable. According to certain embodiments, the composition may be used to replace from about 30 percent to about 100 percent of the sugar in a sweetened consumable. According to certain illustrative embodiments, the composition may be used to replace from about 30 percent to about 90 percent, or from about 30 percent to about 80 percent, or from about 30 percent to about 70 percent, or from about 30 percent to about 60 percent, or from about 30 percent to about 50 percent of the sugar in a sweetened consumable. According to other illustrative embodiments, the composition may be used to replace from about 50 percent to about 100 percent, or from about 50 percent to about 90 percent, or from about 50 percent to about 80 percent, or from about 50 percent to about 70 percent, or from about 50 percent to about 60 percent of the sugar in a sweetened consumable. According to other illustrative embodiments, the composition may be used to replace from about 30 percent, or about 50 percent, or about 70 percent, or about 80 percent or about 100 percent of the sugar in a sweetened consumable. The amounts of the rebaudioside M and glucosylated steviol glycoside are present in the composition in amounts effective to replace the desired amount of sugar.

According to certain illustrative embodiments, the combined amount of (i) rebaudioside M and (ii) glucosylated steviol glycoside is from about 85 percent to about 95 percent, and every amount within this range, and the amount of the (iii) taste modifier is from about 5 percent to about 15 percent and every amount within in this range, or the combined amount of (i) rebaudioside M and (ii) glucosylated steviol glycoside is from about 86 percent to about 95 percent and the amount of the (iii) taste modifier is from about 5 percent to about 14 percent, or the combined amount of (i) rebaudioside M and (ii) glucosylated steviol glycoside is from about 87 percent to about 95 percent and the amount of the (iii) taste modifier is from about 5 percent to about 13 percent, or the combined amount of (i) rebaudioside M and (ii) glucosylated steviol glycoside is from about 88 percent to about 95 percent and the amount of the (iii) taste modifier is from about 5 percent to about 12 percent, or the combined amount of (i) rebaudioside M and (ii) glucosylated steviol glycoside is from about 89 percent to about 95 percent and the amount of the (iii) taste modifier is from about 5 percent to about 11 percent, or the combined amount of (i) rebaudioside M and (ii) glucosylated steviol glycoside is from about 80 percent to about 95 percent and the amount of the (iii) taste modifier is from about 5 percent to about 10 percent.

The sweetened consumable, such as a carbonated soft drink beverage or still fruit juice beverage, may comprise from about 30 percent to about 70 percent of a beverage base including at least sweetener and every amount within this range, or from about 40 percent to about 65 percent of the food or beverage base, or from about 40 percent to about 50 percent of the food or beverage base. The sweetened consumable may comprise from about 0.1 percent to about 0.6 percent of the composition comprising (i) rebaudioside M, (ii) a glucosylated steviol glycoside, and (iii) taste modifier, or from about 0.1 percent to about 0.5 percent of the composition comprising (i) rebaudioside M, (ii) a glucosylated steviol glycoside, and (iii) taste modifier, and any amount within this range, or from about 0.1 percent to about 0.4 percent of the composition comprising (i) rebaudioside M, (ii) a glucosylated steviol glycoside, and (iii) taste modifier, or from about 0.1 percent to about 0.3 percent of the composition comprising (i) rebaudioside M, (ii) a glucosylated steviol glycoside, and (iii) taste modifier, or from about 0.1 percent to about 0.2 percent of the composition comprising (i) rebaudioside M, (ii) a glucosylated steviol glycoside, and (iii) taste modifier, or from about 0.1 percent to about 0.15 percent of the composition comprising (i) rebaudioside M, (ii) a glucosylated steviol glycoside, and (iii) taste modifier, or from about 0.1 percent to about 0.125 percent of the composition comprising (i) rebaudioside M, (ii) a glucosylated steviol glycoside, and (iii) taste modifier.

A sweetened milk beverage may comprise a milk beverage base and a composition containing (i) rebaudioside M, (ii) a glucosylated steviol glycoside, and (iii) taste modifier in an amount from about 0.05 percent to about 0.3 percent of the total milk beverage, or in an amount from about 0.05 percent to about 0.275 percent of the total milk beverage, or in an amount from about 0.05 percent to about 0.25 percent of the total milk beverage, or in an amount from about 0.05 percent to about 0.2 percent of the total milk beverage, or in an amount from about 0.05 percent to about 0.15 percent of the total milk beverage, or in an amount from about 0.05 percent to about 0.1 percent of the total milk beverage.

The sweetened yogurt composition may comprise a yogurt base and a composition containing (i) rebaudioside M, (ii) a glucosylated steviol glycoside, and (iii) taste modifier in an amount from about 0.05 percent to about 0.2 percent of the total yogurt composition, or in an amount from about 0.1 percent to about 0.2 percent of the total yogurt composition, or in an amount from about 0.1 percent to about 0.185 percent of the total yogurt composition, or in an amount from about 0.1 percent to about 0.15 percent of the total yogurt composition, or in an amount from about 0.1 percent to about 0.125 percent of the total yogurt composition, or in an amount from about 0.05 percent to about 0.1 percent of the total yogurt composition.

The at least one sweetener included in the sweetened composition and sweetened consumable may be selected from any one or more of the nutritive and non-nutritive sweeteners described hereinabove.

The compositions may be in any suitable form, for example solid (e.g. powder, granules, tablets) or in solution (e.g. aqueous solution) or in an emulsion or in a suspension. For example, the compositions may further comprise a diluent or bulking agent such as dietary fibre.

Comestible compositions as disclosed herein include, for example, the following.
Wet/liquid soups regardless of concentration or container, including frozen soups. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).
Dehydrated and culinary foods, including cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology).
Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes.
Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.
Beverages, including beverage mixes and concentrates, including but not limited to, alcoholic and non-alcoholic ready to drink and dry powdered beverages, carbonated and non-carbonated beverages, e.g., sodas, fruit or vegetable juices, alcoholic and non-alcoholic beverages.
Confectionery products, e.g., cakes, cookies, pies, candies, chewing gums, gelatins, ice creams, sorbets, puddings, jams, jellies, salad dressings, and other condiments, cereal, and other breakfast foods, canned fruits and fruit sauces and the like.
Dairy products such as milk, cheese, yoghurt.
Pharmaceutical compositions which may, for example, be in the form of a syrup, an emulsion, a suspension, a solution or other liquid form.
Dental compositions including, for example, mouth freshening agents, gargling agents, mouth rinsing agents, toothpaste, tooth polish, dentifrices, mouth sprays and dental floss.
Edible gel compositions

The compositions disclosed herein may further comprise a base composition. For example, the comestible compositions disclosed herein may further comprise a comestible base composition. This refers to all the ingredients necessary for the composition except the combination of the high-intensity sweetener and low-potency sweetener (e.g. sweetness modifying composition). The base composition may, for example, be a sweetened base composition comprising at least one other sweetener present in an amount equal to or greater than its sweetness recognition threshold and/or an amount having a sweetness equal to or greater than about 1.5% (w/v) sucrose equivalence. These will naturally vary in both nature and proportion, depending on the nature and use of the composition, but they are well known in the art and may be used in art-recognised proportions. The formulation of such a base composition for every conceivable purpose is therefore within the ordinary skill in the art.

The ingredients in a base composition may include, but are not limited to, anti-caking agents, anti-foaming agents, anti-oxidants, binders, colourants, diluents, disintegrants, emulsifiers, encapsulating agents or formulations, enzymes, fats, flavour-enhancers, flavouring agents, gums, lubricants, polysaccharides, preservatives, proteins, solubilisers, solvents, stabilisers, sugar-derivatives, surfactants, sweetening agents, vitamins, waxes, and the like. Solvents which may be used are known to those skilled in the art and include e.g. ethanol, ethylene glycol, propylene glycol, glycerine and triacetin. Encapsulants and gums include maltodextrin, gum arabic, alginates, gelatine, modified starch, and polysaccharides.

Examples of additives, excipients, carriers, diluents or solvents for flavour or fragrance compounds may be found e.g. in “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

The proportion of the combination of the one or more high-intensity sweetener(s) and one or more low-potency sweetener(s) (e.g. sweetness modifying composition) or the one or more sweetness enhancer(s) selected from mogroside IV, siamenoside and neomogroside will depend on the nature of the composition and the degree and characteristics of the sweetness desired. The skilled person can readily ascertain the appropriate proportion in every case with only simple, non-inventive experimentation. The amounts and proportions disclosed herein are exemplary only and the flavourist may seek particular effects by working outside this range, and it should be regarded as an indication only.

The pH of the composition disclosed herein may be any pH that does not adversely affect the taste of the sweetener blend. For example, the pH may range from about 1.8 to about 8 or from about 2 to about 5. A person skilled in the art would be able to identify a suitable concentration of each sweetener to use depending on the pH of the composition.

The use of the one or more low-potency sweetener(s) with the one or more high-intensity sweetener(s) may, for example, improve one or more sweetness characteristics in a sweetened composition in comparison to the use of the one or more high-intensity sweetener(s) alone. Thus, the sweetened compositions disclosed herein may, for example, have one or more improved sweetness characteristics compared to the sweetened compositions in the absence of the one or more low-potency sweetener(s). The use of one or more sweetness enhancer(s) selected from mogroside IV, siamenoside and neomogroside may, for example, improve one or more sweetness characteristics of a sweetened composition in comparison to the use of a different sweetness enhancer such as Luo Han Guo extract in place of the one or more of mogroside IV, siamenoside and neomogroside.

The sweetened compositions disclosed herein may, for example, have one or more sweetness characteristics that are more similar to sucrose compared to the sweetened compositions in the absence of the one or more low-potency sweetener(s) or compared to the sweetened compositions comprising a different sweetness enhancer.

The sweetened compositions disclosed herein may, for example, have a weakened lingering sweet taste in compared to the sweetened compositions in the absence of the one or more low-potency sweetener(s) or compared to the sweetened compositions comprising a different sweetness enhancer.

The sweetened compositions disclosed herein may, for example, have a weakened bitter taste and/or astringent taste and/or metallic taste and/or liquorice taste compared to the sweetened compositions in the absence of the one or more low-potency sweetener(s) or compared to the sweetened compositions comprising a different sweetness enhancer.

The sweetened compositions disclosed herein may, for example, have a strengthened sweetness impact compared to the sweetened compositions in the absence of the one or more low-potency sweetener(s) or compared to the sweetened compositions comprising a different sweetness enhancer.

The comparative sweetened composition is identical except that it does not include any of the one or more low-potency sweetener(s) or identical except that it comprises a different sweetness enhancer in place of the one or more mogroside(s), for example one or more of mogroside IV, siamenoside and neomogroside.

### Uses

There is provided herein the use of a combination of one or more high-intensity sweetener(s) and one or more low-potency sweetener(s) to enhance the sweetness of a composition comprising at least one other sweetener present an amount equal to or greater than its sweetness recognition threshold and/or an amount having a sweetness equal to or greater than about 1.5% (w/v) sucrose equivalence. The combination of the one or more high-intensity sweetener(s) and one or more low-intensity sweetener(s) has a sweetness less than 1.5% (w/v) sucrose equivalence. The one or more high-intensity sweetener(s), one or more low-potency sweetener(s) and at least one other sweetener may be in accordance with any embodiment disclosed herein.

There is provided herein the use of one or more mogroside(s), for example one or more of mogroside IV, siamenoside and neomogroside to enhance the sweetness of a composition comprising at least one other sweetener present an amount equal to or greater than its sweetness recognition threshold and/or an amount having a sweetness equal to or greater than about 1.5% (w/v) sucrose equivalence.

Thus, there is provided a method for enhancing the sweetness of a sweetened composition, the method comprising providing a base composition comprising at least one sweetener in an amount having a sweetness above its sweetness recognition threshold and/or an amount having a sweetness equal to or greater than about 1.5% (w/v) sucrose equivalence, and adding at least one low-potency sweetener, at least one high-intensity sweetener; or adding one or more mogroside(s), for example one or more of mogroside IV, siamenoside and neomogroside. Each component of the final composition may be added in any order to obtain the desired final composition. The method may, for example, comprise mixing the components.

The one or more high-intensity sweetener and/or the combination of the one or more high-intensity sweetener and the one or more low-potency sweetener (e.g. the sweetness modifying composition) and/or the one or more mogroside(s), for example one or more of mogroside IV, siamenoside and neomogroside may, for example, increase the sweetness of a sweetened composition by equal to or more than about 1.0% (w/v) sucrose equivalence. For example, the high-intensity sweetener(s) and/or the combination of the high-intensity sweetener(s) and the low-potency sweetener(s) and/or the one or more mogroside(s), for example one or more of mogroside IV, siamenoside and neomogroside may increase the sweetness of a sweetened composition by equal to or greater than about 1.1% (w/v) sucrose equivalence or equal to or greater than about 1.15% (w/v) sucrose equivalence or equal to or greater than about 1.2% (w/v) sucrose equivalence or equal to or greater than about 1.25% (w/v) sucrose equivalence. The composition may, for example, be a composition comprising at least one other sweetener.

There is also provided herein the use of one or more low-potency sweetener(s) to improve one or more sweetness characteristics of a sweetened composition comprising one or more high-intensity sweetener(s). The one or more high-intensity sweetener(s) and one or more low-potency sweetener(s) are used in amounts having a sweetness of less than about 1.5% (w/v) sucrose equivalence.

According to certain embodiments, there is also provided the use of a composition comprising (i) rebaudioside M, (ii) a glucosylated steviol glycoside, and (iii) an effective amount of taste modifier to improve one or more sweetness characteristic(s) of a sweetened composition compared to the respective sweetness characteristic(s) of the sweetened composition in the absence of the composition. The amounts and ratio of the rebaudioside M and glucosylated steviol glycoside present in the composition are any of those described hereinabove for the composition.

According to certain embodiments, there is also provided the use of a composition comprising (i) rebaudioside M, (ii) a glucosylated steviol glycoside, and (iii) an effective amount of taste modifier to improve the upfront sweetness of the sweetened composition compared to the upfront sweetness of the sweetened composition in the absence of the composition. The amounts and ratio of the rebaudioside M and glucosylated steviol glycoside present in the composition are any of those described hereinabove for the composition.

According to certain embodiments, there is also provided the use of a composition comprising (i) rebaudioside M, (ii) a glucosylated steviol glycoside, and (iii) an effective amount of a taste modifier to weaken the bitter off-note tastes of a sweetened composition compared to the bitter off-note taste of the sweetened composition in the absence of the composition. The amounts and ratio of the rebaudioside M and glucosylated steviol glycoside present in the composition are any of those described hereinabove for the composition.

According to certain embodiments, there is also provided the use of a composition comprising (i) rebaudioside M, (ii) a glucosylated steviol glycoside, and (iii) an effective amount of taste modifier to weaken the dry and/or astringent mouthfeel of a sweetened composition compared to the dry and/or astringent mouthfeel of the sweetened composition in the absence of the composition. The amounts and ratio of the rebaudioside M and glucosylated steviol glycoside present in the composition are any of those described hereinabove for the composition.

According to certain embodiments, there is also provided the use of a composition comprising (i) rebaudioside M or a glucosylated steviol glycoside and (ii) an effective amount of taste modifier to improve one or more sweetness characteristic(s) of a sweetened composition compared to the respective sweetness characteristic(s) of the sweetened composition in the absence of the composition.

According to certain embodiments, there is also provided the use of a composition comprising (i) rebaudioside M or a glucosylated steviol glycoside, and (ii) an effective amount of taste modifier to improve the upfront sweetness of the sweetened composition compared to the upfront sweetness of the sweetened composition in the absence of the composition.

According to certain embodiments, there is also provided the use of a composition comprising (i) rebaudioside M or a glucosylated steviol glycoside, and (ii) an effective amount of taste modifier to reduce the amount of sugar in a sweetened composition.

According to certain embodiments, there is also provided the use of a composition comprising (i) rebaudioside M or a glucosylated steviol glycoside, and (ii) an effective amount of a taste modifier to weaken the bitter off-note tastes of a sweetened composition compared to the bitter off-note taste of the sweetened composition in the absence of the composition.

According to certain embodiments, there is also provided the use of a composition comprising (i) rebaudioside M or a glucosylated steviol glycoside, and (ii) an effective amount of taste modifier to weaken the dry and/or astringent mouthfeel of a sweetened composition compared to the dry and/or astringent mouthfeel of the sweetened composition in the absence of the composition.

Thus, there is provided a method for improving one or more sweetness characteristics of a sweetened composition comprising one or more high-intensity sweetener(s) in an amount having a sweetness less than 1.5% (w/v) sucrose equivalence, the method comprising providing a composition comprising one or more high-intensity sweetener(s) and adding one or more low-potency sweetener(s). Each component of the final composition may be added in any order to obtain the desired final composition. The method may, for example, comprise mixing the components.

The improvement of one or more sweetness characteristics of a sweetened composition comprising a high-intensity sweetener may, for example, provide sweetness characteristics that are more similar to the sweetness characteristics of sucrose.

According to certain embodiments, provided is a method of enhancing the sweetness of a sweetened composition which comprises providing a base composition comprising at least one sweetener present in an amount at or above its sweetness recognition threshold and/or having a sweetness equal to or greater than about 1.5% (w/v) sucrose equivalence, and adding a composition to the base composition, the sweetness modifying composition comprising (i) rebaudioside M, (ii) a glucosylated steviol glycoside, and (iii) an effective amount of a taste modifier. The amounts and ratio of the rebaudioside M and glucosylated steviol glyucoside present in the composition are any of those described hereinabove for the composition.

According to certain embodiments, provided is a method of improving one or more sweetness characteristic(s) of a sweetened composition which comprises providing a base composition comprising at least one sweetener present in an amount at or above its sweetness recognition threshold and/or having a sweetness equal to or greater than about 1.5% (w/v) sucrose equivalence, and adding a composition to the base composition, the sweetness modifying composition comprising (i) rebaudioside M, (ii) a glucosylated steviol glycoside, and (iii) an effective amount of a taste modifier. The amounts and ratio of the rebaudioside M and glucosylated steviol glycoside present in the composition are any of those described hereinabove for the composition.

According to certain embodiments, provided is a method of improving the upfront sweetness of a sweetened composition which comprises providing a base composition comprising at least one sweetener present in an amount at or above its sweetness recognition threshold and/or having a sweetness equal to or greater than about 1.5% (w/v) sucrose equivalence, and adding a composition to the base composition, the sweetness modifying composition comprising (i) rebaudioside M, (ii) a glucosylated steviol glycoside, and (iii) an effective amount of a taste modifier. The amounts and ratio of the rebaudioside M and glucosylated steviol glycoside present in the composition are any of those described hereinabove for the composition.

According to certain embodiments, provided is a method of weakening the lingering bitter, metallic and/or liquorice off-notes of a sweetened composition which comprises providing a base composition comprising at least one sweetener present in an amount at or above its sweetness recognition threshold and/or having a sweetness equal to or greater than about 1.5% (w/v) sucrose equivalence, and adding a composition to the base composition, the composition comprising (i) rebaudioside M, (ii) a glucosylated steviol glycoside, and (iii) an effective amount of a taste modifier. The amounts and ratio of the rebaudioside M and glucosylated steviol glycoside present in the composition are any of those described hereinabove for the composition.

According to certain embodiments, provided is a method of improving the dryness and/or astringent mouthfeel of a sweetened composition which comprises providing a base composition comprising at least one sweetener present in an amount at or above its sweetness recognition threshold and/or having a sweetness equal to or greater than about 1.5% (w/v) sucrose equivalence, and adding a composition to the base composition, the sweetness modifying composition comprising (i) rebaudioside M, (ii) a glucosylated steviol glycoside, and (iii) an effective amount of a taste modifier. The amounts and ratio of the rebaudioside M and glucosylated steviol glycoside present in the composition are any of those described hereinabove for the composition.

Astringency is defined by the American Society for Testing and Materials (ASTM, 2004) as the complex of sensations due to shrinking, drawing or puckering of the epithelium as a result of exposure to substances such as alums and tannins. It is believed that astringent molecules react with salivary proteins, especially proline-rich proteins and glycoproteins that act as natural lubricants such as mucins, causing them to precipitate and aggregate, and the resulting loss of lubricity leads to the rough, “sandpapery”, or dry sensation associated with astringency in the mouth. Astringency can be intrinsically present in certain consumables, such as tea, wine, yogurt and plant proteins. Astringency can also be introduced into consumables as the result of adding certain ingredients such as vitamins, minerals, amino acids, proteins, peptides or antioxidants. While these ingredients might be employed as additives with the intention of improving the health and safety of food or for reasons of nourishment, they can also carry with them a perception of astringency and undesired mouthfeel properties.

Mouthfeel (or “mouth feel”) refers to the physical sensations experienced or felt in the mouth that are created by food and beverages, or compositions added to food or beverages. Mouthfeel may refer to textures that come into contact with the tongue, roof of the mouth, teeth, gums, or throat. Mouthfeel is considered to be distinct from taste/flavor, but is considered to have an equal or even greater impact on a person's enjoyment or preference for certain foods over others. Typical mouthfeel descriptors used to describe perceived sensations include acidity (metallic, citrusy, bright), density (close, airy), dryness (arid, scorched), graininess (particulate, powdery, dusty, grainy, chalky), gumminess (chewy, tough), hardness (crunchy, soft), heaviness (full, weighty), irritation (prickly, stinging), mouth coating (oily, buttery), roughness (abrasive, textured), slipperiness (slimy, stringy), smoothness (satiny, velvety), uniformity (even, uneven) and viscosity (full-bodied, light-bodied).

The sweetness characteristics may refer to the flavour profile (taste profile), which refers to the intensity of the flavour and perceptual attributes of a given compound. Exemplary flavour attributes of sweetness are sweetness intensity, bitterness, black liquorice etc.

The sweetness characteristics may refer to the temporal profile, which refers to the changes in perception of sweetness over time. Every sweetener exhibits a characteristic appearance time (AT) and extinction time (ET). Most high-potency sweeteners, in contrast to carbohydrate sweeteners, display prolonged ET (lingering). Generally, the detected sucrose equivalence spikes to a maximal response level, then tapers off over time. The longer the taper, the greater the detected sweetness linger of a compound.

In certain embodiments, the one or more low-potency sweetener(s) may be used to weaken the lingering sweet taste of the sweetened composition comprising one or more high-intensity sweetener(s). In other words, the low-potency sweetener may be used to decrease the extinction time (ET) of the sweetened composition comprising one or more high-intensity sweetener(s). This relates to the undesirable lingering of the sweetness taste in the mouth after the composition is initially ingested or expectorated. The lingering sweet taste may, for example, refer to the length of time that the sweetness taste remains after it is initially detected, how rapidly the intensity of the sweetness taste decreases or fades after it is initially detected and the intensity of the sweetness taste after it is initially detected. The one or more low-potency sweetener(s) may, for example, decrease the length of time that the sweetness taste remains after it is initially detected and/or increase the speed at which the sweetness taste decreases after it is initially detected and/or decrease the intensity of the sweetness taste after it is initially detected.

In certain embodiments, the one or more low-potency sweetener(s) may be used to weaken the bitter taste and/or astringent taste and/or metallic taste and/or liquorice taste of the sweetened composition comprising the one or more high-intensity sweetener(s). The term “liquorice” refers to a sweet taste of a compound.

In certain embodiments, the one or more low-potency sweetener(s) may be used to strengthen the sweetness impact of the sweetened composition comprising the one or more high-intensity sweetener(s). The sweetness impact relates to the length of time it takes before the sweetness is initially detected and the intensity at which the sweetness is initially detected. The one or more low-potency sweetener(s) may, for example, decrease the amount of time before the sweetness is initially detected and/or increase the intensity at which the sweetness is initially detected.

The degree of sweetness and other sweetness characteristics described herein may be evaluated by a tasting panel of trained experts, for example as described in the examples below.

### Manufacturing Methods

There is further provided herein methods of making the compositions disclosed herein. The compositions may be in accordance with any embodiment disclosed herein.

The methods may comprise combining each component of a desired composition in the desired proportions and optionally mixing the components together. The components may be combined and mixed in any suitable order.

A person skilled in the art would identify a suitable method to make the composition (e.g. suitable order in which to combine or mix the components) depending on the nature of the composition and the degree and characteristics of the sweetness desired. The methods may, for example, comprise providing a desired base composition and adding the sweeteners thereto.

Each of the sweeteners disclosed herein may be made by a synthetic process or by a biological (e.g. enzymatic) process or a fermentation process or may be isolated from a natural source such as a plant or fruit.

The process may, for example, comprise contacting at least one mogrol precursor substrate with a mogroside pathway enzyme. The enzyme may, for example, be present in a cell lysate or may be present in a host cell (e.g. a recombinant host cell). The enzyme may, for example, be a UGT enzyme (UDP-glucuronosyltransferase).

For example, a mogroside compound may be made by the biosynthetic pathway disclosed in WO 2013/076577 or WO 2014/086842, the contents of which are incorporated herein by reference.

For example, mogroside V may be made by the biosynthetic pathway disclosed in ltkin et al., “The biosynthetic pathway of the nonsugar, high-intensity sweetener mogroside V from Siraitia grosvenorii”, PNAS, 7 Nov. 2016, E7619-E7628 and WO 2016/038617, the contents of which are incorporated herein by reference.

For example, a mogroside compound may be made by modifying (e.g. redistributing glycoside content) another mogroside compound. For example, a mogroside compound may be made by redistributing glycoside content of another mogroside compound using acid or enzymes as disclosed in WO 2014/150127, the contents of which are incorporated herein by reference.

The process may, for example, comprise extracting one or more sweetener compounds from a natural source such as a plant or fruit. This may, for example, be followed by a purification step to yield a high-intensity sweetener, low-intensity sweetener or mixture of sweeteners (e.g. mixture of high-intensity sweeteners such as a mixture of mogrosides). The extract may, for example, have a relatively high content of mogroside V and/or 11-O-mogroside V (e.g. at least about 30 wt % or at least about 40 wt %). This may, for example, involve fractioning, for example by flash chromatography. One or more mogroside compounds (e.g. mogroside V) may be obtained from Luo Han Guo (Siraitia grosvenorii) fruit.

When a fermentation process is used to make the target product (e.g. target mogroside product), the target can be extracted from the aqueous fermentation reaction medium using an appropriate solvent (e.g., heptane) followed by fractional distillation. The chemical composition of each fraction can be measured quantitatively by GC/MS (gas chromatography mass spectrometry). Fractions can be blended to generate the desired mogroside compounds (e.g. mogroside V and 11-O-mogroside V) for use in flavour or other applications.

Verification of acceptability of the final blended product can be carried out by direct comparison to a reference mogroside flavouring product (for example, an existing natural flavouring commercial product obtained from a commercial supplier).

### EXAMPLES

### Example 1

### Methods

Luo Han Guo fruit extracts obtained from Blue California (Tomas, Rancho Santa Margarita, Calif.) (extract 4), Azile LCC (Rolling Hills Est, California) (extracts 1 and 2) and Chr. Olesen Group (Gentofte, Denmark) (extract 3) were analysed to identify the compounds present in the extract.

Sample solutions of the extracts were prepared by dissolving 16.52 μg of the sample in 25.0 mL solvent (acetonitrile/water 20/80 v/v). From this solution 100 μL were transferred into a HPLC vial and 900 μL solvent was added (66.1 ppm solution). From the sample solution 10 μL was transferred to a HPLC vial and 990 μL solvent was added (6.61 ppm solution). Both the 66.1 and 6.61 ppm solutions were injected twice on the LC-MS.

Calibration (reference) solutions of mogroside V were made by dissolving 9.22 mg mogroside V (98.5% mogroside V obtained from AAPIN chemicals Ltd., Oxfordshire, UK) in 10.0 mL solvent (acetonitrile/water 20/80 v/v). The stock solution was stored in the freezer and used to prepare solutions of mogroside V at various concentrations (0.11 ppm, 0.34 ppm, 1.02 ppm, 3.07 ppm and 9.22 ppm). These solutions were also injected twice on the LC-MS.

2 μL of each solution was injected on an Acquity C18 BEH 1.7 μm 150×2.1 mm column (Waters, Milford, Mass., United States) at 40° C. Compounds were eluted using a mixture of acetonitrile and 0.1% formic acid in water starting at 20% acetonitrile going up to 50% acetonitrile in 14 minutes. The gradient was back on the starting values in 1 minute and stabilized for 5 minutes. The flow was set on 400 μL during the whole run.

Eluted compounds were detected using liquid chromatography mass spectrometry (LC/MS). The mass spectrometer was operating in ESI negative mode measuring 150 to 2000 Amu with a resolution of 70000. Gas flow rates were sheath 60, aux 20 and sweep 3. Capillary temperature and aux gas heater temperature were set on 380° C. and 400° C. respectively.

The % of each component in the extract was calculated using the following equation and calibrated against a curve of the various concentration calibration mogroside V (reference) solutions described above.

$$ratio = \frac{area * V * d}{slope * SW} * 100$$

ratio=% component
area=component area in sample (average area from 2 injections)
V=sample solvent volume in litres
d=sample dilution (from sample solution to vial)
slope=slope from mogroside V calibration curve with b (intercept)=0
SW=sample weight in mg

### Results

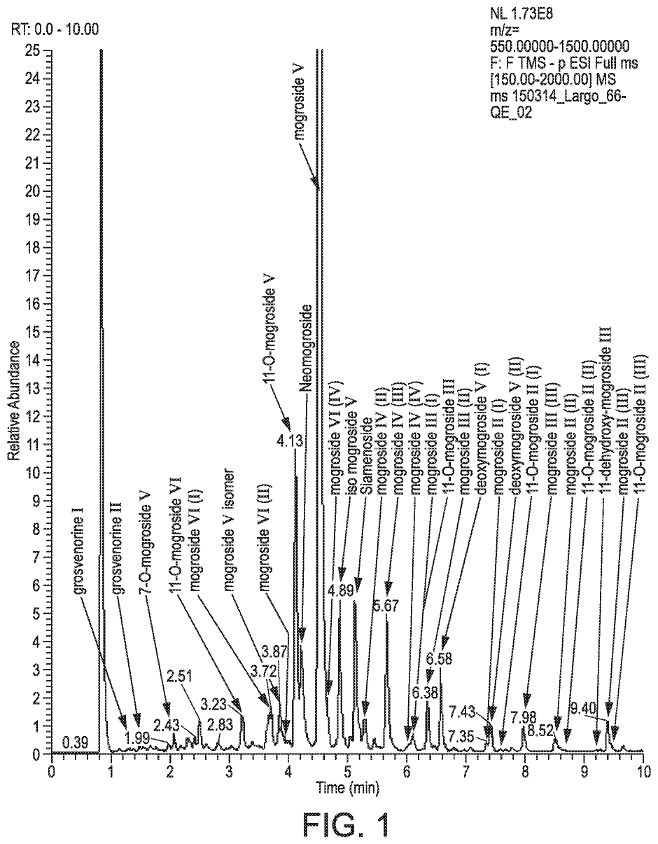

FIG. 1 shows a chromatogram of a Luo Han Guo extract (extract 2 of Table 1 below).

Table 1 shows the composition of four different Luo Han Guo extracts. Mogroside V is the mogroside having the highest concentration in all four extracts (about 45 wt % in extract 1).

TABLE 1

| | | Concentration | Concentration | Concentration | Concentration |
|---|---|---|---|---|---|
| Retention Time | | in Extract 1 | in Extract 2 | in Extract 3 | in Extract 4 |
| (Rt) (minutes) | Name | (wt %) | (wt %) | (wt %) | (wt %) |
| 1.99 | Grosvenorine II | 0.64 | 0.44 | 0.00 | 0.45 |
| 1.52 | Grosvenorine I | 1.38 | 0.84 | 0.00 | 0.62 |
| 7.44 | 11-O-mogroside II (I) | 0.01 | 0.02 | 0.03 | 0.03 |
| 8.54 | 11-O-mogroside II (II) | 0.01 | 0.01 | 0.01 | 0.01 |
| 9.51 | 11-O-mogroside II (III) | 0.03 | 0.01 | 0.04 | 0.02 |
| 7.21 | Mogroside II (I) | 0.04 | 0.08 | 0.11 | 0.14 |
| 8.43 | Mogroside II (II) | 0.06 | 0.06 | 0.05 | 0.05 |
| 9.43 | Mogroside II (III) | 0.51 | 0.20 | 0.53 | 0.27 |
| 9.24 | 11-dehydroxy- | 0.04 | 0.02 | 0.03 | 0.01 |
| | mogroside III | | | | |
| 5.97 | 11-O-mogroside III | 0.22 | 0.11 | 0.19 | 0.09 |
| 6.20 | Mogroside III (I) | 1.61 | 0.92 | 1.42 | 0.71 |
| 7.88 | Mogroside III (II) | 0.29 | 0.24 | 0.27 | 0.28 |
| 5.13 | Siamenoside | 1.84 | 1.81 | 2.95 | 2.20 |
| 5.30 | Mogroside IV (II) | 0.42 | 0.50 | 0.51 | 0.88 |
| 5.67 | Mogroside IV (III) | 2.18 | 1.91 | 3.19 | 2.31 |
| 6.05 | Mogroside IV (IV) | 0.09 | 0.08 | 0.14 | 0.10 |
| 6.58 | Deoxymogroside V (I) | 1.30 | 1.42 | 1.54 | 1.36 |
| 7.43 | Deoxymogroside V (II) | 0.38 | 0.38 | 0.39 | 0.32 |
| 4.13 | 11-O-mogroside V (I) | 4.99 | 4.70 | 4.89 | 4.97 |
| 3.87 | Mogroside V isomer | 0.54 | 0.58 | 0.60 | 0.56 |
| 4.54 | Mogroside V | 45.42 | 43.88 | 43.94 | 41.67 |
| 4.89 | Iso-Mogroside V | 2.20 | 2.10 | 2.05 | 1.74 |
| 2.08 | 7-O-mogroside V | 0.19 | 0.15 | 0.15 | 0.18 |
| 3.23 | 11-O-mogroside VI | 0.33 | 0.27 | 0.26 | 0.25 |
| 3.72 | Mogroside VI (I) | 0.80 | 0.66 | 0.83 | 0.64 |
| 3.93 | Mogroside VI (II) | 0.66 | 0.52 | 0.40 | 0.43 |
| 4.22 | Mogroside VI (III) | 1.19 | 0.96 | 0.88 | 0.74 |
| | (Neomogroside) | | | | |
| 4.67 | Mogroside VI (IV) | 0.19 | 0.16 | 0.14 | 0.45 |
| | Total | 67.58 | 63.04 | 65.57 | 61.50 |

### Example 2

### Methods

A Luo Han Guo fruit extract obtained from Azile LCC (Rolling Hills Est, California) (extract 1 of Example 1 above) containing about 68 wt % mogrosides was fractionated by reverse phase (C-18) flash chromatography.

Compounds were eluted using a mixture of methanol (MeOH) in water starting at 30% MeOH followed by a linear gradient of 30-80% MeOH then finally the column was flushed with 80% MeOH. The solvents were introduced at the flow rate of 30 ml/min throughout the separation procedure. Eluted compounds were visualized with a UV detector set at 210 nm and a coronal light scattering detector. The % of each component in the extract was calculated using the equation described in Example 1 above.

Collected fractions were pooled according to Table 2 below, and then freeze dried to powders. The powder corresponding to various pooled fractions as given in Table 2 below was dissolved in various concentrations on top of 5% sucrose. The taste of these samples was compared by three expert panellists (trained flavourists) to controls of 5% sucrose. Thus the sweetness enhancement effect of each fraction or pool of fractions exhibited in 5% sucrose was determined.

### Results

The results are indicated in the table below. The whole extract was collected into 22 fractions. Fractions 1-10 contain no mogroside V.

TABLE 2

| | Mogroside | Dose level | |
|---|---|---|---|
| Fraction # | V content | of Fraction | Taste evaluation (on |
| (combined) | (%) | (ppm) | top of 5% sucrose) |
| 1(tube 1-7) | 0 | 15 | Some in this set have |
| 2(tube 8-12) | 0 | 15 | sugary notes, most also |
| 3(tube 13-16) | 0 | 15 | have fermented off notes |
| 4 (tube 17-20) | 0 | 15 | Some astringency in this |
| 5 (tube 21-24) | 0 | 15 | part |
| 6 (tube 25-28) | 0 | 15 | Sweetness suppressed |
| 7 (tube 29-32) | 0 | 15 | Bitter, metallic, |
| | | | fermented off notes |
| 8 (tube 33-34) | 0 | 15 | No enhancement |
| 9 (tube 35-36) | 0 | 15 | Fermented, typical white |
| 10 (tube 37) | 0 | 15 | dog notes, astringent, |
| | | | cooked delayed sweet |
| 11 (tube 38) | 1.15 | 45 | Sweeter, some mouthfeel, |
| | | | some upfront |
| 12 (tube 39) | 15.9 | 45 | Slightly higher in |
| | | | enhancement, less off notes |
| 13 (tube 40) | 64.5 | 30 | Sweeter, higher licorice, |
| | | | less dirty fermented, sl |
| | | | higher astringency |
| 14 (tube 41-42) | 100 | 25 | Very lingering, very |
| | | | licorice, dirty sweet, |
| | | | numbing, sharp sweetness, |
| | | | mouth drying |
| 15 (tube 43-44) | 97 | 25 | Strong fermented dirty |
| | | | note, higher sweet, |
| | | | numbing delayed sharp, |
| | | | strong licorice, linger, |
| | | | metallic |
| 16 (tube 45-46) | 70.3 | 25 | Astringent, some |
| 17 (tube 47) | 18.7 | 45 | enhancement, mostly |
| 18 (tube 48) | 4.6 | 45 | licorice lingering |
| 19 (tube 49) | 1.95 | 45 | Negative notes, typical |
| 20 (tube 50-51) | 1.56 | 5 | fermented lingering |
| 21 (tube 52-54) | 0 | 5 | |
| 22 (tube 55-end) | 0 | | |

Fraction 1-10 and 19-22 have an off-taste, which is the character of Luo Han Guo fruit, no sweet enhancement impact.

The better sweetness enhancement effect was observed within fractions 12-17, which contains mainly mogrosides. When the fractions almost have pure mogroside V, the lingering, dirty fermented note is more noticeable, such as fractions 14 and 15. Thus, pure mogroside V has inherent lingering off-taste.

Fraction 12 was the cleanest sweet, but less upfront due to small percentage mogroside V. Fraction 13 has better sweet quality, but slightly higher astringency. 11-O-mogroside V and mogroside V are the two major mogrosides in those two fractions, but with different ratio (F12 mogroside V:11-O-mogroside V is 4:9 and F13 mogroside V:11-O-mogroside V is 13:3).

Mogroside V was very sweet, judged to be 425 times sweeter than sucrose, while 11-O-mogroside V is rated as 84 times sweeter than sucrose.

### Example 3

### Methods

A Luo Han Guo fruit extract obtained from Azile LCC (Rolling Hills Est, California) (extract 1 of Example 1 above) containing about 68 wt % mogrosides was fractionated and the composition of each fraction determined by the chromatography method described above in relation to Example 1.

Each fraction was combined with a solution of 5% sucrose and the taste of these samples was compared by three expert panelists (trained flavourists) to controls of 5% sucrose.

### Results

Table 3 shows the chemical composition of fractions 11 to 20 of the extract.

TABLE 3

| Retention | | | | | | | | | | | |
|---|---|---|---|---|---|---|---|---|---|---|---|
| Time (Rt) | | | | | | | | | | | |
| (minutes) | Name | F11 | F12 | F13 | F14 | F15 | F16 | F17 | F18 | F19 | F20 |
| 1.99 | Grosvenorine II | 0.02 | 0.01 | 0.00 | 0.00 | 0.00 | 0.00 | 0.01 | 0.00 | 0.00 | 0.00 |
| 1.52 | Grosvenorine I | 0.01 | 0.00 | 0.00 | 0.00 | 0.00 | 0.01 | 0.01 | 0.01 | 0.00 | 0.01 |
| 7.44 | 11-O-mogroside II (I) | 0.00 | 0.00 | 0.00 | 0.00 | 0.00 | 0.00 | 0.00 | 0.00 | 0.00 | 0.00 |
| 8.54 | 11-O-mogroside II (II) | 0.00 | 0.00 | 0.00 | 0.00 | 0.00 | 0.00 | 0.01 | 0.02 | 0.02 | 0.01 |
| 9.51 | 11-O-mogroside II (III) | 0.00 | 0.00 | 0.00 | 0.00 | 0.00 | 0.00 | 0.00 | 0.00 | 0.00 | 0.00 |
| 7.21 | Mogroside II (I) | 0.00 | 0.00 | 0.00 | 0.00 | 0.00 | 0.00 | 0.00 | 0.00 | 0.00 | 0.00 |
| 8.43 | Mogroside II (II) | 0.00 | 0.00 | 0.00 | 0.00 | 0.00 | 0.00 | 0.02 | 0.06 | 0.10 | 0.06 |
| 9.43 | Mogroside II (III) | 0.00 | 0.00 | 0.00 | 0.00 | 0.00 | 0.01 | 0.03 | 0.03 | 0.03 | 0.04 |
| 9.24 | 11-dehydroxy-mogroside III | 0.00 | 0.00 | 0.00 | 0.00 | 0.00 | 0.00 | 0.00 | 0.00 | 0.00 | 0.00 |
| 5.97 | 11-O-mogroside III | 0.00 | 0.00 | 0.00 | 0.00 | 0.00 | 0.02 | 0.46 | 4.87 | 8.66 | 5.65 |
| 6.20 | Mogroside III (I) | 0.00 | 0.00 | 0.00 | 0.00 | 0.00 | 0.01 | 0.08 | 1.52 | 14.8 | 82.6 |
| 7.88 | Mogroside III (II) | 0.04 | 0.06 | 0.04 | 0.02 | 0.02 | 0.03 | 0.05 | 0.05 | 0.04 | 0.12 |
| 5.13 | Mogroside IV (I) | 0.01 | 0.01 | 0.05 | 0.63 | 4.27 | 17.5 | 21.2 | 5.99 | 1.03 | 0.25 |
| 5.30 | Mogroside IV (II) | 0.01 | 0.01 | 0.01 | 0.01 | 0.08 | 1.86 | 12.0 | 12.7 | 5.87 | 1.08 |
| 5.67 | Mogroside IV (III) | 0.01 | 0.01 | 0.01 | 0.01 | 0.03 | 0.00 | 19.2 | 64.3 | 86.7 | 36.6 |
| 6.05 | Mogroside IV (IV) | 0.00 | 0.00 | 0.00 | 0.00 | 0.00 | 0.01 | 0.01 | 1.32 | 2.54 | 2.39 |
| 6.58 | Deoxymogroside V (I) | 0.00 | 0.00 | 0.00 | 0.00 | 0.00 | 0.00 | 0.00 | 0.03 | 0.05 | 3.75 |
| 7.43 | Deoxymogroside V (II) | 0.00 | 0.00 | 0.00 | 0.00 | 0.00 | 0.00 | 0.00 | 0.00 | 0.01 | 0.01 |
| 4.13 | 11-O-mogroside V (I) | 22.1 | 35.5 | 14.2 | 1.97 | 0.22 | 0.17 | 0.19 | 0.13 | 0.11 | 0.10 |
| 3.87 | Mogroside V isomer | 5.54 | 4.68 | 1.14 | 0.11 | 0.02 | 0.02 | 0.02 | 0.01 | 0.01 | 0.01 |
| 4.54 | Mogroside V | 1.14 | 15.9 | 64.5 | 104 | 97.5 | 70.8 | 18.7 | 4.59 | 1.95 | 1.56 |
| 4.89 | Iso-Mogroside V | 0.03 | 0.18 | 1.24 | 3.88 | 6.86 | 9.19 | 3.38 | 0.70 | 0.14 | 0.11 |
| 2.08 | 7-O-mogroside V | 0.02 | 0.00 | 0.04 | 0.04 | 0.06 | 0.05 | 0.02 | 0.01 | 0.00 | 0.00 |
| 3.23 | 11-O-mogroside VI | 0.88 | 0.12 | 0.01 | 0.00 | 0.00 | 0.00 | 0.00 | 0.00 | 0.00 | 0.00 |
| 3.72 | Mogroside VI (I) | 9.58 | 4.90 | 0.56 | 0.09 | 0.01 | 0.00 | 0.01 | 0.00 | 0.00 | 0.00 |
| 3.93 | Mogroside VI (II) | 0.65 | 2.45 | 2.37 | 0.00 | 0.17 | 0.05 | 0.03 | 0.02 | 0.01 | 0.01 |
| 4.22 | Mogroside VI (III) | 0.80 | 3.96 | 4.77 | 2.01 | 0.00 | 0.15 | 0.07 | 0.04 | 0.03 | 0.03 |
| | (Neomogroside) | | | | | | | | | | |
| 4.67 | Mogroside VI (IV) | 0.00 | 0.01 | 0.07 | 0.25 | 0.55 | 1.03 | 0.56 | 0.12 | 0.02 | 0.01 |
| | Total | 40.8 | 67.9 | 89.0 | 112.6 | 109.8 | 100.9 | 76.0 | 96.6 | 122.2 | 134.5 |

Table 4 shows the tasting results for fractions 12 to 15. The results are similar to the results obtained in Example 2.

TABLE 4

| | Iso-sweet | Comments for | |
|---|---|---|---|
| | Level | Iso-sweet | Comments for 5% Sucrose |
| Fraction | (ppm) | tasting | Tasting |
| F12 | 45 | Closest to Luo | Slightly higher in enhancement, |
| | | Han Guo extract, | less off-notes, this was the |
| | | less overall off- | cleanest sweet of all the |
| | | notes | samples, less upfront sweet than |
| | | | Luo Han Guo extract, good |
| | | | quality of sweet except for |
| | | | lower upfront sweet impression. |
| | | | The other fractions have |
| | | | different off-notes compared to |
| | | | Luo Han Guo extract, but are |
| | | | comparable in terms of quality |
| | | | of sweet. |
| | | | Basically, numbing/irritating |
| | | | effects are stronger than “wet |
| | | | dog” fermented effects, |
| | | | typical in Luo Han Guo extract |
| F13 | 30 | Very close in | Sweeter, higher licorice, less |
| | | sweetness, | dirty fermented, sl higher |
| | | lingering | astringency |
| F14 | 25 | Slightly sweeter, | Very lingering, very licorice, |
| | | very likely would | dirty sweet, lower overall |
| | | match iso-sweet | quality of sweet compared to |
| | | of Luo Han Guo | Luo Han Guo extract, numbing, |
| | | extract, less dirty | sharp sweetness, mouth drying, |
| | | finish than Luo | irritating, lingers |
| | | Han Guo extract | |
| | | | Fractions 14 and 15 have a |
| | | | sharp, numbing, burn, which |
| | | | negatively effects potency |
| | | | and quality of sweet |
| F15 | 25 | Very close in | Strong fermented dirty note, |
| | | profile, less off- | higher sweet, numbing, delayed |
| | | notes | sharp, strong licorice, |
| | | | lingers, metallic |

### Example 4

Mogroside V and 11-O-mogroside V were isolated from extracts of Luo Han Guo using Agilent 1100 preparative HPLC system with a Phenomenex Luna C18 (2) column (5 μm, 210×21.4 mm), and combined to form solutions of various concentrations.

These solutions were combined with a solution containing 5% (w/v) sucrose and 0.03% (w/v) citric acid to give test samples and evaluated by a sweet sensitive taste panel of five experts (trained flavourists).

The results are shown in Table 5 below.

TABLE 5

| | Moqroside V | 11-O-Moqroside V | |
|---|---|---|---|
| | Concentration | Concentration | |
| Mogroside Content | (ppm) | (ppm) | Taste evaluation |
| Mogroside V | 20 | 0 | Less sweet, less upfront, |
| | | | musty, similar like base |
| Mogroside V | 25 | 0 | Good impact, strong lingering, |
| | | | metallic, woody. |
| Mogroside V | 30 | 0 | Sweet lingering, astringent, |
| | | | sl licorice, upfront |
| 11-O-mogroside V | 0 | 45 | Linger, metallic, clean finish, |
| | | | not as sweet as mogroside V |
| Mogroside V + 11-O- | 20 | 3 | sweet, cinnamic, lingering, |
| mogroside V | | | woody, fruity sweet |
| Mogroside V + 11-O- | 20 | 5 | Slight lingering, low impact |
| mogroside V | | | sweet, astringent |
| Mogroside V + 11-O- | 20 | 8.5 | lingering, slight fruity, |
| mogroside V | | | mouthfeel, full, fruity sweet |
| Mogroside V + 11-O- | 25 | 3 | Preferred, sugar like impact, |
| mogroside V | | | increase sweetness |
| Mogroside V + 11-O- | 25 | 5 | Moderate impact, bitter finish |
| mogroside V | | | |
| Mogroside V + 11-O- | 25 | 8.5 | Sweeter, slightly dry, slightly |
| mogroside V | | | lingering, sl fruity, cleanest, |
| | | | mouthfeel |

| | | |
|---|---|---|
| Luo Han Guo extract | 45 (total dose level of | Clean impact, some lingering, |
| | Luo Han Guo extract) | low sweet impact |

It was surprisingly found that blending 11-O-mogroside V with mogroside V improves the sweet quality compared to mogroside V alone. 11-O-mogroside V on top of mogroside V helped to reduce sweetness lingering (weaken later sweetness taste) and reduce astringent and bitter aftertastes compared to mogroside V alone. Thus, the 11-O-mogroside V made the sweetness taste more similar to sugar than mogroside V alone (i.e. assists in providing a temporal profile that is closer to sugar). This enables the use of higher concentrations of mogroside V to obtain higher sweetness whilst eliminating the disadvantages associated with using higher concentrations of this sweetener (e.g. lingering, bitter and astringent aftertastes). This was surprising given that mogroside V is the most potent mogroside sweetener and 11-O-mogroside V is of much lower potency.

### Example 5

A sweet sensitive taste panel ranked the sweetness of solutions of a mixture of sweeteners (“Mixture 1”) in relation to sucrose solutions at a range of concentrations to determine sucrose equivalence. Mixture 1 was a combination of fractions 11 to 18 of Example 2 and contained 8.16 wt % 11-O-mogroside V and 61.6 wt % mogroside V. The results are shown in Table 6 below.

TABLE 6

| | 35 ppm | 25 ppm | 30 ppm | 1% | 1.5% |
|---|---|---|---|---|---|
| Panelist | Mixture 1 | Mixture 1 | Mixture 1 | Sucrose | Sucrose |
| 1 | 3 | 2 | 1 | 4 | 5 |
| 2 | 1 | 2 | 5 | 3 | 4 |
| 3 | 1 | 2 | 3 | 4 | 5 |
| 4 | 2 | 3 | 1 | 4 | 5 |
| 5 | 1 | 3 | 4 | 2 | 5 |
| 6 | 2 | 5 | 1 | 3 | 4 |
| 7 | 3 | 2 | 5 | 1 | 4 |
| 8 | 3 | 2 | 1 | 4 | 5 |
| 9 | 3 | 1 | 2 | 4 | 5 |
| 10 | 3 | 2 | 1 | 4 | 5 |
| Total | 22 | 24 | 24 | 33 | 47 |

The data demonstrates that mixture 1 has a sweetness below 1% sucrose equivalence (as determined by seven panellists), which is accepted as “not intrinsically sweet” by FEMA. Therefore, mixture 1 is suitable for use as sweetness modifiers or blends at the indicated concentrations because it does not have any detectable sweetness at these levels.

A concentration of mixture 1 having an iso-sweet threshold close to 1% (35 ppm) was selected and added to 5% (w/v) sucrose solutions. This solution was then ranked against 5, 6, 6.5 and 7% (w/v) sucrose solutions. This was repeated for 45 ppm Luo Han Guo extract. The average score of each solution was determined. The results are shown in Table 7 below.

TABLE 7

| Sweetener | Average Score |
|---|---|
| Mixture 1 (35 ppm) | 6.5 |
| Luo Han Guo extract (45 ppm) | 6.4 |

It was surprisingly found that mixture 1 and Luo Han Guo extract act as sweetness enhancers since the increase in sweetness of the 5% (w/v) sucrose solution to which they were added was greater than the sweetness of the sweetener alone.

The taste of various concentrations of mixture 1 was tested by an expert panel of three people (trained flavourists) in solutions containing 5% sucrose and 0.03% citric acid. The taste was compared to the Luo Han Guo extract used in Example 2 (obtained from Azile LCC (Rolling Hills Est, California) (extract 1 of Example 1 above) and containing about 68 wt % mogrosides) (combined with the same 5% sucrose and 0.03% citric acid solution). The results are shown in Table 8.

TABLE 8

| Sample | Panelist 1 | Panelist 2 | Panelist 3 |
|---|---|---|---|
| Luo Han Guo | Sweeter, round, | Good impact, | Most rounded |
| extract (45 ppm) | sl linger | low baggage | sweet profile |
| Mixture 1 (35 ppm) | Linger, sweet | Sweetest, | Vitamin note, |
| | | lingering | oxidized, most |
| | | | sweet overall |
| Mixture 1 (30 ppm) | Sweeter | Lower sweet, | Clean sweet |
| | | least baggage | |
| Mixture 1 (25 ppm) | Sl lower in | Lingering, | Clean sweet |
| | sweetness | clean, least | |
| | | sweet | |

Overall, mixture 1 provides a better sweet quality (less baggage, sweeter) than the Luo Han Guo extract.

### Example 6

A sweet sensitive taste panel ranked the sweetness of solutions of various sweeteners (mogroside V, mogroside IV, siamenoside, neomogroside, 11-O-mogroside V) in relation to sucrose solutions at a range of concentrations to determine sucrose equivalence. The sweeteners were obtained using an Agilent 1100 preparative HPLC system with a Phenomenex Luna C18 (2) column (5 μm, 210×21.4 mm). The results are shown in Tables 9 to 13.

TABLE 9

| | | 20 ppm | | 25 ppm | |
|---|---|---|---|---|---|
| | 0.5% | Mogroside | 1% | Mogroside | 1.5% |
| Panelist | Sucrose | V | Sucrose | V | Sucrose |
| 1 | 3 | 1 | 4 | 2 | 5 |
| 2 | 1 | 3 | 2 | 4 | 5 |
| 3 | 1 | 2 | 4 | 3 | 5 |
| 4 | 1 | 2 | 4 | 3 | 5 |
| 5 | 1 | 2 | 3 | 4 | 5 |
| 6 | 1 | 3 | 2 | 5 | 4 |
| Total | 8 | 13 | 19 | 21 | 29 |

TABLE 10

| | 25 ppm | | 30 ppm | | |
|---|---|---|---|---|---|
| | Mogroside | Sucrose | Mogroside | Sucrose | Sucrose |
| Panelist | IV | 0.5% | IV | 1% | 1.5% |
| 1 | 3 | 1 | 4 | 2 | 5 |
| 2 | 2 | 3 | 1 | 4 | 5 |
| 3 | 1 | 2 | 3 | 4 | 5 |
| 4 | 2 | 4 | 3 | 1 | 5 |
| 5 | 2 | 1 | 3 | 4 | 5 |
| 6 | 1 | 2 | 3 | 4 | 5 |
| 7 | 2 | 1 | 3 | 4 | 5 |
| Total | 13 | 14 | 20 | 23 | 35 |

TABLE 11

| | Sucrose | Siamenoside | Siamenoside | Sucrose | Sucrose |
|---|---|---|---|---|---|
| Panelist | 0.5% | 20 ppm | 25 ppm | 1% | 1.5% |
| 1 | 1 | 4 | 3 | 2 | 5 |
| 2 | 1 | 3 | 2 | 4 | 5 |
| 3 | 2 | 1 | 3 | 4 | 5 |
| 4 | 1 | 4 | 2 | 3 | 5 |
| 5 | 1 | 2 | 4 | 3 | 5 |
| 6 | 1 | 3 | 2 | 4 | 5 |
| 7 | 1 | 2 | 3 | 4 | 5 |
| Total | 8 | 19 | 19 | 24 | 35 |

TABLE 12

| | | | Mogroside | |
|---|---|---|---|---|
| | | | V (25 ppm) + | |
| | Sucrose | Sucrose | 11-O-Mogroside | Sucrose |
| Panelist | 0.5% | 1% | V (3 ppm) | 1.5% |
| 1 | 1 | 2 | 3 | 4 |
| 2 | 3 | 2 | 1 | 4 |
| 3 | 1 | 3 | 2 | 4 |
| 4 | 1 | 2 | 4 | 3 |
| 5 | 1 | 2 | 3 | 4 |
| 6 | 1 | 3 | 2 | 4 |
| 7 | 1 | 3 | 2 | 4 |
| Total | 9 | 17 | 17 | 27 |

TABLE 13

| | 0.5% | 25 ppm | 30 ppm | 1% | 1.5% |
|---|---|---|---|---|---|
| Panelist | Sucrose | Neomogroside | Neomogroside | Sucrose | Sucrose |
| 1 | 1 | 4 | 2 | 3 | 5 |
| 2 | 3 | 1 | 2 | 4 | 5 |
| 3 | 2 | 1 | 3 | 4 | 5 |
| 4 | 1 | 2 | 4 | 3 | 5 |
| 5 | 3 | 1 | 5 | 2 | 4 |
| 6 | 1 | 2 | 4 | 3 | 5 |
| 7 | 2 | 1 | 3 | 4 | 5 |
| 8 | 1 | 2 | 3 | 4 | 5 |
| 9 | 1 | 2 | 3 | 4 | 5 |
| Total | 15 | 16 | 29 | 31 | 44 |

The data demonstrates that mogroside V (25 ppm), mogroside IV (30 ppm), siamenoside (25 ppm), mogroside V (25 ppm) in combination with 11-O-mogroside V (3 ppm) and neomogroside (30 ppm) all have a sweetness below 1.5% sucrose equivalence (as determined by seven panellists), which is accepted as “not intrinsically sweet” by FEMA. Therefore, these compounds and mixtures are suitable for use as sweetness modifiers at the indicated concentrations because they do not have any detectable sweetness at these levels.

Concentrations of the tested sweeteners were selected with an iso-sweet threshold close to 1% and added to 5% (w/v) sucrose solutions. These solutions were then ranked against 5, 6, 6.5 and 7% (w/v) sucrose solutions. The average score of each solution was determined. The results are shown in Table 14 below.

TABLE 14

| Sweetener | Average Score |
|---|---|
| Mogroside V (25 ppm) | 6.2 |
| Mogroside IV (30 ppm) | 6.2 |
| Siamenoside (25 ppm) | 6.4 |
| Neomogroside (30 ppm) | 6.35 |

It was surprisingly found that mogroside V, siamenoside, neomogroside and mogroside V act as sweetness enhancers since the increase in sweetness of the 5% (w/v) sucrose solution to which they were added was greater than the sweetness of the sweetener alone.

The taste of these sweeteners was tested by an expert panel of three people (trained flavourists) in solutions containing 5% sucrose and 0.03% citric acid. The taste was compared to the Luo Han Guo extract used in Example 2 (obtained from Azile LCC (Rolling Hills Est, California) (extract 1 of Example 1 above) and containing about 68 wt % mogrosides). Mogroside IV, siamenoside and neomogroside are all better than Luo Han Guo extract in terms of sweet quality when added to 5% sucrose and 0.03% citric acid. These 3 compounds provide a sugar like taste with less lingering sweet taste. Siamenoside was described as having “more sweet body, sweeter, rounder with a little more upfront and more round lasting sweet”. Mogroside IV was described as having “good and similar sweetness as mogroside V”. Neomogroside was described as having “sweetness, but slightly bitter aftertaste”. The results for mogroside V are shown in Table 15.

TABLE 15

| Sample | Description |
|---|---|
| Luo Han Guo extract (45 | Astringent, fuller sweet, less sharp, mid |
| ppm) | sweet, lingering off note, sweeter, fruity |
| 80% Mogroside V (20 ppm) | More astringent, more acidic, more back |
| | end, missing upfront fullness, flat, |
| | closest to Largo, slight acidic |
| 80% Mogroside V (25 ppm) | Most sweet, acidic, slightly stronger than |
| | #2, sweeter overall, sweeter than largo, |
| | linger |

In general, the tasters agreed that 80% mogroside V does not have the same full round sweet profile as the Luo Han Guo extract. The 80% mogroside V is more acidic tasting when applied to a sugar/acid/water solution.

### Example 7

### Methods

Mogroside V, siamenoside, mogroside IV and neomogroside were obtained using an Agilent 1100 preparative HPLC system with a Phenomenex Luna C18 (2) column (5 μm, 210×21.4 mm).

The mogroside V, siamenoside, mogroside IV and neomogroside were each added to a solution containing 5% sucrose and 0.03% citric acid in a concentration of 25 ppm (mogroside V), 25 ppm (siamenoside), 30 ppm (mogroside IV) and 30 ppm (neomogroside) respectively.

These test solutions were tasted by an expert panel of seven people. For various aspects of sweet taste (upfront sweet, overall sweet, lingering sweet, astringent, volatile off-taste), each panellist scored the test solutions in comparison to the base solution (solution of 5% sucrose and 0.03% citric acid).

A score of 0 indicated that the taste aspect was the same, 1 indicates slightly higher, 2 indicates higher, 3 indicates much higher, −1 indicates slightly lower, −2 indicates lower and −3 indicates much lower. The average score for each test solution for each taste aspect was calculated. The results are shown in Table 16 below.

TABLE 16

| | Mogroside | | Mogroside | |
|---|---|---|---|---|
| | V | Siamenoside | IV | Neomogroside |
| Overall Sweet | 1 | 1.8 | 0.4 | 1.4 |
| Upfront Sweet | 0.8 | 1.4 | 0.4 | 1 |
| Lingering | 0.4 | 0.6 | 0 | 0.4 |
| Sweet | | | | |
| Astringent | 0 | 0.4 | 0 | 0 |
| Volatile Off- | 0 | 0.2 | 0 | 0 |
| Note | | | | |

### Example 8

As shown above, siamenoside, neomogroside and mogroside IV all have similar or better sweet taste quality on top of 5% sucrose and 0.03% citric acid compared to mogroside V. Therefore, the taste of 11-O-mogroside V with each of these mogrosides is evaluated as shown in Table 17.

TABLE 17

| | | 11-O |
|---|---|---|
| | Siamenoside | mogroside V |
| Mogroside | concentration | concentration |
| content | (ppm) | (ppm) |
| Siamenoside | 25 | 0 |
| Siamenoside + 11- | 25 | 3 |
| O mogroside V | | |
| Siamenoside + 11- | 25 | 5 |
| O-mogroside V | | |
| Siamenoside + 11- | 25 | 8.5 |
| O-mogroside V | | |
| | | 11-O |
| | Mogroside IV | mogroside V |
| | concentration | concentration |
| | (ppm) | (ppm) |
| Mogroside IV | 30 | 0 |
| Mogroside IV + 11- | 30 | 3 |
| O-mogroside V | | |
| Mogroside IV + 11- | 30 | 5 |
| O-mogroside V | | |
| Mogroside IV + 11- | 30 | 8.5 |
| O-mogroside V | | |
| | | 11-O- |
| | Neomogroside | mogroside V |
| | concentration | concentration |
| | (ppm) | (ppm) |
| Neomogroside | 30 | 0 |
| Neomogroside + 11- | 30 | 3 |
| O mogroside V | | |
| Neomogroside + 11- | 30 | 5 |
| O-mogroside V | | |
| Neomogroside + 11- | 30 | 8.5 |
| O-mogroside V | | |

### Example 9

The taste of mogroside V with and without 11-O-mogroside V in various milk or yoghurt bases is evaluated as shown in Table 18. The iso-sweet threshold for mogroside V in milk and yoghurt is also evaluated.

A milk base (2% fat) includes 2% fat milk and 5% sucrose. A non-fat yoghurt base includes plain non-fat yoghurt and 5% sucrose. A full fat yoghurt base includes plain full fat yoghurt and 5% sucrose. A higher dose level is used for milk and yoghurt compositions due to the fat, protein and other ingredients. Luo Han Guo extract is used at 75 ppm for these applications.

TABLE 18

| | Mogroside | 11-O mogroside |
|---|---|---|
| Mogroside | concentration | V concentration |
| content | (ppm) | (ppm) |
| Mogroside V | 40 | 0 |
| Mogroside V + | 40 | 5 |
| 11-O | | |
| mogroside V | | |
| Mogroside V + | 40 | 10 |
| 11-O- | | |
| mogroside V | | |
| Mogroside V + | 40 | 15 |
| 11-O- | | |
| mogroside V | | |

### Example 10

The Identification of New Minor Cucurbitane Glycosides from Siraitia grosvenorii

### INTRODUCTION

Siraitia grosvenorii (Swingle) C. Jeffrey ex Lu et Z. Y. Zhang is a herbaceous perennial vine of Cucurbitaceae family endemic to southern China and northern Thailand. The fruit of S. grosvenorii, commonly known as ‘luo han guo’ has been used for traditional medicine in China for centuries as a treatment of respiratory infection, bronchitis, gastritis, constipation etc. Modern pharmacological research have confirmed that S. grosvenorii extracts or its components possess variety of bioactivities, such as antibacterial, anti-inflammation, anti-diabetic, anti-cancer, and immunostimulatory [1]. Luo Han Guo has been used as a sweetener in food and beverages in China. It is now one of the best known natural high intensity sweeteners throughout the world. Since cucurbitane glycoside mogroside V has been discovered as the sweet principle of S. grosvenorii, more than 40 cucurbitane triterpenoids have been reported from S. grosvenorii so far [1-4]. Food and flavor industry researchers have been actively discovering and adding more new compounds into the mogroside pool in order to find new mogrosides with better sweet performance [5-7]. New molecules under known natural sweetener categories with better sweet performance have been a sought-after for food and flavor industries. The commercialization of rebaubioside M (also known as rebaubioside X) is a good example. Even it is a minor natural product from Stevia (less than 0.1%) discovered in 2010, rebaubioside M quickly progressed into commercialization stage thanks to cost reduction by technology development in plant biology, molecular biology and enzyme engineering [8, 9]. Rebaudioside M received Letter of No Objection concerning its Generally Recognized as Safe (GRAS) status from US FDA in 2013, 2014 and 2017 (GRN No. 473, 512 and 667) [10-12].

We have been conducting investigations to seek the best performance mogrosides or their combinations by using commercial Luo Han Guo extracts [13]. Herein, we report two new minor cucurbitane glycosides from S. grosvenorii and emphasize our new oligosaccharide elucidation strategy based on HSQC-TOCSY experiments with different mixing times.

### Materials and Methods

### General Experimental Procedures

Optical rotations were measure with a Rudolph Autopol IV polarimeter. The NMR spectra were recorded on Bruker DRX Avance 300 or 500 spectrometers. Chemical shifts are given in δ (ppm) referring to the residual solvent peak. Low pressure chromatography was performed on Biotage Flash System SP1. Preparative HPLC was performed on an Agilent 1100 preparative HPLC system with a Phenomenex Lunar C18(2) column (5 μm, 210×21.4 mm) or a TSKgel Amide-80 (5 μm, 300×21.5 mm) (Tosoh Bioscience LLC). Analytical HPLC was performed on an Agilent 1100 analytical HPLC system equipped with ESA Corona Calif.D detector. LC-MS was performed using Waters Q-Tof micro mass spectrometer coupled with Waters 2795 separation module.

### Plant Material

The Luo Han Guo extract (commercial name Swingle, ˜60% mogrosides) was purchased from Blue California Co., Ltd.

### Instrumentation

Chromatographic conditions: The chromatography was performed on a Waters Acquity H UPLC. Separation was carried out at 25 C using a 1.0×100 mm, Acquity UPLC HSS T3 column (Waters), with a particle size of 1.8 mm, equipped with a 0.2 mm prefilter. Solvent A was water and solvent B was acetonitrile, both solvents contained 0.1% formic acid. Injection volume was set to 10 μl. The chromatography flow rate was 200 μl/min. Sample was eluted from the LC column using the following linear gradient (curve number 6): 0-40 min: 90% A-30% A; 40-45 min: 30-10% A; 45-50 min: 10% A; 50-51 min 10%-90% A, 51-55 min 90% A for re-equilibration.

### Mass Spectrometry

The U-HPLC system was coupled to a hybrid quadrupole orthogonal time-of-flight (TOF) mass spectrometer (SYNAPT G2 HDMS, Waters MS Technologies, Manchester, UK). The mass spectrometer was operated in the positive electrospray ionization mode (ESI⁺). The sample cone voltage 40, capillary voltage 0.7 kv, source temperature 40° C., desolvation temperature 450° C., desolvation gas flow 800 L/h, and cone gas flow 50 L/h were optimized. Leucine enkephalin was used as the lock mass [M+H]⁻ at m/z 556.2771. Sodium formate solution was used for external instrument calibration.

### Purification

3 g Luo Han Guo extract was dissolved in 15 mL water and loaded onto a pre-equilibrated C-18 Snap cartridge (KP-C18-HS, 120 g, 132 mL column volume). The gradient system (A: water; B: methanol) used was: 30% 2 CV, 30%˜80% 10 CV, 80%˜100% 2 CV, 100% 2 CV. The flow rate was 30 mL/min. Fractions were collected for 27 mL per tube. Four loading of total 12 g Luo Han Guo was fractionated. All the fractions were analyzed by analytical HPLC to locate the fractions with the target mogrosides (isocratic mobile phase: 24% acetonitrile in water. Column: Luna C18 5 μm 4.6×150 mm). Fractions 36-38 with iso-mogroside VI and 11-epi-mogroside V were combined to evaporate solvents. Further preparative HPLC purification of fractions 36-38 afforded iso-mogroside VI (1, 22 mg) and 11-epi-mogroside V (2, 17 mg) (24% acetonitrile in water, 10 mL/min, retention time 13.1 min and 14.3 min, respectively). 11-oxo-mogroside V (4) and neomogroside (3) were mainly in flash fractions 39-40 with 11-oxo-mogroside V as the major component. On reverse phase C-18 preparative HPLC, neomogroside appeared as a tail shoulder of 11-oxo-mogroside (24% acetonitrile in water, 10 mL/min, retention time 17.0 min and 18.0 min, respectively). Collection of the peak front gave 105 mg of the compound 11-oxo-mogroside V (4). Further purification of the shoulder neomogroside (3, 15 mg) was achieved by preparative HPLC on TSKgel Amide-80 (65% acetonitrile in water, 20 mL/min, rt 15.5 min).

iso-mogroside VI (1):White amorphous powder; [α]²⁰_{D}−8.2 (c 0.12, MeOH); For ¹H NMR and ¹³C spectroscopic data, see Tables 1; −HRESIMS: m/z 1449.7075 [M+H]⁻ (calcd. for C₆₆H₁₁₃O₃₄, 1447.7113, Δ2.6 ppm).

epi-mogroside V (2):White amorphous powder; [α]²⁰_{D}+4.5 (c 0.13, MeOH); For ¹H NMR and ¹³C spectroscopic data, see Tables 1; HRESIMS: m/z 1287.6558 [M+H]⁻ (calcd. for C₆₀H₁₀₃O29, 1287.6585, Δ2.1 ppm).

### Acid Hydrolysis and Determination of Absolute Configuration of Sugars

Compounds 1 (1.2 mg) or 2 (1.8 mg) were incubated in 1 mL 1 M HCl at 80° C. for 3 hrs. After hydrolysis, the solution was extracted with EtOAc (1 mL×3). The remaining aqueous solutions were evaporated by blowing nitrogen gas and freezing dried. The absolute configuration of the sugar in the residue was determined by GC-MS analysis of its O-silylated derivative and comparing with the derivatives of D-glucose and L-glucose standards. Briefly, the sugar residues, D-glucose (2 mg) or L-glucose (2 mg) were dissolved in pyridine (0.5 mL). 0.1 M L-cysteine methyl ester hydrochloride (Aldrich, Milwaukee, Wis.) in pyridine (0.5 mL) was added into the solution. The mixture was kept at 60° C. for 2 h and dried by blowing nitrogen gas. The residue was added with 1-trimethylsilylimidazole (Fluka, Buchs, Switzerland) (0.5 mL) and incubated under 60° C. for 1 h. The mixture was partitioned by adding n-hexane and water (1.0 mL each). The n-hexane extract was analyzed by GC-MS under the following conditions: capillary column HP-5MS (30 m×0.25 mm×0.25 μm, Agilent); column temperature, 180 to 230° C. at a ramp of 5° C./min; injection temperature, 250° C.; carrier, He gas; split ratio, 20:1. The O-silylated derivatives of D-glucose and L-glucose showed retention time at 16.02 and 16.39 min, respectively. By comparing the retention time and co-chromatography, the sugar residues after acid hydrolysis of 1 and 2 were determined to be D-glucose.

Reduction of 11-Oxo-Mogroside V with NaBH₄

25 mg of 11-oxo-mogroside V (4) was dissolved in 50% dioxane and added with 20 mg NaBH₄ and heated at 50° C. for 3 days. The reaction mixture was periodically analyzed by HPLC to monitor the reaction progress. After the reaction, the mixture was acidified by acetate acid and concentrated to dryness by blowing nitrogen gas. The residue was re-dissolved in water and passed through a pre-equilibrated C-18 SPE column. The methanol eluents from SPE column were concentrated. The residue was then separated by semi-preparative HPLC. The two reduced products had same retention time and molecular weight as the isolated mogroside V and 11-epi-mogroside V by LC-MS analysis and co-chromatography on analytical HPLC. The 1-D and 2-D NMR data also confirmed that the structures of the two reduced products were mogroside V and 11-epi-mogroside V.

### Results and Discussion

### Isolation and Elucidation of Iso-Mogroside VI (1) and 11-Epi-Mogroside V (2)

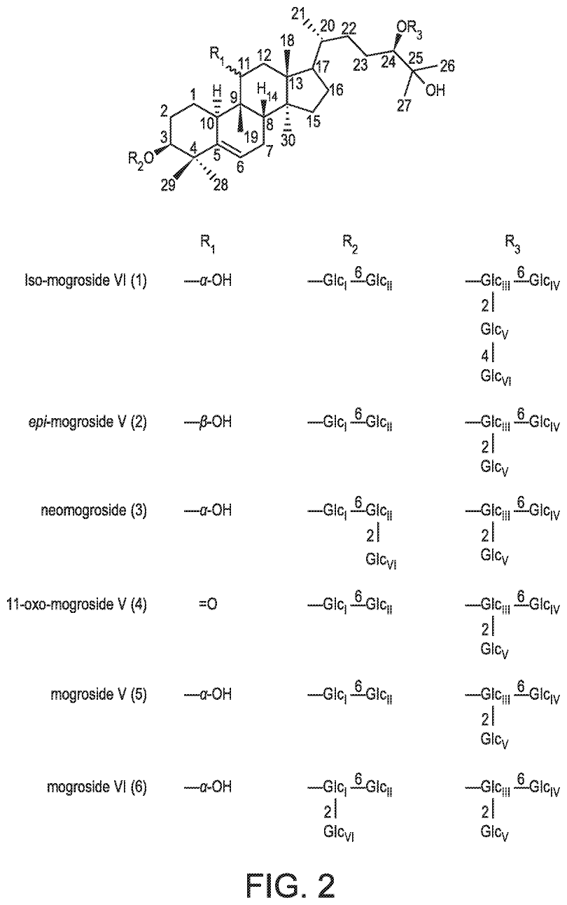

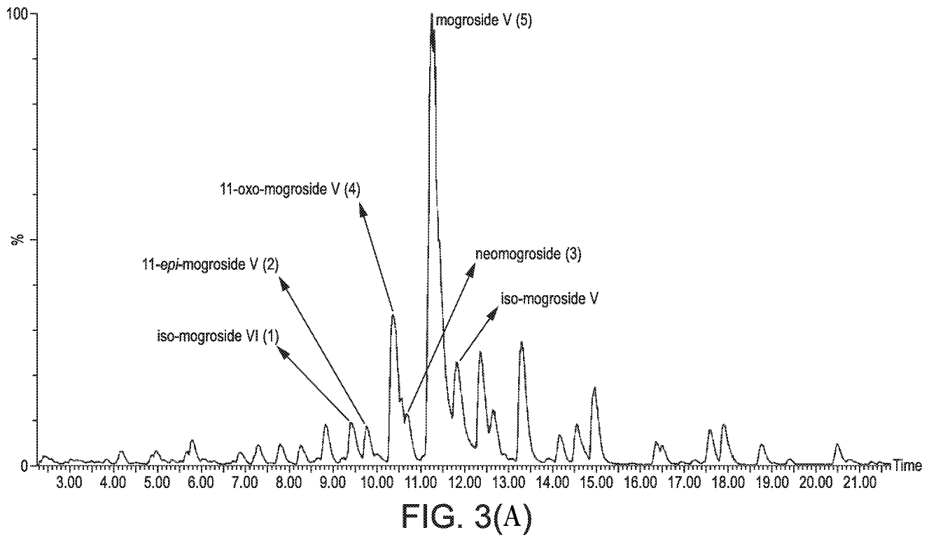

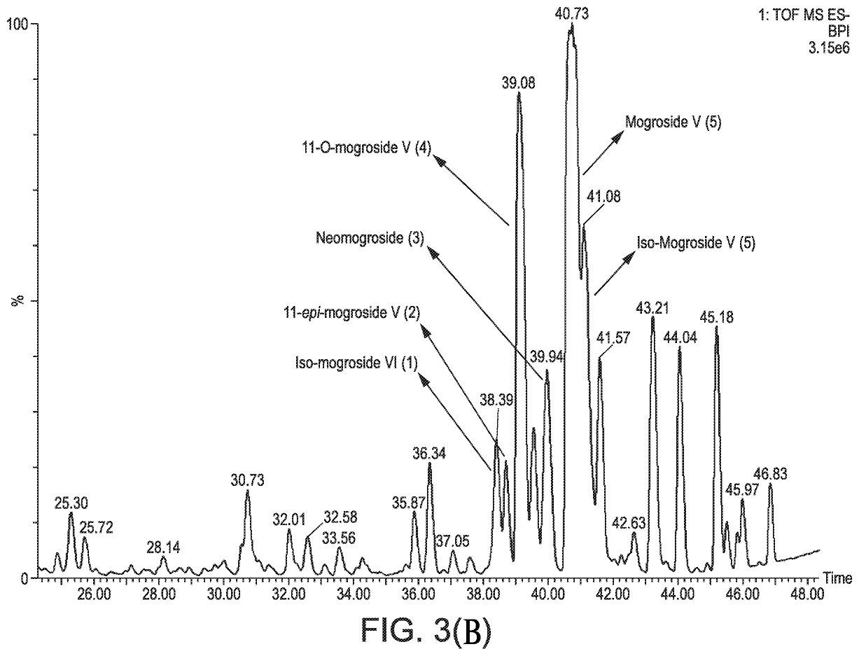

During the course of investigating a commercial Luo Han Guo extracts with 60% mogrosides by LC-MS, several mogrosides with six or five sugar moieties in the extracts attracted our attention (FIGS. 2 and 3). Since there were little report on the sweet properties of mogroside V and VI isomers, we decided to purify and identify these isomers for our evaluation. The concentrations of 1, 2, 3 and 4 in the extracts were estimated to be 0.8%, 0.5%, 0.6%, 4.9%, respectively, according to the universal Corona detector. After fractionated on flash chromatography system and followed by preparative HPLC purification, the four targeted mogrosides 1-4 were purified and determined to be iso-mogroside VI (1), 11-epi-mogroside V (2), neomogroside (3), 11-oxo-mogroside V(4).

The molecular formula of 1 was deduced as C₆₆H₁₁₂O₃₄ by its HR-ESI-MS spectral data ([M−H]⁻ m/z, 1447.6957, calcd. for C₆₆H₁₁₁O₃₄, 1447.6957). The NMR spectral data of 1 suggested the structure of a hexasaccharide triterpenoid saponin: 30 of the 66 carbons were assigned to the triterpenoid aglycone, and 36 of 66 to six hexose moieties. The ¹³C and ¹H NMR spectra of 1 showed the signals of seven singlet tertiary methyls, a doublet secondary methyl, and an olefinic methine (Table 19), which suggested a typical (24R)-cucurbit-5-ene-3β,11α,24,25-tetraol mogrol aglycone. The mogrol aglycone of 1 was further confirmed by extensive analysis of its ¹H, ¹³C, and 2D (COSY, TOCSY, HSQC and NOESY) NMR data, as well as comparison with NMR data of mogroside V standard.

TABLE 19
¹H NMR and ¹³C NMR spectroscopic data for iso-mogroside
VI and 11-epi-mogroside V (¹H 300 MHz and ¹³C 75 MHz in
pyridine-d₅/D₂O 10:1)

| | iso-mogroside VI | | | 11-epi-mogroside V | | |
|---|---|---|---|---|---|---|
| | δ_{H} | | δ_{C} | δ_{H} | | δ_{C} |
| 1 | 1.93, 2.86 | | 26.9 | 1.68, 1.93 | | 24.8 |
| 2 | 2.20, 2.38 | | 29.5 | 1.92, 2.42 | | 29.6 |
| 3 | 3.65 | (brs, 7.5) | 87.6 | 3.68 | (brs, 7.8) | 87.5 |
| 4 | — | | 42.4 | — | | 42.1 |
| 5 | — | | 144.5 | — | | 143.2 |
| 6 | 5.45 | (d, 4.8) | 118.5 | 5.47 | (d, 6.6) | 119.4 |
| 7 | 1.65, 2.27 | | 24.6 | 1.64, 2.22 | | 26.1 |
| 8 | 1.59 | | 43.6 | 1.99 | | 40.9 |
| 9 | — | | 40.2 | — | | 40.3 |
| 10 | 2.80 | (brd, 13) | 36.7 | 2.09 | | 40.1 |
| 11 | 4.15 | | 77.8 | 4.05 | | 72.5 |
| 12 | 2.12 | | 40.8 | 1.99, 2.15 | | 39.4 |
| 13 | — | | 47.5 | — | | 46.0 |
| 14 | — | | 49.8 | — | | 50.0 |
| 15 | 1.03, 1.10 | | 34.7 | 1.16 | | 35.5 |
| 16 | 1.40, 2.05 | | 28.6 | 1.40, 2.10 | | 28.6 |
| 17 | 1.72 | | 51.0 | 1.65 | | 51.7 |
| 18 | 0.86 s | | 17.1 | 1.29 s | | 18.3 |
| 19 | 1.28 s | | 26.3 | 1.25 s | | 23.2 |
| 20 | 1.46 | | 36.5 | 1.56 | | 36.8 |
| 21 | 1.04 | (d, 6.2) | 19.2 | 1.13 | (d, 5.9) | 19.3 |
| 22 | 1.67, 1.83 | | 33.4 | 1.69, 1.95 | | 33.6 |
| 23 | 1.53, 1.84 | | 29.5 | 1.56, 1.85 | | 29.5 |
| 24 | 3.71 | (d, 8.2) | 92.3 | 3.71 | (d, 8.6) | 92.6 |

| | | | | |
|---|---|---|---|---|
| 25 | — | 72.9 | — | 73.0 |
| 26 | 1.29 s | 26.9 | 1.30 s | 27.2 |
| 27 | 1.41 s | 24.6 | 1.44 s | 24.9 |
| 28 | 1.14 s | 27.8 | 1.03 s | 28.4 |
| 29 | 1.45 s | 26.2 | 1.46 s | 26.5 |
| 30 | 0.88 s | 19.5 | 0.81 s | 18.4 |

Glc-I

| | | | | | | |
|---|---|---|---|---|---|---|
| 1 | 4.73 | (d, 7.9) | 106.8 | 4.77 | (d, 7.9) | 106.6 |

| | | | | |
|---|---|---|---|---|
| 2 | 3.86 | 75.1 | 3.89 | 75 |
| 3 | 4.11 | 77.8 | 4.18 | 77.6 |
| 4 | 3.99 | 71.4 | 3.93 | 71.1 |
| 5 | 4.01 | 77.2 | 4 | 76.9 |
| 6 | 4.26, 4.69 | 70.1 | 4.26, 4.73 | 69.7 |

Glc-II

| | | | | | | |
|---|---|---|---|---|---|---|
| 1 | 5.10 | (d, 7.8) | 105.1 | 5.10 | (d, 7.8) | 104.8 |

| | | | | |
|---|---|---|---|---|
| 2 | 3.99 | 75.0 | 3.99 | 74.7 |
| 3 | 4.22 | 77.8 | 4.15 | 77.7 |
| 4 | 3.96 | 71.5 | 3.9 | 71.4 |
| 5 | 4.11 | 78.0 | 4.16 | 78.0 |
| 6 | 4.26, 4.47 | 62.5 | 4.26, 4.47 | 62.3 |

Glc-III

| | | | | | | |
|---|---|---|---|---|---|---|
| 1 | 4.85 | (d, 7.5) | 103.6591 | 4.85 | (d, 7.5) | 103.5 |

| | | | | |
|---|---|---|---|---|
| 2 | 4.12 | 81.6 | 4.22 | 80.9 |
| 3 | 4.21 | 78.3 | 4.23 | 78.3 |
| 4 | 3.93 | 71.4 | 3.99 | 70.9 |
| 5 | 4.01 | 76.4 | 4.02 | 76.1 |
| 6 | 3.92, 4.81 | 70.0 | 3.90, 4.80 | 69.7 |

Glc-IV

| | | | | | | |
|---|---|---|---|---|---|---|
| 1 | 4.78 | (d, 7.5) | 104.6 | 4.78 | (d, 7.5) | 104.3 |

| | | | | |
|---|---|---|---|---|
| 2 | 3.95 | 74.5 | 3.99 | 74.9 |
| 3 | 4.18 | 77.7 | 4.21 | 77.7 |
| 4 | 3.87 | 71.2 | 3.91 | 71 |
| 5 | 4.00 | 78.2 | 4.13 | 77.8 |
| 6 | 4.26, 4.47 | 62.4 | 4.26, 4.47 | 62.1 |

Glc-V

| | | | | | | |
|---|---|---|---|---|---|---|
| 1 | 5.43 | (d, 7.8) | 104.7 | 5.50 | (d, 7.8) | 104.5 |

| | | | | |
|---|---|---|---|---|
| 2 | 4.05 | 75.4 | 4 | 75.4 |
| 3 | 4.14 | 76.4 | 4.15 | 77.9 |
| 4 | 4.14 | 82.0 | 3.92 | 72.0 |
| 5 | 3.86 | 76.5 | 4.02 | 78.0 |
| 6 | 4.25, 4.42 | 62.6 | 4.25, 4.52 | 62.9 |

Glc-VI

| | | | |
|---|---|---|---|
| 1 | 5.03 | (d, 7.7) | 104.8 |

| | | |
|---|---|---|
| 2 | 3.99 | 74.6 |
| 3 | 4.16 | 77.7 |
| 4 | 3.94 | 71.3 |
| 5 | 4.07 | 77.9 |
| 6 | 4.37, 4.44 | 62.3 |

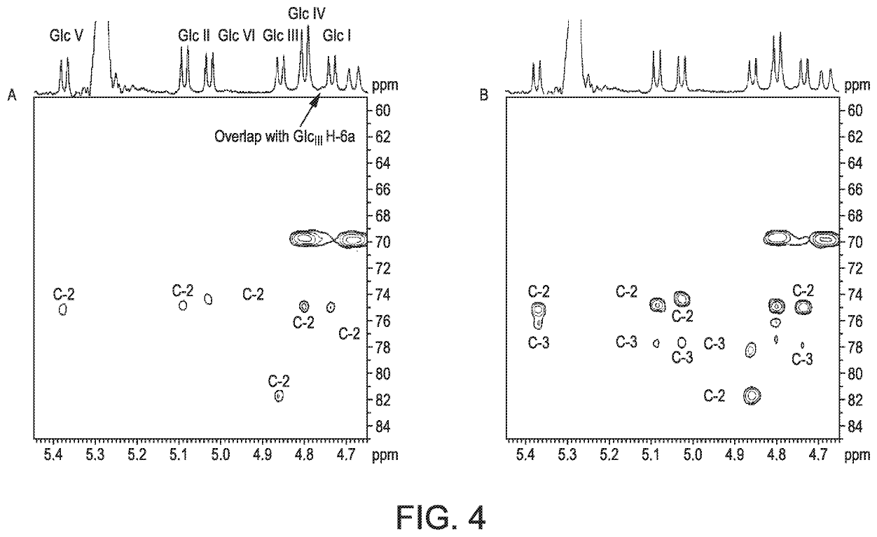

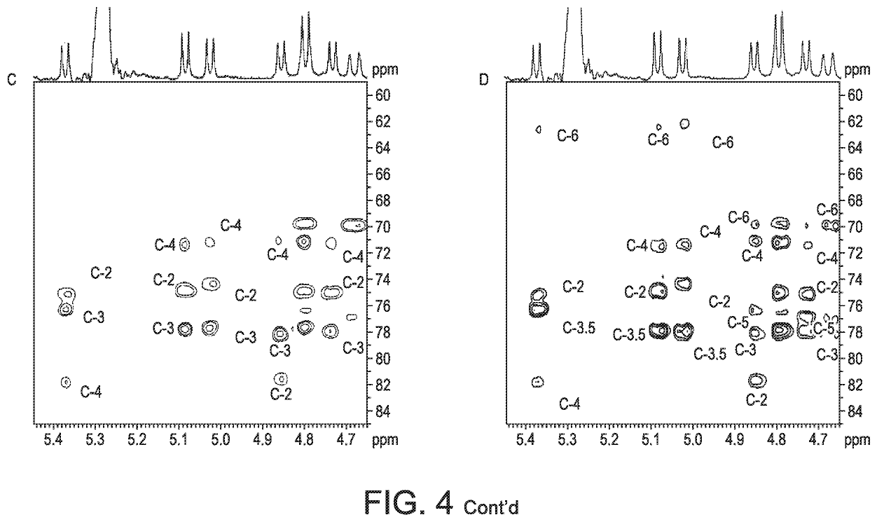

GC-MS analysis of water-soluble acid hydrolysis products of 1 showed that D-glucose was the only monosaccharide in the structure of 1. The HSQC spectra clearly displayed the anomeric cross-peaks of six glucosyls: Glc-I (δ_{C} 106.8 and δ_{H} 4.73), Glc-II (δ_{C} 105.1 and δ_{H} 5.10), Glc-III (δ_{C} 103.7 and δ_{H} 4.85), Glc-IV (δ_{C} 104.6 and δ_{H} 4.78), Glc-V (δ_{C} 104.7 and δ_{H} 5.43), Glc-VI (δ_{C} 104.8 and δ_{H} 5.03). The stereochemistry of all the six glucopyranosyls were determined to be β configuration from their anomeric proton coupling constants ³J_{H1, H2}. From HSQC-TOCSY experiment (hsqcgpmlph) with 100 ms mixing time, the glucopranosyl carbon signals can be divided into six groups (FIG. 4). The oligosaccharide elucidation was started from the glucopyranosyl connected at C-3 of the cucurbitane aglycone. Glc-I was determined to link with aglycone C-3 according to the HMBC correlation of its anomeric proton (δ_{H} 4.73, d, J=7.9 Hz) with aglycone C-3 (δ_{C} 87.6) and the NOESY correlation of Glc-I H-1 and aglycone H-3. The ¹³C signals of Glc-I (δ_{C} 75.1, 77.8, 71.4, 77.2, 70.1) as determined by HSQC-TOCSY missed a typical C-6 carbon signal at around δ_{C} 62. The downfield shift of Glc-I C-6 (δ_{C} 70.1) indicated glycosylation at this position. By comparing HSQC-TOCSY spectra (hsqcgpmlph) with increased mixing time from 10, 30, 60, and 100 ms, the magnetization transfer relay can be observed gradually extending from C-2 to C-6 (FIG. 4). As shown in FIG. 4, HSQC-TOCSY under 10 ms mixing time displayed the correlation of glucopyranosyl H-1 and C-2. Under 30 ms mixing time, the correlation of H-1 and C-3 appeared in addition to H-1 and C-2 correlation. Under 60 ms, the carbon chain as indicated by the HSQC-TOCSY correlation extend to C-4. The full HSQC-TOCSY correlation of H-1 with C-2 to C-6 can be observed under 100 ms. Therefore, signals of C-2 to C-6 can be unambiguously assigned. The linkage of Glc-II to Glc-I was established by the HMBC correlation of anomeric Glc-II H-1 (δ_{H} 5.10, d, J=7.8 Hz) to Glc-I C-6 (δ_{C} 70.1). The ¹³C signals of Glc-II (δ_{C} 75.0, 77.8, 71.5, 78.0, 62.5) suggested no glycosylation on Glc-II. As a result, the sugar chain on aglycone C-3 was furnished as 3-O-(β-D-glucopyranosyl(1→6)-β-D-glucopyranosyl.

HMBC correlation of anomeric proton (δ_{H} 4.85, d, J=7.5 Hz) to aglycone carbon signal (δ_{C} 92.3) indicated the connection of Glc-III H-1 to aglycone C-24. The ¹³C pattern of Glc-III (δ_{C} 81.6, 78.3, 71.4, 76.4, 70.0) suggested C-2 and C-6 glycosylation shifts. Analysis of HSQC-TOCSY with 10, 30, 60, and 100 ms mixing time resulted in the sequential assignment and confirmation of C-2 and C-6 downfield shifts. Glc-IV was determined to connect to C-6 of Glc-III as from its H-1 (δ_{H} 4.78, d, J=7.5 Hz) HMBC correlation with C-6 of Glc-III (δ_{C} 70.0). Glc-IV was a regular terminal glucopyranosyl without any substitution (δ_{C} 74.5, 77.7, 71.2, 78.2, 62.4). The linkage of Glc-V to C-2 of Glc-III was established by HMBC correlation of anomeric Glc-V H-1 (δ_{H} 5.43, d, J=7.8 Hz) to Glc-III C-2 (δ_{C} 81.6). The relatively down-field shift of Glc-V H-1 (δ_{H} 5.43) was consistent with previous reports with similar structure. The ¹³C chemical shift of C-4 normally at δ_{C} 70-71 was missing in the Glc-V signal set (δ_{C} 104.7, 75.4, 76.4, 82.0, 76.5, 62.6), which suggested glycosylation at C-4. By observing the C-2 to C-6 relay from HSQC-TOCSY with 10, 30, 60 and 100 ms mixing time, δ_{C} 82.0 was clearly assigned to C-4 of Glc-V (FIG. 4). HMBC cross-peak between C-4 of Glc-V (δ_{C} 82.0) and H-1 of Glc-VI (δ_{H} 5.03, d, J=7.7 Hz) further confirmed that Glc-VI linked to Glc-V at this position. Glc-VI was a terminal glucopyranosyl without further sugar branch. Based upon the above evidences, the structure of iso-mogroside (1) was assigned as 3-O-β-D-glucopyranosyl(1→6)-β-D-glucopyranosyl-mogrol-24-O-β-D-glucopyranosyl-(1→6-[β-D-glucopyranosyl-(1→4)-β-D-glucopyranosyl-(1→2)]-β-D-glucopyranosyl.

Compound 2 was assigned a molecular formula of C₆₀H₁₀₂O₂₉ from its HR-ESI-MS data ([M−H]⁻ m/z, 1285.6429). The NMR data of the oligosaccharide portion of 2 were superimposable with those of mogroside V. Detailed 2-D NMR experiments including HSQC, HMBC, NOESY, COSY and HSQC-TOCSY confirmed that 2 had the same sugar moieties as mogroside V. Attentions were then turned onto the aglycone NMR data. The HMBC correlation between C-11 and H₃-19 revealed significant upfield shift of C-11 (δ_{C} 72.5) as compared with mogroside V (δ_{C} 77.8). Further assignment of aglycone data by 2-D NMR experiments showed that major ¹³C chemical shift changes occurred on C-8, C-10 and C-12 when comparing with the data of mogroside V (Table 19). This suggested β-OH instead of α-OH at C-11. The β-OH stereo structure of 2 was further established by NOE correlations between H-8 and H₃-18, 19; H-10 and H₃-28, H₃-30; H-11 and H₃-30; H-17 and H₃-30. There were one natural 11-β-OH cucurbitane and one semi-synthetic 11-β-OH cucurbitane reported before [14, 15]. The ¹³C NMR data of compound 2 aglycone had a good match with the data of the semi-synthetic 11-β-OH cucurbitane glycoside, which was recorded in pyridine-d₆[14]. The ¹³C NMR data of natural 11-β-OH cucurbitane by Matsuda et al was obtained in methanol-d₄ and were quite different in terms of chemical shifts at C-11, C-8, C-10 and C-12 [15]. To further confirm the 11-β-OH structure of 2, semi-synthesis of 2 was carried out by chemical reduction of 11-oxo-mogroside V (4) to the 11-β-OH and 11-α-OH isomers of mogroside V. By LC-MS, HPLC co-chromatography and NMR data analysis, the semi-synthetic 11-epi-mogroside V was determined to be identical to the isolated 11-epi-mogroside V. Therefore, the structure of 11-epi-mogroside V (2) was elucidated as 3-O-β-D-glucopyranosyl(1→6)-β-D-glucopyranosyl-11β-OH-mogrol-24-O-β-D-glucopyranosyl-(1→2)-[β-D-glucopyranosyl-(1→6)]-β-D-glucopyranosyl. To our best of knowledge, this is the first report of natural mogroside with a 11-β hydroxyl group.

HSQC-TOCSY with Different Mixing Time for Oligosaccharide Chain Elucidation.

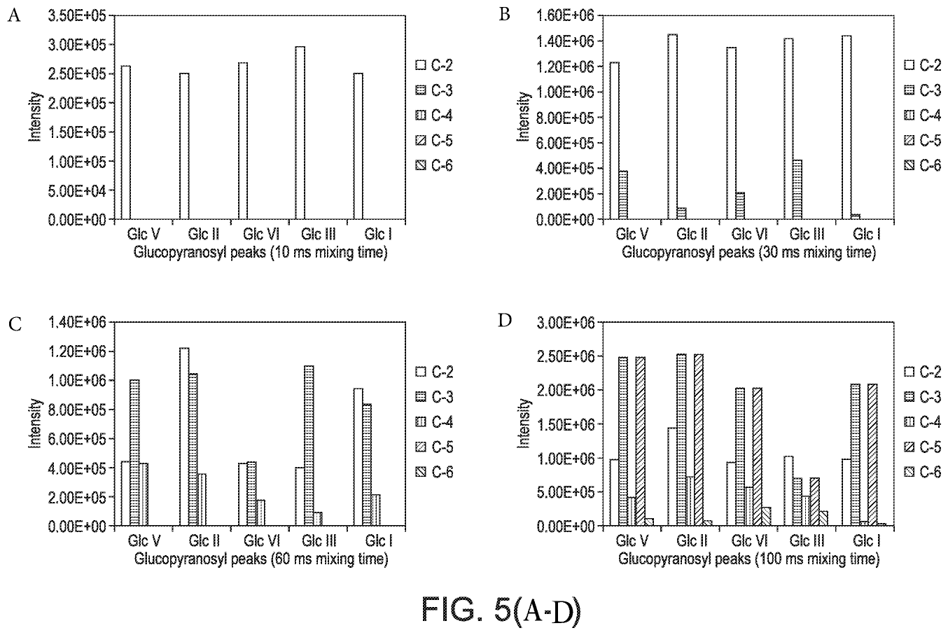

Gheysen et al investigated TOCSY experiments with different mixing time and concluded 100 ms as the optimal spin lock time to discriminate D-glucose, D-galactose and D-mannose [16]. Through their results, we noticed that the spin lock time could significantly affect the magnetization transfer efficiency of H-1 of D-glucose. The correlation between H-1 and H-2 through H-6 gradually extended to H-6 as the spin lock time increased. Inspired from their investigation, we hypothesized that by increasing spin lock time of HSQC-TOCSY, we should be able to see that the correlations of glucose H-1 with C-2 to C-6 gradually extend from C-2 to C-6 as the chain of the magnetization transfer extends. HSQC-TOCSY with increasing spin lock time should tell the carbon sequence information, which would be very useful for oligosaccharide elucidation and assignment. FIG. 4 showed HSQC-TOCSY (hsqcgpmlph) of iso-mogroside VI with 10, 30, 60 and 100 ms mixing time. The cross-peaks in FIG. 4 were quantified by their integrals and compared in FIG. 5. The peak intensity (as presented by the integrals) could be an indication of their distance from H-1 in some cases. For example, all the C-3 peaks were significantly weaker than C-2 peaks under 30 ms mixing time experiments. However, under 60 ms C-3 peaks become bigger than C-2 peaks. To ensure correct elucidation, the carbon sequence should be determined through the overview of all the HSQC-TOCSY spectra with different mixing time, not just by the peak intensity under one mixing time.

Traditionally, NMR elucidation and assignment of sugar chain of saponins start from the sugar linked to aglycone. By HMBC or NOESY, the well-resolved anomeric H-1 and C-1 signals can be identified. Then through COSY correlations and matching ³J (H,H) coupling constants, the proton signals of the monosaccharide can be assigned. Since a large coupling constant (>7 Hz) typically indicate two neighboring axial C—H bonds and small coupling constant (<4 Hz) for an axial-equatorial or equatorial-equatorial C—H bond, the type of monosaccharide can be determined. NOE correlations are useful for confirmation of the stereochemistry of axial-axial, axial-equatorial or equatorial-equatorial relations. The carbon signals of the saccharide (C-2 to C-6) are assigned according to HSQC or HMQC. The chemical shifts of the carbon signals as determined by HSQC/HMQC are very important information to confirm the monosaccharide type since the pattern of C-1 to C-6 chemical shifts for different type of monosaccharides is characteristic and consistent. Through the observation of carbon chemical shifts changes, the glycosylation position on the sugar chain can be identified and further confirmed by HMBC correlation. In summary, traditional way to elucidate saponin sugar is: HMBC→C-1, H-1→COSY→H-2 to H-6→HSQC/HMQC→C-2 to C-6, then assisted and confirmed by coupling constant analysis and NOESY experiment.

¹H-¹H TOCSY (Total Correlated Spectroscopy also known as HOHAHA—Homonuclear Hartmann Hahn) experiment could be a big help to divide the complicated sugar proton signals into groups. The transfer of magnetization during the TOCSY spin lock from the anomeric H-1 to the end of the furanose or pyranose ring will depend on the magnitude of the intervening ³J (H,H) scalar coupling constants. Neighboring axial-axial protons with large coupling constant (>7 Hz) allow a fast transfer of magnetization, whereas axial-equatorial or equatorial-equatorial with small coupling constant (<4 Hz) will considerably reduce transfer efficiency. Therefore, TOCSY experiment not only can be used to group proton signals into spin systems, but also provide the stereochemistry information of the saccharide. For example, we should be able to see the magnetization relay of glucose through H-1 to H-6 with the right mixing time. For galactose, there is no magnetization relay over H-4 even with 200 ms mixing time.

However, for the case of mogrosides with five or six sets of glucopyranosyl signals, using COSY and TOCSY to connect H-1 to H-6 can be quite tricky. The proton signals of the mogroside glucopyranosyls have very similar chemical shifts and appear crowded in a small range from δ_{H} 3.8 to 4.5. It is hard to make clear COSY connections through such poorly-resolved proton signals. The glucopyranosyl carbon signals are also very close and the HSQC cross-peaks heavily overlap to each other, which make the elucidation and assignment even more difficult.

Previously, HSQC-TOCSY have been applied in the structure elucidation and assignment of saponins by grouping carbon signals in each spin system together [17, 18]. Through our investigation, we demonstrated for the first time that the signal sequence within the glucopyranosyl carbon group can be identified by applying different mixing time in HSQC-TOCSY experiments.

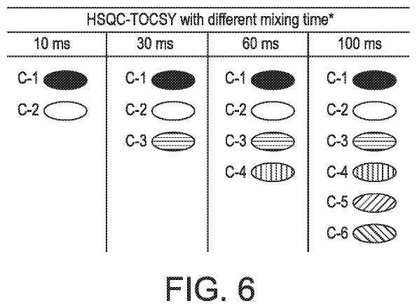

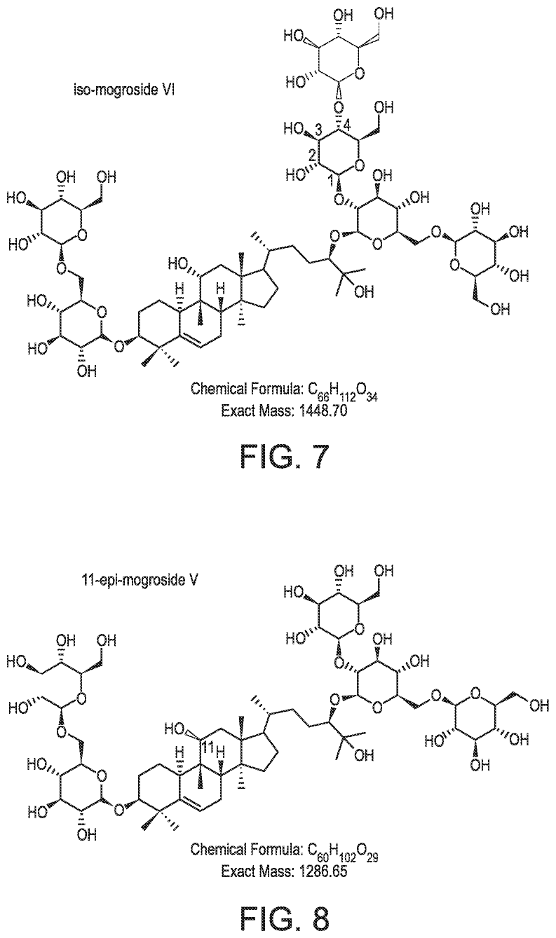

FIG. 6 summarized the new HSQC-TOCSY based strategy to elucidate the glucopyranosyl oligosaccharide chain of mogrosides as follows: In Step 1, Heteronuclear multiple bond correlation spectroscopy (HMBC) was used to determine anormeric C-1 and H-1 of the sugar. Start from the sugar link to aglycone. In Step 2, HSQC-TOCSY was used with 100 ms mixing time to determine the whole group of C-2 to C-6. HSQC-COSY or HSQC-TOCSY (d9=10 ms) to assign C-2. HSQC-TOCSY (d9=30 ms) to assign C-3. HSQC-TOCSY (d9=60 ms) to assign C-4. HSQC-TOCSY (d9=100 ms) to assign C-5 and C-6. In Step 3, if a C-2 downshift from ˜δ75 to ˜δ81, C-4 downshift from ˜δ71 to ˜δ81 or C-6 downshift from ˜δ62 to ˜δ9 is observed, check HMBC for glycosylation at these positions.** If a C-2 downshift from ˜δ75 to ˜δ81, C-4 downshift from ˜δ71 to ˜δ81 or C-6 downshift from ˜δ62 to ˜δ9, check HMBC for glycosylation at these positions.**. 1-D NMR data such as ¹H coupling constants and ¹³C carbon signal pattern and 2-D NMR experiments such as NOESY, HMBC, TOCSY, COSY and HSQC could assist the process and confirm the results. The new HSQC-TOCSY based strategy may provide a simple, fast and unambiguous way for elucidation and assignment of glucopyranosyl chains of any new or known mogrosides. The strategy can also be adapted for elucidation and assignment of other monosaccharides and oligosaccharides.

### Structures of Neomogroside and Mogroside VI

Compound 3 was determined to be neomogroside by extensive 1-D and 2-D NMR analysis, as well as comparison with literature data [19]. For the oligosaccharide chain elucidation of 3, signals were assigned by HSQC-TOCSY and TOCSY experiments with different mixing time at 10, 30, 60, 100 ms. The linkage of the six saccharides were made by their NOESY and HMBC correlations. The oligosaccharide chain on C-3 of aglycone can be clearly assigned as β-D-glucopyranosyl-(1→2)-β-D-glucopyranosyl-(1→6)-β-D-glucopyranosyl. The glucopyranosyl on C-24 of aglycone was branched with a β-D-glucopyranosyl-(1→2) and a β-D-glucopyranosyl-(1→6).

Neomogroside was firstly discovered from S. grosvenorii and described by Si et al. [19]. Searching neomogroside in Scifinder returned the CAS number 189307-15-1. However, the incorrect structure of neomogroside was given in Scifinder even though the literature referred by Scifinder was the 1996 article by Si et al. The incorrect structure of 189307-15-1 was given as 3-O-β-D-glucopyranosyl-(1→2)-[β-D-glucopyranosyl-(1→6)]-β-D-glucopyranosyl-mogrol-24-O-β-D-glucopyranosyl-(1→6)-[β-D-glucopyranosyl-(1→2)]-β-D-glucopyranosyl (structure of 6 in FIG. 2) in Scifinder. The report of neomogroside by Si et al was written in Chinese and published in a Chinese journal in 1996. The accessibility and misunderstanding of this article might lead to the incorrect structure in Scifinder.

In Scifinder, neomogroside and mogroside VI had the same CAS number 189307-15-1 and same structure. Takemoto et al firstly reported mogroside VI from S. grosvenorii [2]. But it only referred a pure mogroside with a molecular formula of C₆₆H₁₁₂O₃₄ and no structure was determined [2]. Prakash et al. reported the structure and NMR data of mogroside VI as a known compound in their article published in 2011 [6]. In their article, the structure of mogroside VI was assigned as the structure of 6 in FIG. 2. Prakash mentioned that the structure elucidation of mogroside VI was made by NMR analysis and also by comparing with the literature values. However, no citation was given for the literature values.

For known compounds, comparison of NMR data with literature data could be useful for structure determination. However, the complexity of mogroside NMR data makes it difficult to determine the structure mainly by comparison of NMR data with literature data. ¹H NMR data of known mogrosides in different reports showed variations due to different NMR solvents used (the ratio of pyridine and D₂O could cause signal shifts) or simply incorrect assignments.

Even though ¹³C NMR data are quite consistent and have better resolution than ¹H NMR data, structure determination of oligosaccharide chain of known mogrosides cannot be relied on directly comparing ¹³C NMR data with literature data. Considering the case of neomogroside, if the Glu-VI glucopyranosyl-(1→2) branched on Glu-I, Glu-II, Glu-III, Glu-IV, or GluV, the five isomers may have very similar ¹³C NMR data. Rather than comparing ¹³C NMR data with literature data, extensive 2-D NMR analysis should be carefully done before the oligosaccharide chain of mogrosides are unambiguously determined.

### Example 11

### Sweet Intensity of Iso-Mogroside VI and 11-Epi-Mogroside V

### Methods

10 mg iso-mogroside VI (FIG. 7) was dissolved in 31 mL water to make 100 ppm iso-mogroside VI solution. The working solution of 11-epi-mogroside V (FIG. 8) was 374 ppm (9.34 mg 11-epi-mogroside V in 25 mL water), A series of standard sucrose solutions were prepared (0.50, 0.75, 1.00, 1.25, 1.50%) as sweetness references.

### Results

Four sweet sensitive panelists evaluated 100 ppm iso-mogroside VI and 374 ppm 11-epi-mogroside V and the sucrose standards, and were asked to give sweet equivalence concentrations to sucrose. The mean sweet equivalence concentrations of each compound were used to calculate the iso-sweet potency. The iso-sweet potency values of iso-mogroside VI and 11-epi-mogroside V were determined as 91 and 35 times of sweetness of sucrose, respectively (100 ppm iso-mogroside VI sweet equivalent to 0.91% sucrose; 374 ppm 11-epi-mogroside V sweet equivalent to 1.31% sucrose).

### Example 12

### Methods

Iso-Mogroside VI and 11-epi-mogroside V were obtained as described in Example 10. The iso-Mogroside VI and 11-epi-mogroside V were each added to a solution containing 5% sucrose and 0.03% citric acid in a concentration of 25 ppm. These test solutions were tasted by an expert panel of seven people. For various aspects of sweet taste (overall sweet, upfront sweet, lingering sweet, astringent, volatile off-note), each panellist scored the test solutions in comparison to the base solution (solution of 5% sucrose and 0.03% citric acid). A score of 0 indicated that the taste aspect was the same, 1 indicates slightly higher, 2 indicates higher, 3 indicates much higher, −1 indicates slightly lower, −2 indicates lower and −3 indicates much lower.

### Results

The average score for each test solution for each taste aspect was calculated. The results are shown in Table 20 below.

TABLE 20

| | Iso-Mogroside | Epi-Mogroside |
|---|---|---|
| | VI | V |
| Overall Sweet | 0.2 | 0.17 |
| Upfront Sweet | 0.2 | 0.33 |
| Lingering | 0.2 | 0 |
| Sweet | | |
| Astringent | 0 | 0 |
| Volatile Off- | 0 | 0 |
| Note | | |
| Comments | Slightly acidic | Higher upfront |
| | | sweetness |
| | | offsets slightly |
| | | lower linger to |
| | | give overall |
| | | higher |
| | | sweetness |

Two new minor cucurbitane glycosides along with known 11-oxo-mogroside and neomogroside were purified from the commercial extracts of Luo Han Guo (Siraitia grosvenorii (Swingle) C. Jeffrey ex Lu et Z. Y. Zhang). By extensive NMR and LC-MS analyses and chemical synthesis, the structures of the two new compounds iso-mogroside VI (1) and 11-epi-mogroside V (2) were elucidated as 3-O-β-D-glucopyranosyl(1→6)-β-D-glucopyranosyl-mogrol-24-O-(β-D-glucopyranosyl-(1→6)-[β-D-glucopyranosyl-(1→4)-β-D-glucopyranosyl-(1→2)]-β-D-glucopyranosyl and 3-O-β-D-glucopyranosyl(1→6)-β-D-glucopyranosyl-11β-OH-mogrol-24-O-β-D-glucopyranosyl-(1→6)-[β-D-glucopyranosyl-(1→2)]-β-D-glucopyranosyl, respectively. The sweet potency of iso-mogroside VI and 11-epi-mogroside V were evaluated as 91 and 35 times of sweetness of sucrose, respectively (100 ppm iso-mogroside VI sweet equivalent to 0.91% sucrose; 374 ppm 11-epi-mogroside V sweet equivalent to 1.31% sucrose). Through our course of identifying the new and known mogrosides with five or six glucopyranosyls, a new strategy for glucopyranosyl sugar chain elucidation and assignment was developed. The new strategy based on HSQC-TOCSY experiments with different mixing times featured a quick and unambiguous elucidation and assignment of glucopyranosyl oligosaccharide chains. The previous confusion regarding the structures of neomogroside and mogroside VI was reviewed and clarified after the confirmation of neomogroside structure by our extensive NMR spectral analysis.

### Example 13

Carbonated Soft Drink with 30%-100% Sugar Replacement With Composition Comprising Reb M, glucosylated steviol glycoside and taste modifier.

Carbonated soft drink beverages were prepared in accordance with Table 21 below and were evaluated by experienced flavorists for sweetness characteristics and sensory perceptions of mouthfeel.

TABLE 21

| | FM-C1 | FM-2 | FM-3 | FM-4 | FM-5 | FM-C6 | FM-C7 | | |
|---|---|---|---|---|---|---|---|---|---|
| | Full | 30% | 50% | 70% | 80% | 50% | 70% | FM-8 | FM-C9 |
| | Sugar | sugar red | sugar red | sugar red | sugar red | sugar red | sugar red | Zero | Zero |
| | 10 Brix | to 7 Brix | to 5 Brix | to 3 Brix | to 2 Brix | to 5 Brix | to 3 Brix | sugar red | sugar red |
| Ingredients | % | % | % | % | % | % | % | % | % |
| Water | 8.614 | 17.914 | 24.114 | 30.314 | 33.414 | 34.114 | 70.314 | 64.614 | 109.614 |
| Sodium Benzoate | 0.033 | 0.033 | 0.033 | 0.033 | 0.033 | 0.033 | 0.033 | 0.033 | 0.033 |
| Carmel Color | 0.036 | 0.036 | 0.036 | 0.036 | 0.036 | 0.036 | 0.036 | 0.036 | 0.036 |
| Sugar syrup 65° Brix | 31 | 21.7 | 15.5 | 9.3 | 6.2 | 15.5 | 9.3 | 0 | 0 |
| Citric Acid | 0.15 | 0.15 | 0.15 | 0.15 | 0.15 | 0.15 | 0.15 | 0.15 | 0.15 |
| Guarana Flavor | 0.12 | 0.12 | 0.12 | 0.12 | 0.12 | 0.12 | 0.12 | 0.12 | 0.12 |
| Guarana Extract | 0.05 | 0.05 | 0.05 | 0.05 | 0.05 | 0.05 | 0.05 | 0.05 | 0.05 |
| Total Conc. Base (syrup) | 40 | 40 | 40 | 40 | 40 | 50 | 80 | 65 | 110 |
| Conc. Base Syrup | 1 + 4 | 1 + 4 | 1 + 4 | 1 + 4 | 1 + 4 | 1 + 3 | 1 + 1.5 | 1 + 2.07 | 1 + 0.82 |
| Dilution | | | | | | | | | |
| Reb M powder | 0 | 0.01 | 0.018 | 0.027 | 0.031 | 0.054 | 0.086 | 0.072 | 0.12 |
| GSG Powder | 0 | 0.012 | 0.022 | 0.03 | 0.035 | 0 | 0 | 0.086 | 0 |
| MM Powder | 0 | 0.1 | 0.15 | 0.23 | 0.3 | 0.15 | 0.23 | 0.4 | 0.4 |
| Still Water | 20 | 20 | 20 | 20 | 20 | 10 | 0 | 0 | 0 |
| Carbonated Water | qs = 200 | qs = 200 | qs = 200 | qs = 200 | qs = 200 | qs = 200 | qs = 200 | qs = 200 | qs = 200 |
| Carbonation level (CO₂) | 3.5 vol. | 3.5 vol. | 3.5 vol | 3.5 vol | 3.5 vol | 3.5 vol. | 3.0 vol. | 3.3 vol | 2.2 vol |
| Total Beverage | 200 | 200 | 200 | 200 | 200 | 200 | 200 | 200 | 200 |
| Final brix (theoretical | 10.075 | 7.052 | 5.03 | 3.02 | 2.015 | 5.03 | 3.02 | 0 | 0 |
| sugar %) | | | | | | | | | |
| Reb M over syrup (%) | 0 | 0.025 | 0.045 | 0.068 | 0.078 | 0.108 | 0.108 | 0.111 | 0.109 |

Reb M Powder = Rebaudioside M powder
GSG Powder = Glucosylated steviol glycoside powder
MM Powder = off-note masking and mouthfeel improving ingredient

TABLE 22
Results of Comparative Evaluation of Carbonated
Soft Drink Beverages of Table 21

| | CO₂ | |
|---|---|---|
| Sample | volume | Evaluation |
| FM-2 | 3.5% | Very similar with full-sugar. Optimum upfront, sweet |
| | | intensity = OK, linger = OK, optimum body/juicy/ |
| | | sugary, slight higher CO2 sens.. AFT: good, slight + |
| | | CO2/tingling. |
| FM-3 | 3.5% | Optimum upfront, swt intense = OK, linger = OK, |
| | | body = ok, juicy/sugary = very good, slightly + |
| | | tingling/CO2 sens.. AFT: good, sl. + tingling/CO2. |
| FM-4 | 3.5% | Optimum up-front, swt intense = OK, linger = OK, |
| | | body slightly (−), juicy/sugary = sl.***(−), |
| | | slightly + tingling/CO2 sens., clean taste. AFT: |
| | | sl.**(−) body, swt = ok, *** + CO2. |
| FM-5 | 3.5% | Good upfront, swt intense = OK, linger = OK, body |
| | | very slightly (**−), sugary = OK, juicy sl.(**−), |
| | | NO bitter, no dry, sl.** + tingling/CO2 sens.. AFT: |
| | | clean, sl.(***−)body, swt = OK |
| FM-C6 | 3.5% | Upfront slightly less, initial swt intense = OK, |
| | | sl.** + swt linger, body = **+, slightly |
| | | (−)sugary, * + tingling/CO2, clean taste. AFT: |
| | | slightly + swt linger, * + dry/tingling. |
| FM-C7 | 3.0% | Upfront = OK, swt intense initial = ok but with |
| | | intense swt linger, swt clean profile, body = OK, |
| | | slightly ** + sugary intense. AFT: ++linger, |
| | | ** + tingling, slightly dry, NO bitter. |
| FM-8 | 3.3% | Good upfront, swt intense very sl. lower, linger = |
| | | OK, sugary = OK, body/juicy = very slightly |
| | | (**−), ** + tingling/CO2 sens.. AFT: swt = OK, |
| | | slightly + CO2/tingling, sl. dry. |
| FM-C9 | 2.2% | Slight. Less upfront, slight (−) swt intense, but |
| | | with high linger, lower CO2 sens., body/juicy = less, |
| | | clean swt profile.AFT: ++strong linger swt, (−) |
| | | CO2 sens., clean swt. |

### Example 14

Still Apple Beverage with 50% and 80% Sugar Replacement With Composition Comprising Reb M, glucosylated steviol glycoside and taste modifier.

Still Apple Beverages were prepared in accordance with Table 23 below and were evaluated by experienced flavorists for sweetness characteristics and sensory perceptions of mouthfeel.

TABLE 23

| | FM-C10 | FM-C11 | FM-12 | FM-C13 | FM-14 | FM-15 |
|---|---|---|---|---|---|---|
| | Full Sugar | 50% sugar red | 50% sugar red | 80% sugar red | 80% sugar red | 80% sugar red |
| | 10 Brix | to 5 Brix | to 5 Brix | to 2 Brix | to 2 Brix | to 2 Brix |
| Ingredients | % | % | % | % | % | % |
| Sodium Benzoate | 0.02276 | 0.02276 | 0.02276 | 0.02276 | 0.02276 | 0.02276 |
| Citric Acid | 0.19500 | 0.19500 | 0.19500 | 0.19500 | 0.19500 | 0.19500 |
| Apple Flavor | 0.08700 | 0.08700 | 0.08700 | 0.08700 | 0.08700 | 0.08700 |
| Refined Sugar | 0 | 10.1 | 10.1 | 4.1 | 4.1 | 4.1 |
| Sugar syrup 65° Brix | 30.8 | 0 | 0 | 0 | 0 | 0 |
| Water | 2.192343 | 22.892343 | 22.892343 | 28.892343 | 28.892343 | 28.892343 |
| Tartrazine color (E102) | 0.000066 | 0.000066 | 0.000066 | 0.000066 | 0.000066 | 0.000066 |
| FD&C Blue No. 1/Brilliant | 0.000033 | 0.000033 | 0.000033 | 0.000033 | 0.000033 | 0.000033 |
| Blue (E113) | | | | | | |
| Azorubine color (E122) | 0.000866 | 0.000866 | 0.000866 | 0.000866 | 0.000866 | 0.000866 |
| Sunset yellow color (E110) | 0.000033 | 0.000033 | 0.000033 | 0.000033 | 0.000033 | 0.000033 |
| FD&C Red #40, granular | 0.000166 | 0.000166 | 0.000166 | 0.000166 | 0.000166 | 0.000166 |
| Caramel liq. | 0.001733 | 0.001733 | 0.001733 | 0.001733 | 0.001733 | 0.001733 |
| Additional water to conc. syrup | 0 | 16.7 | 0 | 56.7 | 0 | 3.7 |
| Total Conc. Base (syrup) | 33.3 | 50 | 33.3 | 90 | 33.3 | 37 |
| Conc. Base Syrup Dilution | 1 + 5 | 1 + 3 | 1 + 5 | 1 + 1.22 | 1 + 5 | 1 + 4.4 |
| Reb M powder | 0 | 0.1 | 0.1 | 0.1 | 0.1 | 0.1 |
| GSG Powder | 0 | 0 | 0.022 | 0 | 0.035 | 0.049 |
| MM Powder | 0 | 0.2 | 0.2 | 0.32 | 0.32 | 0.38 |
| Protein-T Sol. 10% PG/WA (75/25) | 0 | 0.1 | 0.1 | 0.1 | 0.1 | 0.1 |
| Still Water | qs = 200 | qs = 200 | qs = 200 | qs = 200 | qs = 200 | qs = 200 |
| Total Beverage | 200 | 200 | 200 | 200 | 200 | 200 |
| Final brix (theoretical sugar %) | 10 | 5 | 5 | 2 | 2 | 2 |
| Reb M over syrup (%) | 0 | 0.108 | 0.054 | 0.111 | 0.093 | 0.111 |

Reb M Powder = Rebaudioside M powder
GSG Powder = Glucosylated steviol glycoside powder
MM Powder = off-note masking and mouthfeel improving ingredient

TABLE 24
Results of Comparative Evaluation of
Still Apple Beverages of Table 23.

| Sample | Evaluation |
|---|---|
| FM-C10 | Very similar to FM-C1 full sugar; |
| FM-C11 | Slight less upfront, initial sweet ok, intense lingering, |
| | slight dryness and bitter, less juicy, slight lower body- |
| | mouthfeel, AFT: lingering and slight dryness. |
| FM-12 | Optimum upfront, clean sweet, intense, sugary type, no |
| | bitter, reduced dryness, increased juicy, improved |
| | mouthfeel-body, AFT: slightly lingering, no dryness. |
| FM-C13 | Less upfront, initial sweet ok, but high intense |
| | lingering, slight medicinal off-note, *bitter, intense |
| | dryness, reduced body/mouth-round, AFT: strong linger and |
| | dryness. |
| FM-14 | Good upfront, slightly lesser sweet intense, clean, no |
| | linger, juicy, no bitter, very reduced dryness, slightly |
| | lower body/mouth-round, AFT: no linger, no dryness. |
| FM-15 | Optimum upfront, good intensity, clean, slightly linger, |
| | sugary, bitter not perceived, reduced dryness, improved |
| | body/mouth-round, AFT: sugary, no linger, very slight |
| | dryness. |

### Example 15

Strawberry Milk Beverage with 50% and 100% Sugar Replacement With Composition Comprising Reb M, glucosylated steviol glycoside and taste modifier.

Strawberry Milk Beverages were prepared in accordance with Table 25 below and were evaluated by experienced flavorists for sweetness characteristics and sensory perceptions of mouthfeel.

TABLE 25

| | FM-C16 | FM-17 | FM-C18 | FM-19 | FM-C20 |
|---|---|---|---|---|---|
| | Full Sugar | 50% | 50% | 100% | 100% |
| | 10 Brix | sugar red | sugar red | sugar red | sugar red |
| Ingredients | % | % | % | % | % |
| Refined | 10 | 5 | 5 | 0 | 0 |
| Sugar | | | | | |
| Carraghenan | 0.03 | 0.03 | 0.03 | 0.03 | 0.03 |
| Seaken | | | | | |
| Refined Salt | 0.03 | 0.03 | 0.03 | 0.03 | 0.03 |
| Strawberry | 0.110 | 0.110 | 0.110 | 0.110 | 0.110 |
| Flavor | | | | | |
| Pasteurized | 89.83 | 94.83 | 94.83 | 99.83 | 99.83 |
| Milk, 3% Fat | | | | | |
| Milk | 100 | 100 | 100 | 100 | 100 |
| Beverage | | | | | |
| Base | | | | | |
| Reb M | 0 | 0.0090 | 0.027 | 0.036 | 0.050 |
| powder | | | | | |
| GSG Powder | 0 | 0.0110 | 0 | 0.043 | 0 |
| MM Powder | 0 | 0.0500 | 0.0500 | 0.2000 | 0.2000 |
| Total | 100 | 100 | 100 | 100 | 100 |
| Strawberry | | | | | |
| Milk | | | | | |
| Beverage | | | | | |

Reb M Powder = Rebaudioside M powder
GSG Powder = Glucosylated steviol glycoside powder
MM Powder = off-note masking and mouthfeel improving ingredient

TABLE 26
Results of Comparative Evaluation of Strawberry
Milk Beverages of Table 25.

| Sample | Evaluation |
|---|---|
| FM-C16 | Used as comparative reference. |
| FM-17 | Good sweet upfront, sweet intense ok, slightly linger, juicy, |
| | sugary, no bitter, no dryness, aft: very slightly linger, no |
| | dryness. |
| FM-C18 | Slight less upfront, initial sweet intense higher, with intense |
| | lingering, full body, slight dryness, aft: continued lingering, |
| | slightly art. |
| FM-19 | Upfront sweet OK, slightly lower sweet, good linger, juicy, no |
| | bitter, slightly dryness, slight less body/mouthfeel, aft: no |
| | dryness, no linger, +body, sugary. |
| FM-C20 | Lesser upfront, sweet intensity higher, with higher lingering, |
| | slight dryness, good body/mouth-round, aft: linger strong |
| | lasting, slight dryness. |

### Example 16

Strawberry yogurt with 50% and 70% Sugar Replacement With Composition Comprising Reb M, glucosylated steviol glycoside and taste modifier.

Strawberry yogurt samples were prepared in accordance with Table 27 below and were evaluated by experienced flavorists for sweetness characteristics and sensory perceptions of mouthfeel.

TABLE 27

| | FM-C21 | FM-C22 | FM-23 | FM-C24 | FM-25 |
|---|---|---|---|---|---|
| | Reference, | 50% | 50% | 70% | 70% |
| | 9% sugar | sugar red | sugar red | sugar red | sugar red |
| Ingredients | % | % | % | % | % |
| Yogurt | 91 | 95.5 | 95.5 | 97.3 | 97.3 |
| (Neutral | | | | | |
| yogurt, 3% | | | | | |
| fat without | | | | | |
| sugar) | | | | | |
| Refined | 9 | 4.5 | 4.5 | 2.7 | 2.7 |
| Sugar | | | | | |
| Yogurt Base | 100 | 100 | 100 | 100 | 100 |
| Reb M | 0 | 0.027 | 0.010 | 0.043 | 0.0150 |
| powder | | | | | |
| GSG Powder | 0 | 0 | 0.012 | 0 | 0.0180 |
| MM Powder | 0 | 0.1000 | 0.1000 | 0.1500 | 0.1500 |
| Total | 100 | 100 | 100 | 100 | 100 |
| Strawberry | | | | | |
| Milk | | | | | |
| Beverage | | | | | |

Reb M Powder = Rebaudioside M powder
GSG Powder = Glucosylated steviol glycoside powder
MM Powder = off-note masking and mouthfeel improving ingredient

TABLE 28
Results of Comparative Evaluation
of Strawberry Yogurt of Table 27.

| Sample | Evaluation |
|---|---|
| FM-C21 | Used as comparative reference. |
| FM-C22 | Upfront ok, sweet intense higher, lingering, acidity ok, good |
| | mouthfeel, slight less juicy, with low dryness, aft: lingering |
| | slight intense. |
| FM-23 | Upfront ok, slightly less sweet, linger ok, sugary, juicy, |
| | acidity ok, full body, no bitter, no dryness, aft: sugary, |
| | slightly sweet linger. |
| FM-C24 | Slight less upfront, sweet intense sl. higher with lingering |
| | strong, acidity ok, lower body, perceived dryness, aft: |
| | lingering, slight art. Sweet. |
| FM-25 | Upfront ok, sweet intense ok, clean, sugary, acidity ok, |
| | improved mouthfeel (less), no bitter, no dryness, aft.: very |
| | slightly linger. |

The foregoing broadly describes certain embodiments of the present invention without limitation. Variations and modifications as will be readily apparent to those skilled in the art are intended to be within the scope of the present invention as defined in and by the appended claims.

### REFERENCES

1. Chun, L.; Li-Mei, L.; Feng, S.; Zhi-Min, W.; Hai-Ru, H.; Li, D. JIANG, T.-L. Chemistry and pharmacology of Siraitia grosvenorii: A review. Chinese journal of natural medicines, 2014, 12, 89-102.
2. Takemoto, T.; Arihara, S.; Nakajima, T. Okuhira, M. Studies on the constituents of Fructus Momordicae. I. On the sweet principle. Yakugaku Zasshi, 1983, 103, 1151-4.
3. Takemoto, T.; Arihara, S.; Nakajima, T. Okuhira, M. Studies on the constituents of Fructus Momordicae. III. Structure of mogrosides. Yakugaku zasshi: Journal of the Pharmaceutical Society of Japan, 1983, 103, 1167-1173.
4. Takemoto, T.; Arihara, S.; Nakajima, T. Okuhira, M. Studies on the constituents of Fructus momordicae. II. Structure of sapogenin. Yakugaku zasshi: Journal of the Pharmaceutical Society of Japan, 1983, 103, 1155.
5. Chaturvedula, V. S. P. Meneni, S. R. A New Cucurbitane Glycoside from Siraitia grosvenorii. Nat Prod Commun, 2015, 10, 1521-3.
6. Chaturvedula, V. S. P. Prakash, I. Cucurbitane Glycosides from Siraitia grosvenorii. J. Carbohydr. Chem., 2011, 30, 16-26.
6. Patron, A.; Manam, R.; Colquitt, J.; Servant, N.; Noriega, C. E.; Hammaker, J. R. Gonsalves, N. High intensity sweeteners. Patent WO2017075257A2, May 4, 2017.
8. Prakash, I.; Markosyan, A. Bunders, C. Development of next generation stevia sweetener: rebaudioside M. Foods, 2014, 3, 162-175.
9. Ohta, M.; Sasa, S.; Inoue, A.; Tamai, T.; Fujita, I.; Morita, K. Matsuura, F. Characterization of novel steviol glycosides from leaves of Stevia rebaudiana Morita. Journal of Applied Glycoscience (Japan), 2010.
10. U.S. Food and Drug Administration. https://www.accessdata.fda.gov/scripts/fdcc/?set=GRASNotices&id=512. (accessed May 25, 2017).
11. U.S. Food and Drug Administration. https://www.accessdata.fda.gov/scripts/fdcc/?set=grasnotices&id=667. (accessed May 25, 2017).
12. U.S. Food and Drug Administration. https://www.accessdata.fda.gov/scripts/fdcc/?set=GRASNotices&id=473. (accessed May 25, 2017).
13. Jia, Z. Yang, X., Novel Sweetener ISO-Mogroside V. 2008, Europe Patent EP2188300 B1.
14. Kasai, R.; Matsumoto, K.; Nie, R.-L.; Morita, T.; Awazu, A.; Zhou, J. Tanaka, O. Sweet and bitter cucurbitane glycosides from Hemsleya carnosiflora. Phytochemistry, 1987, 26, 1371-1376.
15. Matsuda, H.; Nakashima, S.; Abdel-Halim, O. B.; Morikawa, T. Yoshikawa, M. Cucurbitane-type triterpenes with anti-proliferative effects on U937 cells from an egyptian natural medicine, Bryonia cretica: structures of new triterpene glycosides, bryoniaosides A and B. Chemical and pharmaceutical bulletin, 2010, 58, 747-751.
16. Gheysen, K.; Mihai, C.; Conrath, K. Martins, J. C. Rapid identification of common hexapyranose monosaccharide units by a simple TOCSY matching approach. Chemistry—A European Journal, 2008, 14, 8869-8878.
17. Tabatadze, N.; Elias, R.; Faure, R.; Gerkens, P.; De Pauw-Gillet, M. C.; Kemertelidze, E.; Chea, A. Ollivier, E. Cytotoxic triterpenoid saponins from the roots of Cephalaria gigantea. Chemical and pharmaceutical bulletin, 2007, 55, 102-105.
18. Mshvildadze, V.; Elias, R.; Faure, R.; Rondeau, D.; Debrauwer, L.; Dekanosidze, G.; Kemertelidze, E. Balansard, G. Triterpenoid saponins from leaves of Hedera pastuchowii. Chemical and pharmaceutical bulletin, 2004, 52, 1411-1415.
19. Si, J.; Chen, D.; Chang, Q. Shen, L. Isolation and determination of cucurbitane-glycosides from fresh fruits of Siraitia grosvenorii. Zhiwu Xuebao, 1996, 38, 489-494.

1. A composition comprising:
(i) rebaudioside M,
(ii) a glucosylated steviol glycoside, and
(iii) an effective amount of taste modifier,
wherein the amount of said glucosylated steviol glycoside present in the sweetness modifying composition is greater than the amount of rebaudioside M present in the sweetness modifying composition.

2. The composition of claim 1, wherein the ratio of said rebaudioside M to said glucosylated steviol glycoside in said sweetness modifying composition is from about 1:1 to about 1:1.5.

3. The composition of claim 2, wherein the ratio of said rebaudioside M to said glucosylated steviol glycoside in said sweetness modifying composition is selected from the group consisting of 1:1.1, 1:1.2, 1:1.3, 1:1.4 and 1:1.5.

4. The composition of claim 3, wherein the ratio of said rebaudioside M to said glucosylated steviol glycoside in said sweetness modifying composition is 1:1.2.

5. The composition of claim 1, wherein said glucosylated steviol glycoside is selected from the group consisting of glucosylated stevioside, glucosylated rebaudioside A, glucosylated rebaudioside B, glucosylated rebaudioside C, glucosylated rebaudioside D, glucosylated rebaudioside E, glucosylated rebaudioside F, glucosylated rebaudioside G, glucosylated rebaudioside H, glucosylated rebaudioside I, glucosylated rebaudioside J, glucosylated rebaudioside K, glucosylated rebaudioside L, glucosylated rebaudioside M, glucosylated rebaudioside N, glucosylated rebaudioside O, glucosylated dulcoside A, glucosylated dulcoside B, glucosylated rubusoside, any other glucosylated steviol glycoside derived from Stevia rebaudiana and mixtures thereof.

6. The composition of claim 1, wherein the sweetness modifying composition improves one or more sweetness characteristic(s) of a sweetened composition compared to the respective sweetness characteristic(s) of the sweetened composition in the absence of the sweetness modifying composition.

7. The composition of claim 6, wherein the sweetness modifying composition improves the upfront sweetness of the sweetened composition compared to the upfront sweetness of the sweetened composition in the absence of the sweetness modifying composition.

8. The composition of claim 1, wherein the sweetness modifying composition weakens the bitter off-note taste of a sweetened composition compared to the bitter off-note taste of the sweetened composition in the absence of the sweetness modifying composition.

9. The composition of claim 1, wherein the sweetness modifying composition weakens the dry and/or astringent mouthfeel of a sweetened composition compared to the dry and/or astringent mouthfeel of the sweetened composition in the absence of the sweetness modifying composition.

10. A sweetened composition comprising:
at least one sweetener, and
a composition comprising (i) rebaudioside M, (ii) a glucosylated steviol glycoside, and (iii) an effective amount of a taste modifier, wherein the amount of said glucosylated steviol glycoside present in the composition comprising the (i) rebaudioside M, (ii) the glucosylated steviol glycoside, and (iii) the effective amount of a taste modifier is greater than the amount of rebaudioside M present in the composition comprising the (i) rebaudioside M, (ii) the glucosylated steviol glycoside, and (iii) the taste modifier.

11. The sweetened composition of claim 10, wherein the ratio of said rebaudioside M to said glucosylated steviol glycoside in said composition comprising the (i) rebaudioside M, (ii) the glucosylated steviol glycoside, and (iii) the taste modifier is from about 1:1 to about 1:1.5.

12. The sweetened composition of claim 11, wherein the ratio of said rebaudioside M to said glucosylated steviol glycoside in said composition comprising the (i) rebaudioside M, (ii) the glucosylated steviol glycoside, and (iii) the taste modifier is selected from the group consisting of 1:1.1, 1:1.2, 1:1.3, 1:1.4 and 1:1.5.

13. The sweetened composition of claim 12, wherein the ratio of said rebaudioside M to said glucosylated steviol glycoside in said composition comprising the (i) rebaudioside M, (ii) the glucosylated steviol glycoside, and (iii) the taste modifier. is 1:1.2.

14. The sweetened composition of claim 10, wherein said glucosylated steviol glycoside is selected from the group consisting of glucosylated stevioside, glucosylated rebaudioside A, glucosylated rebaudioside B, glucosylated rebaudioside C, glucosylated rebaudioside D, glucosylated rebaudioside E, glucosylated rebaudioside F, glucosylated rebaudioside G, glucosylated rebaudioside H, glucosylated rebaudioside I, glucosylated rebaudioside J, glucosylated rebaudioside K, glucosylated rebaudioside L, glucosylated rebaudioside M, glucosylated rebaudioside N, glucosylated rebaudioside O, glucosylated dulcoside A, glucosylated dulcoside B, glucosylated rubusoside, any other glucosylated steviol glycoside derived from Stevia rebaudiana and mixtures thereof.

15. The sweetened composition of claim 10, wherein the composition comprising the (i) rebaudioside M, (ii) the glucosylated steviol glycoside, and (iii) the taste modifier. improves one or more sweetness characteristic(s) of the sweetened composition compared to the respective sweetness characteristic(s) of the sweetened composition in the absence of the composition comprising the (i) rebaudioside M, (ii) the glucosylated steviol glycoside, and (iii) the taste modifier.

16. The sweetened composition of claim 15, wherein the composition comprising the (i) rebaudioside M, (ii) the glucosylated steviol glycoside, and (iii) the taste modifier improves the upfront sweetness of the sweetened composition compared to the upfront sweetness of the sweetened composition in the absence of the composition comprising the (i) rebaudioside M, (ii) the glucosylated steviol glycoside, and (iii) the taste modifier.

17. The sweetened composition of claim 10, wherein the composition comprising the (i) rebaudioside M, (ii) the glucosylated steviol glycoside, and (iii) the taste modifier weakens the dry and/or astringent mouthfeel of the sweetened composition compared to the dry and/or astringent mouthfeel of the sweetened composition in the absence of the composition comprising the (i) rebaudioside M, (ii) the glucosylated steviol glycoside, and (iii) the taste modifier.

18. The sweetened composition of claim 10, wherein the at least one sweetener is selected from the group consisting of sucrose, fructose, glucose, xylose, arabinose, rhamnose, sugar alcohols, starch syrups, and mixtures thereof.

19. The sweetened composition of claim 18, wherein said sugar alcohol is selected from the group consisting of erythritol, xylitol, mannitol, sorbitol and inositol.

20. A sweetened consumable comprising:
a food or beverage base composition comprising at least one sweetener present in an amount at or above its sweetness recognition threshold and/or having a sweetness equal to or greater than about 1.5% (w/v) sucrose equivalence, and
a composition comprising (i) rebaudioside M, (ii) a glucosylated steviol glycoside, and (iii) an effective amount of an off-note masking and mouthfeel improving ingredient, wherein the amount of said glucosylated steviol glycoside present in the composition is greater than the amount of rebaudioside M present in the composition.

21. The sweetened consumable of claim 20, wherein the ratio of said rebaudioside M to said glucosylated steviol glycoside in said composition is from about 1:1 to about 1.1.5.

22. The sweetened consumable of claim 21, wherein the ratio of said rebaudioside M to said glucosylated steviol glycoside in said composition is selected from the group consisting of 1:1.1, 1:1.2, 1:1.3, 1:1.4 and 1:1.5.

23. The sweetened consumable of claim 22, wherein the ratio of said rebaudioside M to said glucosylated steviol glycoside in said composition is 1:1.2.

24. The sweetened consumable of claim 20, wherein said glucosylated steviol glycoside is selected from the group consisting of glucosylated stevioside, glucosylated rebaudioside A, glucosylated rebaudioside B, glucosylated rebaudioside C, glucosylated rebaudioside D, glucosylated rebaudioside E, glucosylated rebaudioside F, glucosylated rebaudioside G, glucosylated rebaudioside H, glucosylated rebaudioside I, glucosylated rebaudioside J, glucosylated rebaudioside K, glucosylated rebaudioside L, glucosylated rebaudioside M, glucosylated rebaudioside N, glucosylated rebaudioside O, glucosylated dulcoside A, glucosylated dulcoside B, glucosylated rubusoside, any other glucosylated steviol glycoside derived from Stevia rebaudiana and mixtures thereof.

25. The sweetened consumable of claim 20, wherein said consumable comprises a carbonated beverage having a carbon dioxide gas content of about 2.0 percent to about 3.5 percent by volume based on the total volume of the carbonated beverage.

26. The sweetened consumable of claim 20, wherein the composition improves one or more sweetness characteristic(s) of the sweetened consumable compared to the respective sweetness characteristic(s) of the sweetened consumable in the absence of the composition.

27. The sweetened consumable of claim 26, wherein the composition improves the upfront sweetness of the sweetened consumable compared to the upfront sweetness of the sweetened consumable in the absence of the composition.

28. The sweetened consumable of claim 20, wherein the sweetness modifying composition weakens the bitter off-note taste of the sweetened consumable compared to the bitter off-note taste of the sweetened consumable in the absence of the composition.

29. The sweetened consumable of claim 20, wherein the composition weakens the dry and/or astringent mouthfeel of the sweetened consumable compared to the dry and/or astringent mouthfeel of the sweetened consumable in the absence of the composition.

30. A method of enhancing the sweetness of a sweetened composition, the method comprising:
providing a base composition comprising at least one sweetener present in an amount at or above its sweetness recognition threshold and/or having a sweetness equal to or greater than about 1.5% (w/v) sucrose equivalence, and
adding a composition to said base composition, the sweetness comprising (i) rebaudioside M, (ii) a glucosylated steviol glycoside, and (iii) an effective amount of a taste modifier, wherein the amount of said glucosylated steviol glycoside present in the composition is greater than the amount of rebaudioside M present in the composition.

31. A method of reducing the amount of sugar in a sweetened composition, the method comprising:
providing a base composition comprising at least one sweetener present in an amount at or above its sweetness recognition threshold and/or having a sweetness equal to or greater than about 1.5% (w/v) sucrose equivalence, and
adding a composition to said base composition, the composition comprising (i) rebaudioside M, (ii) a glucosylated steviol glycoside, and (iii) an effective amount of a taste modifier, wherein the amount of said glucosylated steviol glycoside present in the composition is greater than the amount of rebaudioside M present in the composition.

32. The method of claim 31, wherein the amount of sugar replaced in the sweetened composition is from about 30 percent to about 100 percent.

33. The method of claim 32, wherein the amount of sugar replaced in the sweetened composition is from about 30 percent to about 70 percent.

34. The method of claim 32, wherein the amount of sugar replaced in the sweetened composition is from about 50 percent to about 100 percent.

35. The method of claim 34, wherein the amount of sugar replaced in the sweetened composition is from about 50 percent to about 80 percent.

36. The method of claim 35, wherein the amount of sugar replaced in the sweetened composition is from about 50 percent to about 70 percent.

37. The composition of claim 5, wherein said glucosylated steviol glycoside comprises a blend of at least one glucosylated steviol glycoside and at least one residual steviol glycoside is selected from the group consisting of stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, dulcoside B, rubusoside, any other residual steviol glycoside derived from Stevia rebaudiana and mixtures thereof.

38. The sweetened composition of claim 14, wherein said glucosylated steviol glycoside comprises a blend of at least one glucosylated steviol glycoside and at least one residual steviol glycoside is selected from the group consisting of stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, dulcoside B, rubusoside, any other residual steviol glycoside derived from Stevia rebaudiana and mixtures thereof.

39. The sweetened consumable of claim 24, wherein said glucosylated steviol glycoside comprises a blend of at least one glucosylated steviol glycoside and at least one residual steviol glycoside is selected from the group consisting of stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, dulcoside B, rubusoside, any other residual steviol glycoside derived from Stevia rebaudiana and mixtures thereof.
